(19) United States
(12) Patent Application Publication
(10) Pub. No.: US 2024/0099261 A1
(43) Pub. Date: Mar. 28, 2024

(54) Clumping Litter and Method of Making Clumping Litter Using a Non-Clumping Substrate

(71) Applicant: Pioneer Pet Products, LLC, Cedarburg, WI (US)

(72) Inventors: John M. Lipscomb, Cedarburg, WI (US); Omar I. Rodriguez, Cedarburg, WI (US)

(21) Appl. No.: 18/372,677

(22) Filed: Sep. 25, 2023

Related U.S. Application Data
(60) Provisional application No. 63/409,755, filed on Sep. 24, 2022.

(51) Int. Cl. A01K 1/015; B01J 20/12; B01J 20/24; B01J 20/28; B01J 20/32

(52) U.S. Cl. CPC A01K 1/0155; B01J 20/12; B01J 20/24; B01J 20/28016; B01J 20/3204; B01J 20/3223; B01J 20/3231; B01J 20/3295; A01K 1/0154

(57) ABSTRACT

A self-clumping coated substrate litter composed of self-clumping coated substrate litter granules each made of an inner substrate around which is agglomerated a particulate modified starch clumping agent forming an outer coating of the modified starch clumping agent around the substrate. The coating has an inner self-adhering region adhered to the substrate and an outer region of the clumping agent surrounding the inner region defining an outer surface of each granule that has absorption-enhancing microcracks and microscopic upraised projections, including spikes, formed in and on the surface. The coating has a first single time moisture activated moisture cured adhesive and a second moisture reactivated moisture recured adhesive which are both formed of starch modified during ultrahigh pressure extrusion using a single screw extruder. In a method of making, a suitable agglomeration method includes a substrate water wetting method where substrate particles are wetted with water, powdered clumping agent is applied, and the wetted mixture is tumbled until round low tracking agglomerated litter granules are obtained. Another suitable agglomeration method involves application of a slurry of the clumping agent onto substrate particles while being tumbled until rounded low tracking agglomerated litter granules are obtained.

### CROSS-REFERENCE TO RELATED APPLICATION(S)

This application claims priority in U.S. Provisional Patent Application Ser. No. 63/409,755 filed Sep. 24, 2022 the entirety of which is hereby expressly incorporated herein by reference.

### FIELD OF THE INVENTION

The present invention relates generally to sorbents, particularly to animal litters, and more particularly to clumping or self-clumping animal litters that clump when wetted. The present invention even further relates to self-clumping litters composed of litter granules formed of a substrate at least partially covered by or coated with a sorbent clumping material containing cold-water swellable water-absorbent starch and cold-water soluble binder that self-clumps together granules of the litter when wetted together with methods of making the same.

### BACKGROUND OF THE INVENTION

In the past, myriad attempts have been made by others to develop low-cost cat litters using granular or particulate material that would not clump on their own. The original non-clumping litters were products like play box sand, as sand was cheap and readily available. Next came calcium bentonite litters, which absorbed the urine when the cat peed, but which also did not clump. When a cat soiled such non-clumping litter, the soiled litter was often simply covered up or covered over with additional non-clumping litter. These types of non-clumping litters were not only inefficient, but they actually tended to be more costly to use. This is because it was not uncommon for a whole box of litter to become contaminated, smelly, and unusable after only a single day's use by a single cat and sometimes even after a single use of the litter by the cat.

This led to the development of sodium bentonite clumping litter, which absorb urine and liquid fecal matter. Sodium bentonite litters do a good job of clumping when soiled by a cat, which enables the soiled litter clump to be easily removed from unspoiled litter simply by scooping out the clump using a handled perforate litter scoop. While sodium bentonite clumping litters were the gold standard for several years because of their ability to clump, improvements in clumping litters led to litters having increased clump retention rates. Clump retention rate is a measurement of how well a clump of litter holds together after being dropped during a drop test typically from a predetermined height of about 12-18 inches and is used to measure how much of the original clump of spoiled litter held together or was retained during removal from unspoiled litter in a litter box. A litter having a clump retention rate of over 90%, which means at least 90% of the clump stayed together after being dropped from the predetermined drop test height, was considered a good litter, a litter having a clump retention rate of at least 96% was considered a great litter, with exceptional sodium bentonite litters having a clump retention rate of at least 99%, which is now the gold standard for all types of litters.

Unfortunately, sodium bentonite is very dusty, which can increase the amount of cleaning needed to be done in and around the area of the litter box when sodium bentonite litter is used. After being mined, sodium bentonite used in clumping litters is typically processed very little other than by being crushed to relatively small sized granules that enhance clumping. The litter granules are dusty, because sodium bentonite is a friable material with many impurities, which can include sand, limestone, sodium chloride, calcium chloride, magnesium chloride, potassium chloride, ammonium chloride, calcium carbonate, magnesium carbonate, calcium sulfate, sodium sulfate, sodium nitrate, ferrous sulfate, along with other organic and inorganic contaminants, depending upon where it was mined. Because it is friable, the granules of sodium bentonite litter rub together creating tiny powder-like dust particles during packaging, shipping to the retailer and handling by the retailer with the consumer and cats unfortunately being exposed to the dust when it becomes airborne when pouring the litter into the litter box and scooping clumps out of the litter box. Not only does the sodium bentonite dust cling to the litterbox, floor, and surrounding walls, but it can also get on the fur of cats using the litterbox requiring them to more frequently groom their fur to remove the dust.

Sodium bentonite as sold is also very heavy as it has a bulk density typically ranging between 54-72 pounds per cubic foot. Because it is so heavy, sodium bentonite is very costly to ship from the mine to litter manufacturing plants where it is crushed into smaller sized litter granules and packaged in bags, jugs, and other types of containers for consumer use. Its considerable weight also makes it very costly to ship sodium bentonite litter to stores and the homes of consumers throughout the country. And because it is so heavy, containers of the litter can be difficult for consumers to lift and carry home from the store as well as be unwieldy to lift and pour into a litter box during actual use.

To reduce both the weight and the cost of litter, litter manufactures have brought to market multicomponent litter blends where sodium bentonite litter granules are blended with other one or more other types of litter granules which are lighter in weight, cheaper to ship, and which can be cheaper to source as a raw material. Examples of such hybrid blended multicomponent sodium bentonite litters include litters composed of sodium bentonite blended with calcium bentonite granules, ground or crushed perlite granules, pellets or granules of compressed, crushed, ground or milled organic materials which are typically high in cellulose content, as well as multicomponent sodium bentonite litter blends composed of sodium bentonite granules and granules, pellets or particles of two or three other types of non-sodium bentonite litter components. However, virtually all of these multicomponent litters made with sodium bentonite not only suffer from many, if not most, of the same disadvantages as litters made only of sodium bentonite, they often do not clump as well either.

Newer lighter weight products are now replacing sodium bentonite litter in the retail market. Natural litter derived from distillers dried grains was an early offering, but it struggled even to meet the 90% clump retention rate criteria. While the Applicant's even newer extruded cereal grain litters out-clump even the best clumping sodium bentonite-based litters and hence have enjoyed considerable commercial success in the marketplace, improvements to clumping litters nonetheless remain desirable.

For example, what is needed are litters complementary to extruded cereal grain litters which also clump when wetted and which are not only superior to the many sodium bentonite litters and sodium bentonite multicomponent litters still ubiquitous in the marketplace, but which also have and preferably even improve upon one or more of the desirable properties and characteristics of Applicant's own commercially successful extruded cereal grain litters.

In modern day litters tracking is also a concern as it is not only desirable to keep cat litter from migrating out of the litter box but also desirable to keep litter from sticking to and even accumulating on a cat's paws in the first place. Tracking is dependent on the moisture of the cat's paw and of the litter in the litterbox. The shape of the litter granules or pellets. Because cat's paws have hair and sweat glands in between the pads litter granules or pellets can get caught in the hair between the pads. Hair acts like a spring as it pushes back after intrusion of a small particle between the pads, many times causing the small particle to be captured by the hair. Especially when a cat is sweating, small dusty particles will get matted within the hair between the pads of a cat. There are times when the buildup of litter particles in the hair between the pads of the paw(s) of a cat becomes so great and/or deep that it becomes sore and painful when the cat walks, which can and often does require a vet to clean out the matted litter particles in the hair between the pads.

What is also needed is a litter with low tracking characteristics which prevents litter from sticking to a cat's paws during litter box use.

### SUMMARY OF THE INVENTION

The present invention is directed to a self-clumping sorbent granular litter and method of making the self-clumping sorbent granular litter composed of self-clumping absorbent litter granules which include generally rounded self-clumping absorbent coated substrate litter granules. Each one of the generally rounded self-clumping absorbent coated substrate litter granules has a coating with a generally round outer surface at least partially, preferably substantially completely, filled with microscopic water absorption enhancing projections, e.g., spikes, upraised from the granule outer surface formed during agglomeration. The outer surface of the coating of each one of the generally rounded self-clumping absorbent coated substrate litter granules also is configured with myriad water absorption enhancing micro-cracks formed in the outer surface during curing after agglomeration as well as during post-curing drying after agglomeration.

Each one of the coated-substrate litter granules is formed of an inner substrate, in the form of a litter granule nucleating substrate particle, and an outer modified starch water-absorbent clumping agent configured to absorb water or urine during litter use, agglomerate, and self-clump into a removably scoopable clump of wetted litter granules, which include at least a plurality of pairs of the coated-substrate litter granules, which can be scooped using a handled perforate litter scoop, which has a clump retention rate of at least 95%, preferably at least 97%, more preferably at least 99%, and which has a clump crush strength of at least 40 pounds per square inch (PSI), preferably at least 60 PSI, more preferably 80 PSI, even more preferably 100 PSI, when dry. In a preferred self-clumping absorbent coated-substrate litter granule embodiment, each coated-substrate litter granule of the present invention has an outer coating of the modified starch water-absorbent clumping agent adhesively self-adhered to an outer surface of the inner substrate particle by an inner self-adhering region using an agglomeration method of the present invention discussed in more detail below.

In one preferred embodiment, a self-clumping litter according to the present invention has at least 20%, preferably has at least 30%, and more preferably has at least a majority, i.e., at least 50%, by litter weight, composed of the self-clumping absorbent coated-substrate litter granules of the present invention forming a multicomponent litter which can have the remainder composed of one or more other types of granular components, e.g., non-clumping calcium bentonite granules and/or non-clumping organic granules, and still form removably scoopable clumps upon wetting with water or urine that have a clump retention rate of at least 95%, preferably at least 97%, more preferably at least 99%, and a clump crush strength of at least 40 PSI, preferably 60 PSI, more preferably 80 PSI, even more preferably 100 PSI, when dry. Such a self-clumping sorbent granular litter, which can be a multicomponent litter, which is composed of anywhere from 20% and 100% of the self-clumping absorbent coated-substrate litter granules of the present invention, advantageously improves upon one or more of the properties and/or characteristics of past and present sodium bentonite litters and sodium bentonite based litters, is lighter in weight, cheaper to make and ship, easier to handle during transport, easier for users to lift, carry, and pour, produces less dust, preferably is non-dusting or even dust-inhibiting, and produces rounded coated-substrate litter granules which are not easily caught in a cat's paw thereby advantageously also reducing tracking from the litterbox.

During making of the coated-substrate litter granules, a coating of modified starch water-absorbent clumping agent is adhered via agglomeration, preferably wet agglomeration, to the outer surface of a substrate granule forming an inner self-adhering region of the coating using some, but not all, of the modified starch water-absorbent clumping agent which directly adheres to the substrate granule outer surface. The inner self-adhered region of the coating is directly adhered to the substrate granule outer surface by wetting at least one of the outer surface and the modified starch water-absorbent clumping agent material applied onto the outer surface. This leaves the rest of the modified starch water-absorbent clumping agent in an outer region of the coating surrounding the inner self-adhered region of the coating substantially unmodified, substantially unchanged, and available to absorb water and facilitate clumping upon being wetted with water or urine during litter or absorbent use. The inner adhering region is self-adhering because it is formed of the same modified starch water-absorbent clumping agent as the outer region but has some of its adhesive activated to directly adhere the inner adhering region to the outer surface of the substrate granule. In addition to at least one constituent of the modified starch water-absorbent clumping agent of each coated substrate coating being water absorbent, the modified starch water-absorbent clumping agent has at least one other constituent of each coated substrate coating that is a water-activated adhesive, preferably is a moisture-curing water-activated adhesive, that becomes activated when wetted with an aqueous wetting liquid, such as water or urine, by at least becoming tacky and which preferably also becomes flowable, forms a flowable adhesive, and which can also gel, i.e., thicken, during or after flowing.

In a preferred embodiment, the modified starch water-absorbent clumping agent has a first adhesive constituent that is a one-time water activated, one time water cured at least partially water-soluble adhesive, and a second adhesive constituent that is a water reactivated and water re-cured at least partially water-soluble adhesive. The second adhesive constituent preferably can be water reactivated and water re-cured at least a plurality of, preferably at least a plurality of pairs of, i.e., at least three, times. In a preferred embodiment, the first adhesive constituent is a starch modified at least physically during extrusion, i.e., a physically modified starch, and which preferably is a dextrinized starch which can be or include dextrin, but which is not necessarily dextrin. In such a preferred embodiment, the second adhesive constituent is a starch modified during extrusion into forming a starch pregel or pregelatinized starch which has adhesive properties.

A coating applied onto a substrate granule or substrate particle contains both the first adhesive constituent and the second adhesive constituent. In a preferred embodiment, a coating applied onto a substrate granule or substrate particle contains the first adhesive constituent, the second adhesive constituent, and a third water absorbent constituent configured to absorb room temperature water or cat-body temperature urine. In one embodiment, at least one of the first constituent, the second constituent, and the third constituent include or are composed of cold-water soluble starch that can be water and urine absorbent and which at least partially solubilizes in room temperature water and cat-body temperature urine. In another embodiment, at least both the first constituent and the second constituent are composed of or include water absorbent starch that is water and urine absorbent and are composed of or include modified starch which at least partially solubilizes in room temperature water and cat-body temperature urine.

During making of the coated substrate litter granules, preferably by agglomeration, either or both the modified starch water-absorbent clumping agent and the outer surface of the substrate granule are wetted with an aqueous wetting liquid, preferably water, ultimately causing wetting of at least some of the modified starch water-absorbent clumping agent activating some, but not all, of the water-activated adhesive in the modified starch water-absorbent clumping agent in forming the inner self-adhering region. In at least one preferred embodiment of the modified starch water-absorbent clumping agent at least some of the adhesive activated by the aqueous wetting liquid becomes at least somewhat tacky, preferably does become tacky, causing at least some of the modified starch water-absorbent clumping agent to stick to and adhere to the outer substrate granule surface. In at least another preferred embodiment of the modified starch water-absorbent clumping agent, at least some of the adhesive activated by the aqueous wetting liquid gels causing at least some of the modified starch water-absorbent clumping agent to stick to and adhere to the outer substrate granule surface in forming the inner self-adhering region. In at least a further preferred embodiment of the modified starch water-absorbent clumping agent, at least some of the adhesive activated by the aqueous wetting liquid becomes flowable, preferably forms a flowable adhesive, causing at least some of the modified starch water-absorbent clumping agent to stick to and adhere to the outer substrate particle surface in forming the inner self-adhering region. In at least one preferred embodiment of the modified starch water-absorbent clumping agent, at least some of the adhesive activated by aqueous wetting liquid wetting the modified starch water-absorbent clumping agent becomes tacky, at least some of the adhesive activated by aqueous wetting liquid wetting the modified starch water-absorbent clumping agent gels, and/or at least some of the adhesive activated by the aqueous wetting liquid wetting the modified starch water-absorbent clumping agent forms a flowable water-activated adhesive causing at least some of the modified starch water-absorbent clumping agent to stick to and adhere to the outer substrate particle surface in forming the inner self-adhering region.

The combination of this tackiness and the use of a tumbling action of the substrate granule during agglomeration, such as in a rotating drum into a coated substrate litter granule of the present invention leads to the formation of an outer coated substrate litter granule surface that has a multitude of upraised projections, which preferably include spikes, over substantially the entire outer coated substrate litter granule surface. These microscopic projections, including spikes, are microscopic in size by extending outwardly from the coated substrate litter granule surface no greater than 5 microns, preferably no greater than 2 microns, and more preferably no greater than about 1 micron (1 micron±0.25 microns). Preferably, these microscopic projections, including spikes, are nanoscale in size or nanosized each extending outwardly from the outer surface no farther than 1 micron. This tumbling action, such as carried out in a rotating drum, also is responsible for producing coated substrate litter granules of the present which are rounded and which can be substantially round, which minimize tracking by minimizing the likelihood of being picked up by a cat's paw during litter use. Because these projections, including any spikes, are so small as to be microscopic in size, they advantageously enhance absorption by speeding absorption by more rapidly spreading water or urine wetting the projections, including spikes, via wicking or capillary action substantially along the entire coated substrate litter granule outer surface while still maintaining the generally rounded configuration or shape of the coated substrate litter granule that minimizes tracking.

Thereafter, upon curing the projections, including the spikes, become substantially hard and absorption-enhancing micro-cracks form in the outer surface. These micro-cracks continue forming and propagating after curing, during drying and even during storage of the coated substrate litter granules after being packaged and prior to use. These micro-cracks can range in length from being nanoscale or nanosized, i.e., less than 1 micron, to being as long as the multi-micron thickness of the clumping agent coating at least partially covering the substrate particle or substrate granule that forms the substrate coated litter granule. In a preferred embodiment, these microcracks range in size from having a root thickness of no more than about 1 micron and length of no more than about 50 microns (50 microns±5 microns) to a root thickness as little as about 5 nanometers (5 nanometers±3 nanometers) and a length of as little as about 5 nanometers, e.g., root thickness of between about 5 nanometers and about 1 micron and length of between about 5 nanometers and about 50 microns. These microcracks further enhance absorption via wicking or capillary action to open up portions of the outer coated substrate litter granule coating upon wetting with water or urine thereby rapidly increasing the magnitude of the surface area thereof in contact with water or urine which can absorb the water or urine. The projections, including the spikes, work in concert with the microcracks to not only enhance absorption by speeding absorption but also speeding flow of flowable adhesive from each wetted coated substrate litter granule thereby also enhancing clumping.

In a preferred method and embodiment, at least some of the adhesive of the first adhesive constituent of the modified starch water-absorbent clumping agent is activated and cures thereby helping to bond the self-adhering region to the outer substrate granule surface. At least some of the adhesive of the second adhesive constituent also is activated and cures thereby also helping to bond the self-adhering region to the outer substrate granule surface.

A preferred self-clumping litter of the present invention includes self-clumping absorbent coated substrate litter granules each having a granule coating weight of each inner substrate particle of between about 5% and about 35%, preferably between about 5% and 50%, more preferably between about 5% and 85% of modified starch water-absorbent clumping agent by coated substrate litter granule weight and which produces self-clumping coated substrate litter granules of the invention which each absorb at least two times, preferably at least three times, more preferably at least four times, most preferably at least six times their coating weight in water, such as preferably room temperature water having a temperature of between 68°-72° Fahrenheit and urine, such as cat body temperature urine having a temperature between about 100° Fahrenheit and about 104°. The wetted coated substrate litter granules do so while also agglomerating with adjacent water or urine wetted litter granules in self-clumping together into a clump that is removably scoopable from other unwetted or unsoiled litter granules using a handled perforate litter scoop. Self-clumping absorbent coated substrate litter granules of the invention absorb at least one times their coating weight in water, preferably room temperature water, or urine, preferably cat body temperature urine, within one minute, i.e., sixty seconds of being wetted with the water or urine, preferably within thirty seconds, more preferably within twenty seconds of being wetted during agglomeration with other wetted litter granules into a clump composed of at least a plurality of pairs of the coated substrate litter granules. In such a preferred embodiment, each coated substrate litter granule is composed of between about 5% and about 35%, preferably between about 5% and 50%, more preferably between about 5% and 85% by granule weight of the modified starch water-absorbent clumping agent. In one such preferred embodiment and method of making coated substrate litter granules of the invention, modified starch water-absorbent clumping agent is applied onto each substrate granule until a granule coating weight of between 5% and 35%, preferably between about 5% and 50%, more preferably between about 5% and 85% by granule weight of the modified starch water-absorbent clumping agent on the substrate particle is obtained such that each finished coated substrate litter granule contains between 5% and 35%, preferably between about 5% and 50%, more preferably between about 5% and 85% by granule weight of the modified starch water-absorbent clumping agent.

The self-clumping absorbent coated substrate litter granules of a preferred self-clumping litter of the present invention each have a granule coating weight of between about 5% and about 35%, preferably between about 5% and 50%, more preferably between about 5% and 85%, by granule weight of the outer modified starch water-absorbent clumping agent on the inner substrate granule, which is a granule coating weight sufficient to produce a coating on the self-clumping coated substrate litter granules that each absorb at least one time the coated substrate litter granule's coating weight in water or urine and swell at least 25%, preferably at least 35%, more preferably at least 50%, most preferably at least 80%, in volume as the water or urine is absorbed compared to the volume of the litter granule before wetting. In a preferred embodiment, each one of the self-clumping absorbent coated substrate litter granules of the present invention have a granule coating weight of between about 5% and about 35%, preferably between about 5% and 50%, more preferably between about 5% and 85%, by granule weight of the outer modified starch water-absorbent clumping agent on the inner substrate granule, which is a granule coating weight sufficient to produce a coating on the self-clumping coated substrate litter granules that each absorb at least two times the coated substrate litter granule's coating weight in water or urine and swell at least 25%, preferably at least 35%, more preferably at least 50%, most preferably at least 80%, in volume as the water or urine is absorbed compared to the volume of the litter granule before wetting.

Each self-clumping absorbent coated substrate litter granule of the present invention preferably is a swelling and gelling self-clumping absorbent coated substrate litter granule in which the outer region of its modified starch water-absorbent clumping agent outer coating swells as it absorbs water or urine, preferably room temperature water or cat body temperature urine, wetting the granule and also substantially simultaneously forms a gel on, along and for a depth below the outer surface of the coated substrate litter granule that preferably is tacky when wetted and which can be, include, or otherwise preferably does contain a water-activated moisture curing adhesive which facilitates clumping with other contacting litter granules by its stickiness or tackiness creating adhesion therebetween that adhesively bonds the contacting granules thereto into a clump by moisture curing by the moisture evaporating from the clump as the clump dries. In one embodiment of a coated substrate litter granule of the invention, the modified starch water-absorbent clumping agent outer coating of each wetted coated substrate litter granule at least partially solubilizes in water or urine, preferably room temperature water or cat body temperature urine, forming a flowable water-activated moisture-curing adhesive with a viscosity that remains low enough, preferably no greater than 15,000 centipoise, more preferably no greater than 10,000 centipoise, even more preferably no greater than about 5,000 for a long enough period of time, preferably for at least one second after being wetted, more preferably for at least 4 seconds after being wetted, enabling it to flow from the water or urine wetted of modified starch water-absorbent clumping agent of the litter granule along and in between contacting granules and adjacent granules until the viscosity increases forming back into a tacky semisolid gel having a viscosity of at least about 30,000 centipoise, preferably at least 50,000 centipoise, more preferably at least 80,000 centipoise within 20 seconds after being wetted, preferably within 10 seconds after being wetted, more preferably within 5 seconds after being wetted. As the flowable adhesive increases in viscosity, it gels (but remains at least slightly tacky), and hardens into a glassy material having a glassy material state at room temperature as the formed clump moisture cures during drying thereby bonding together the clumped granules. These bonds can include one of hydrogen bonds and covalent bonds, preferably covalent bonds. In any event, the resultant clump formed becomes hard enough to have a clump retention rate of at least 95%, preferably at least 97%, more preferably at least 99% and a clump crush strength of at least 40 PSI, preferably at least 60 PSI, more preferably 80 PSI, even more preferably at least 100 PSI, when the clump is dried to a moisture content of about 12% (12%±1.5%) by clump weight.

Preferably, at least a portion of the modified starch water-absorbent clumping agent of each litter granule of the invention at least partially solubilizes in room temperature water or cat body temperature urine wetting the granule by contacting the granule and forms a flowable adhesive that preferably is a flowable water-activated adhesive that also is moisture curing that flows from the wetted granule outwardly therefrom along and between contacting and adjacent granules of the litter. The flowable adhesive initially is of a flowable viscosity greater than the viscosity of water that increases in viscosity over time solidifying into an adhesive gel which initially adheres contacting pellets thereto and to each other, such as by surface tension, capillarity, liquid adhesion and/or intermolecular forces, e.g., Van der Waals forces, transitions into a more viscous bonding gel as it moisture cures as it dries, more strongly adhering the contacting pellets thereto and to each other, such as preferably at least with hydrogen bonds and/or preferably at least some covalent bonds. As the initially flowable adhesive, which transitioned over time into an adhesive gel and then a bonding gel, even further moisture cures as it dries to a moisture content of less than 15%, preferably no greater than 12%, by weight, it becomes a substantially fully cured solid adhesive that is a glassy material in a glassy state adhesively bonding contacting litter granules of the litter thereto, at least with hydrogen bonds, i.e., hydrogen bonding, and/or preferably with covalent bonds, i.e., covalent bonding. Such a clump formed of at least a plurality of pairs, i.e., at least three, of the litter granules of the invention wetted with water or urine adhesively bonded together with hydrogen bonds, covalent bonds, or a combination of hydrogen bonds and covalent bonds by the solid adhesive formed from the initial flowable adhesive becoming substantially fully moisture cured into a rock hard clump with a clump moisture content of about 12% by clump weight, which has a clump crush strength of at least 40 PSI, preferably at least 60 PSI, more preferably at least 80 PSI, and even more preferably at least 100 PSI, and a clump retention rate of at least 95%, preferably at least 97%, more preferably at least about 99%.

In a preferred embodiment of the modified-starch water-absorbent clumping agent of each coated substrate litter granule of the litter of the present invention, the modified starch water absorbent clumping agent is composed of (1) a water swellable modified starch, preferably a cold water swellable modified starch, which also is water absorbent and which swells as water is absorbed, absorbing at least four and a half times, preferably at least six times the weight of the litter granule weight in room temperature water or cat body temperature urine, and (2) a water soluble modified starch binder, which preferably is a cold water soluble modified starch binder, which is at least partially cold water-soluble in room temperature water and at least partially soluble in cat body temperature urine, which forms a flowable exclusive upon becoming at least partially solubilized, flows from wetted litter granules, increases in viscosity during moisture curing into an adhesive gel which is tacky and adheres granules together with at least one of liquid adhesion, hydrogen bonding, and/or other intermolecular forces which even further increases in viscosity during further moisture curing into a bonding gel adheres granules together with at least one of hydrogen bonding and covalent bonding, and which becomes a substantially solid adhesive that is a glassy material having a glassy material state when substantially fully moisture cured to a moisture content of less than 15%, preferably no greater than 12% by weight. The water swellable modified starch, preferably cold water swellable modified starch of the modified starch water absorbent clumping agent in each litter granule is composed of native starch, such as native starch from one or more cereal grains, such as from or of one or more of corn or maize, rice, wheat, rye, barley, millet, triticale, oats, fonio, and sorghum, and/or one or more legumes, such as from or of one or more of beans, soybeans, peas, chickpeas, peanuts, lentils, lupins, mesquite, carob, tamarind, alfalfa, and/or clover, modified, preferably physically modified, so as to degrade granules of the starch and/or reduce a molecular weight of one or both of the amylose and/or amylopectin molecules of the native starch using a starch modification method or process, such as extrusion, where the native starch is processed in a starch-modifying machine, such as an extruder, preferably a single screw extruder, subjecting the native starch to an ultrahigh extrusion pressure of at least 2500 PSI, preferably at least 3000 PSI, more preferably at least 4000 PSI, even more preferably at least 5000 PSI, at an extrusion temperature of at least 100° Fahrenheit, within the extruder which modifies native starch into modified starch which is water-swellable water-absorbent modified starch, preferably cold water-swellable cold water-absorbent modified starch. The at least partially soluble, preferably at least partially cold water-soluble, modified starch binder of the modified starch water absorbent clumping agent of each litter granule also is composed of native starch, such as native starch from one or more cereal grains, such as one or more of corn or maize, rice, wheat, rye, barley, millet, triticale, oats, fonio, and sorghum, and/or one or more legumes, such as one or more of beans, soybeans, peas, chickpeas, peanuts, lentils, lupins, mesquite, carob, tamarind, alfalfa, and/or clover, which is modified, preferably physically modified, so as to degrade granules of the starch and/or reduce a molecular weight of one or both of the amylose and/or amylopectin molecules of the starch using a starch modification method or process, such as extrusion, where the native starch is processed in a starch-modifying machine, such as an extruder, preferably a single screw extruder, subjecting the native starch to an ultrahigh extrusion pressure of at least 2500 PSI, preferably at least 3000 PSI, more preferably at least 4000 PSI, even more preferably at least 5000 PSI, at an extrusion temperature of at least 100° Fahrenheit, in the extruder which modifies the native starch into modified starch which is an at least partially water soluble modified starch, preferably an at least partially cold water soluble modified starch composed of a water-activated moisture-curing binder that is activated by room temperature water and/or cat body temperature urine into a flowable adhesive having the properties and characteristics discussed hereinabove.

During making of coated substrate litter granules of the present invention, a comminuted form, preferably milled form, i.e., made by milling, of the modified-starch water-absorbent clumping agent is used that has relatively small particle sizes, smaller than even the smallest sized substrate particles, which preferably has particle sizes in the size range of a flour or powder, such as which pass through a 40-mesh screen, preferably pass through a 60-mesh screen, and even more preferably which pass through a 40-60 mesh screen and which rest upon a smaller mesh screen, such as an 80-mesh screen. In doing so, as-extruded pellets, such as made using the extrusion method above and/or as disclosed elsewhere herein, are milled using a milling machine into a powder or flour having the aforementioned mesh measurements disclosed above in this paragraph.

In one preferred embodiment and implementation of a method of making coated substrate litter granules, as-extruded pellets made in accordance with at least one of the modified starch water-absorbent clumping agent extrusion methods disclosed herein can be used as the modified starch water-absorbent clumping agent used to agglomerate with the substrate granules or particles to make a coated substrate litter in accordance with the present invention. In one such preferred embodiment and method implementation, as-extruded pellets can be mixed with water to form a slurry that is applied onto substrate granules or substrate particles in such a manner as discussed in more detail below. In another such preferred embodiment and method implementation, water can be applied onto substrate granules or substrate pellets in an agglomerator or coater, preferably a rotating or tumbling agglomerator or coater, before as-extruded pellets can be mixed therewith to agglomerate the substrate granules or substrate particles into coated substrate litter granules of the present invention in such a manner as also discussed in more detail below.

In another preferred embodiment and method implementation, as-extruded pellets are comminuted into smaller particles of modified starch water-absorbent clumping agent using a high-speed high shear mixer, such as a batch, in-line, or granulator high speed high shear mixer. In one such preferred embodiment and method implementation, as-extruded pellets are comminuted with water in such a high-speed shear mixer to form a substantially homogenous slurry of smaller sized pellet particles of modified starch water-absorbent clumping agent that is thereafter applied as a slurry onto substrate granules or substrate particles being agitated, preferably tumbled, in a rotary agglomerator or coater in such a manner as discussed in more detail below.

In yet another preferred embodiment and method implementation, the modified starch water-absorbent clumping agent is formed of a combination of powder or flour having the mesh measurements defined hereinabove and as-extruded pellets made in accordance with at least one of the modified starch water-absorbent clumping agent extrusion methods disclosed herein. In one such preferred embodiment and method implementation, a mixture of powdered or flour modified starch water-absorbent clumping agent and as-extruded pellets are homogenized into a water-containing slurry using a high-speed high shear mixer such as in the manner described hereinabove.

If desired, the modified-starch water-absorbent clumping agent can be in the form of particles of a cereal grain litter that were classified as being too small to be used in one or more of the extruded litters disclosed in in one or more of commonly owned U.S. Pat. Nos. 9,491,926, 10,028,481, 10,098,317, 10,882,238, 11,013,211, and/or 11,083,168, the entirety of each of which is hereby expressly incorporated by reference herein. Where needed, the particles of modified-starch water-absorbent clumping agent from rejected particles of extruded litter made in accordance with one or more of can be further size reduced, such as by milling, e.g. hammer milling, using another particle size reduction machine, and/or using another method of particle size reduction or particle comminution, such as the particle size reduction system, equipment and methods disclosed in commonly owned U.S. Pat. No. 11,013,211, the entirety of which is hereby expressly incorporated by reference herein.

As described in more detail herein, in a method of manufacturing self-clumping absorbent litter granules of a preferred litter in accordance with the present invention, these powder-like or flourlike relatively small particles of modified-starch water-absorbent clumping agent are wetted with an aqueous wetting liquid, such as water, thereby activating some, but not all, of the at least partially water-soluble binder in at least some, but not all, of the modified-starch water-absorbent clumping agent particles, causing at least some, but not all, of the modified-starch water-absorbent clumping agent particles to adhere while wet to the outer surface of each substrate particle and thereafter become adhesively bonded to the outer surface of each substrate particle when substantially completely moisture cured when dried, forming the inner adherence region between the inner substrate particle and the outer region of modified-starch water-absorbent clumping agent of each litter granule. The wetting of substantially all of the particles modified-starch water-absorbent clumping agent fee aqueous wetting liquid activates at least some, but not all, of the at least partially water-soluble binder of the remaining unadhered wetted particles of the modified-starch water-absorbent clumping agent causing at least some, but not all, of the modified-starch water-absorbent clumping agent particles contacting the inner adherence region to themselves to adhere while wet to the inner adherence region and thereafter become adhesively bonded thereto when substantially completely moisture cured when dried, forming one or more additional regions modified-starch water-absorbent clumping agent to each one of the litter granules being manufactured.

In one preferred litter granule manufacturing method, wetting of the modified-starch water-absorbent clumping agent particles is done by mixing dry powder-sized or flour-sized particles of the modified-starch water-absorbent clumping agent with the aqueous wetting liquid, preferably water, to form a slurry which then is applied onto the substrate particles, preferably while substantially simultaneously mixing the slurry in the substrate particles together, by tumbling, agitation or in another manner, such as by using a mixer, coater, blender, or another mixing device or arrangement causing the inner adhering region to form on the outer surface of each substrate particle before the outer region of modified-starch water-absorbent clumping agent becomes formed thereon. In another preferred litter granule manufacturing method, wetting of the modified-starch water-absorbent clumping agent particles is done indirectly by wetting the substrate particles with the aqueous liquid, preferably water, before applying the dry powder-sized or flour-sized particles of the modified-starch water-absorbent clumping agent onto the wetted substrate particles and preferably doing so while tumbling, agitating or otherwise mixing the wetted substrate particles and the applied modified-starch water-absorbent clumping agent particles causing water on the surfaces of the substrate particles to wet the modified-starch water-absorbent clumping agent particles coming into contact therewith causing the inner adhering region to form on the outer surface of each substrate particle. Preferably, one or more wetting cycles and the application cycles are performed where additional aqueous wetting liquid is applied onto the at least partially coated substrate particles during each rewetting cycle either substantially simultaneously with or substantially immediately followed by another application cycle where additional dry powder-sized or flour-sized particles of the modified-starch water-absorbent clumping agent are applied on the wetted at least partially coated substrate particles all while the tumbling, agitation or other mixing of the wetted at least partially coated substrate particles is being performed until one or more additional outer regions are added on top of the inner adhering region of each formed litter granule.

As a result of applying the aqueous wetting liquid, preferably water, onto the substrate particles at the beginning and the at least partially formed litter granules until a desirably thick coating of the modified-starch water-absorbent clumping agent particles accumulates on each substrate particle thereby forming a finished litter granule, wetting of the modified-starch water-absorbent clumping agent particles being applied on each substrate particle coalesces the modified-starch water-absorbent clumping agent particles of the outer region of each litter granules surrounding its inner substrate particle into an amorphous substantially homogeneous region of the modified-starch water-absorbent clumping agent material adhesively bonded when substantially completely moisture cured to its inner substrate particle of the finished litter granule. A preferred self-clumping absorbent granule of the present invention produced from a method of manufacture disclosed herein has an outer region of modified-starch water-absorbent clumping agent having a thickness of no greater than 1 mm, preferably no greater than 0.8 mm, and preferably no greater than about 0.5 mm, and even more preferably no greater than about 0.3 mm and having at least 50%, preferably at least 80%, more preferably at least 95%, even more preferably substantially the entire outer surface of each substrate particle of each litter granule being covered with the modified-starch water-absorbent clumping agent material. One preferred self-clumping absorbent granule of the present invention produced from a method of manufacture disclosed herein has an outer modified-starch water-absorbent clumping agent region of a thickness of between 20 microns, i.e., 0.02 mm, and 1000 microns, i.e., 1 mm, preferably between 20 microns, i.e., 0.02 mm, and 800 microns, i.e., 0.8 mm, more preferably between 20 microns, i.e., 0.02 mm, and 500 microns, i.e., 0.5 mm, and even more preferably between 20 microns, i.e., 0.02 mm, and 300 microns, i.e., 0.3 mm with at least 50%, preferably at least 80%, more preferably at least 95%, and even more preferably substantially the entire outer surface of each substrate particle of each litter granule covered with the modified-starch water-absorbent clumping agent material.

In a preferred embodiment, the rounded coated substrate litter granules are advantageously of a size that minimizes tracking of litter from the litter box during use and operation of the coated substrate litter of the present invention. The roundedness of the coated substrate litter granules advantageously helps prevent coated substrate litter granules from getting entrapped in a cat's paw during litter box use. In addition, the coated substrate litter granules are of a size that also helps prevent tracking by a cat from a litter box during litter box use by the cat. In a preferred embodiment, the coated substrate litter granules need to have a size bigger than a 25-mesh screen, i.e., larger than 25 mesh, but no bigger than a 10-mesh screen, i.e., no bigger than 10 mesh. At least 80% of the coated substrate litter granules should be smaller in size than 10 mesh and be bigger than 25 mesh (10/25). For example, in one embodiment, between 60% and 95%, and preferably at least about 80% (80%±15%), of the granules pass through a 12-mesh screen but are larger than a 25-mesh screen. The remainder of the coated substrate litter granules will be bigger than 10 mesh. Having rounded coated substrate litter granules with a particle size distribution of between 12 mesh and 20 mesh (12/20) provides the best feel for a cat's paw.

Therefore, in one preferred coated substrate cat litter embodiment, the coated substrate litter granules are generally rounded, have upraised projections, including spikes, and have a particle size distribution of between 12 mesh and 20 mesh (12/20) to produce a preferred embodiment of a low track litter in accordance with the present invention that minimizes tracking by a cat from a litter box. In another preferred coated substrate cat litter embodiment, the coated substrate litter granules are generally rounded, have upraised projections, including spikes, and have a particle size distribution of between 10 mesh and 25 mesh (10/25) to produce another preferred embodiment of a low track litter in accordance with the present invention that minimizes tracking by a cat from a litter box.

In a method of applying modified-starch water-absorbent clumping agent onto substrate particles to make self-clumping absorbent coated substrate litter granules of the present invention, depending on the type and size of the substrate particles, an amount of slurry containing a predetermined amount, e.g., predetermined weight or mass, of particles of modified-starch water-absorbent clumping agent is applied for a given amount, e.g., given weight or mass, of the substrate particles, with the respective predetermined amount of modified-starch water-absorbent clumping agent slurried in water selected based on the size or size range and given amount of the substrate particles to be coated and turned into self-clumping absorbent granules of the invention. In a preferred method of making self-clumping absorbent litter granules of the invention using a slurry of water and particles of modified-starch water-absorbent clumping agent, the slurry is applied onto substrate granules or substrate particles being tumbled in a rotating barrel or drum of a drum mixer, cement mixer, drum coater or the like using one or more spaced apart spray heads, nozzles, misters, or another type of slurry applicator or slurry dispenser that is configured or operated to controllably discharge the slurry onto the substrate particles in the rotating mixer or coater barrel in making self-clumping absorbent litter granules of the present invention. In another preferred method of applying modified starch water-absorbent clumping agent onto substrate granules or substrate particles to make self-clumping absorbent coated substrate litter granules of the present invention, the substrate particles are wetted with an aqueous wetting liquid, such as water, and dry particles of the modified starch water-absorbent clumping agent are applied while the substrate particles, modified starch water-absorbent clumping agent particles, and aqueous wetting liquid, preferably water, while initially the substrate particles and then the substrate particles, modified starch water-absorbent clumping agent particles, and aqueous wetting liquid, preferably water, are tumbled or otherwise agitated, such as preferably in a rotating barrel of a drum mixer, cement mixer, drum coater or the like to mix everything together. One or more cycles of wetting by application of aqueous wetting liquid, preferably water, onto the at least partially coated substrate particles followed by application of particles of modified starch water-absorbent clumping agent is performed as needed until each substrate particle has a desired amount of granule coating weight, e.g., coverage, and/or outer region thickness of modified starch water-absorbent clumping agent is achieved producing finished self-clumping absorbent litter granules of the present invention. Thereafter, the at least partially moist finished self-clumping absorbent litter granules are subjected to a moisture curing step that preferably is a moisture removal step, such as by drying the at least partially moist finished litter granules using convective drying with flowing air, preferably turbulently flowing air, directed at the litter granules, drying in a heated oven using one or more of radiant heat, convective drying with heated air, or another type of heated drying method, until moisture curing is complete or substantially complete in each one of the litter granules upon drying each granule to a moisture content of no greater than 12%, preferably greater than 10% and more preferably no greater than 8% by litter granule weight.

Where a slurry is used in making self-clumping absorbent coated substrate litter granules of the invention, the slurry is a slurry of water and relatively small particles of modified-starch water-absorbent clumping agent, preferably having the size of a powder or flour, whereby the modified-starch water-absorbent clumping agent particles are mixed with the water until a substantially uniform mixture or slurry is formed. As previously noted, mixing can be done using a high-speed high shear mixer. In a preferred slurry, the ratio of the amount of modified-starch water-absorbent clumping agent to water, when water is used as the aqueous wetting liquid, is about 1:1±10% by weight. The slurry is applied onto substrate granules or substrate particles while the substrate particles are being agitated, tumbled, or otherwise mixed, such as in a rotating barrel, drum or chamber of a mixer, coater or blender, thereby causing a region of modified-starch water-absorbent clumping agent to build up on each one of the substrate particles until a desired region thickness or a desired granule coating weight of the modified-starch water-absorbent clumping agent on the substrate particles is reached. Tumbling in a rotating barrel or drum type mixer or coater is preferred because it also ensures that the resultant coated substrate litter granule produced are rounded in the manner discussed above to minimize tracking from a litter box. The water in the slurry activates at least some, but not all, of the water-soluble modified starch binder, preferably cold water-soluble modified starch binder, in the modified-starch water-absorbent clumping agent particles in the slurry producing tacky gel(s) and flowable adhesive(s) which adheres modified-starch water-absorbent clumping agent particles to the substrate particles onto which the slurry is applied. This tackiness helps ensure the formation of upraised projections, including spikes, in the outer surface of the coated substrate granule which thereby enhances the amount and speed of water absorption during litter use. The slurry is applied onto the substrate particles while they are being agitated, tumbled, or mixed to not only facilitate more uniform adherence of modified-starch water-absorbent clumping agent particles to each substrate particle, but also to help prevent the at least partially coated substrate particles from agglomerating during slurry-based self-clumping absorbent litter granule manufacture. The slurry is applied on the substrate particles while they are being tumbled, agitated and/or mixed therewith until a desired thickness or granule coating weight of the modified-starch water-absorbent clumping agent particles on the substrate particles is reached. In a preferred method implementation, initial application of the slurry onto the substrate particles causes each one of the substrate particles to act as a litter granule nucleator causing modified-starch water-absorbent clumping agent in the slurry to adhere to the outer surface of each substrate particle forming an inner adhering region whose aqueous wetness more rapidly facilitates adherence of another outer region of modified-starch water-absorbent clumping agent.

In a preferred slurry application method, depending on the type and size of the substrate particles, an amount of slurry containing a predetermined amount, e.g., predetermined weight or mass, of particles of modified-starch water-absorbent clumping agent is applied for a given amount, e.g., given weight or mass, of the substrate particles, with the respective predetermined amount of modified-starch water-absorbent clumping agent slurried in water selected based on the size or size range and given amount of the substrate particles to be coated and turned into self-clumping absorbent granules of the invention. In a preferred method of making self-clumping absorbent litter granules of the invention using a slurry of water and particles of modified-starch water-absorbent clumping agent, the slurry is applied onto substrate particles being tumbled in a rotating barrel or drum of a drum mixer, cement mixer, drum coater or the like using one or more spaced apart spray heads, nozzles, misters, or another type of slurry applicator or slurry dispenser that is configured or operated to controllably discharge the slurry onto the substrate particles in the rotating mixer or coater barrel in making self-clumping absorbent litter granules of the present invention.

In a preferred slurry application method implementation, the amount and preferably the rate, such as the volumetric rate or metering, of application of the slurry onto the substrate particles is varied in real time during application of the slurry onto the substrate particles in order to (a) control amount of granule coating weight coverage and/or thickness of the modified-starch water-absorbent clumping agent that forms an outer region around each substrate particle, and (b) prevent substrate particles at least partially covered with a region of the modified-starch water-absorbent clumping agent from agglomerating while being tumbled, agitated or otherwise mixed. The ratio of the amount of modified-starch water-absorbent clumping agent to water can also be controllably regulated or varied in real time by as much as ±25%, such as 1:1 up to +25% or 1:1 down to −25%, during application of the slurry onto the substrate particles to control (a) water activation of the at least partially soluble modified starch binder, (b) the rate of granule coating weight coverage of modified-starch water-absorbent clumping agent that adheres and/or covers each one of the substrate particles, (c) the amount of granule coating weight coverage of modified-starch water-absorbent clumping agent that adheres and/or covers each one of the substrate particles, (d) the thickness of the outer region of the modified-starch water-absorbent clumping agent that adheres and/or covers each one of the substrate particles during making of litter granules of the present invention, (e) the viscosity of the slurry, and/or (f) prevent agglomeration of partially coated or partially formed litter granules while being tumbled, agitated or otherwise mixed.

In one preferred method implementation, the slurry formed can be and preferably is in the form of (a) a suspension composed of an aqueous wetting liquid, preferably water, and dry particles of modified-starch water-absorbent clumping agent mixed together, such as by using a high shear mixer, another suitable type of blender, or another suitable type of mixer, until the suspension is formed, or (b) an emulsion composed of the aqueous wetting liquid, preferably water, and dry particles of modified-starch water-absorbent clumping agent mixed together, such as by using a high shear mixer, another suitable type of blender, or another suitable type of mixer, until the suspension is formed. Where a slurry is used that is in the form of such an suspension, the suspension can include one or more surfactants, including one or more super surfactants, to facilitate suspension of dry powder sized or flour sized particles of modified-starch water-absorbent clumping agent in the aqueous wetting liquid, preferably water, during a slurry suspension mixing step where all of the constituents of the suspension are mixed together. Where a slurry is used that is in the form of such an emulsion, the emulsion can include (1) one or more surfactants, including one or more super surfactants, and/or (2) one or more emulsifiers to emulsify or facilitate emulsion all of the dry powder sized or flour sized particles of modified-starch water-absorbent clumping agent in the aqueous wetting liquid, preferably water, during a slurry emulsion mixing step where all of the constituents of the emulsion are mixed together. At least one of the viscosity, rate of modified-starch water-absorbent clumping agent coating thickness buildup, the amount of modified-starch water-absorbent clumping agent coating thickness, and/or the granule coating weight of modified-starch water-absorbent clumping agent on each substrate particle can be controlled during application of the slurry onto the substrate particles by controlling the ratio of water to modified-starch water-absorbent clumping agent in the slurry suspension or emulsion preferably in real time during application of the slurry suspension or emulsion onto the substrate particles. Such a slurry suspension or emulsion, preferably is a substantially homogenous suspension or emulsion of particles of modified-starch water-absorbent clumping agent suspended or emulsified in water, is applied onto substrate particles while the substrate particles are being agitated, tumbled or otherwise mixed thereby causing a region of modified-starch water-absorbent clumping agent to build up on an outer surface of each one of the substrate particles until a desired region thickness or a desired granule coating weight of the modified-starch water-absorbent clumping agent on the substrate particles is reached. The water in the slurry activates at least some, but not all, of the water-soluble modified starch binder, preferably cold water-soluble modified starch binder, in the modified-starch water-absorbent clumping agent particles in the slurry producing tacky gel(s) and flowable adhesive(s) which adheres the modified-starch water-absorbent clumping agent in the suspension or emulsion to the substrate particles onto which the slurry suspension or emulsion is applied. The slurry suspension or emulsion is applied onto the substrate particles while they are being agitated, tumbled or mixed not only to facilitate more uniform adherence of modified-starch water-absorbent clumping agent to each substrate particle, but also to help prevent the at least partially coated substrate particles/partially finished litter granules from agglomerating during application of the slurry suspension or emulsion while being tumbled, agitated or otherwise mixed during slurry-based self-clumping absorbent litter granule manufacture.

The slurry, slurry suspension, or slurry emulsion is applied on the substrate particles while they are being tumbled, agitated and/or mixed therewith until a desired thickness or granule coating weight of the modified-starch water-absorbent clumping agent particles on the substrate particles is reached thereby producing self-clumping absorbent litter granules of the present invention. Thereafter, the moisture of the finished litter granules is reduced to moisture cure the at least partially soluble modified starch binder which was activated during slurry application and formed a flowable adhesive and gel adhering one or more outer regions of the modified-starch water-absorbent clumping agent to each substrate particle. The moisture of the finished litter granules is reduced to a moisture content of no greater than 12%, preferably no greater than 10% and more preferably no greater than about 8% by finished litter granule weight to substantially completely moisture cure the water-activated at least partially soluble modified starch binder, flowable adhesive and gel into a solid adhesive in a glassy material state adhesively bonding the outer region of modified-starch water-absorbent clumping agent to each inner substrate particle. At least a portion of the at least partially soluble modified starch binder in the outer region of modified-starch water-absorbent clumping agent of each finished self-clumping absorbent litter granule of the present invention remains un-activated and/or uncured thereby ready to be wetted with water, such as room temperature water, or urine, such as urine at cat body temperature, and at least partially solubilize into flowable adhesive that flows from the wetted litter granules long and in between contacting litter granules and litter granules adjacent thereto increasing in viscosity during initial moisture curing into an adhesive or adherent gel which transitions into a bonding gel as further moisture curing occurs which finally transition into a solid adhesive in a glassy starch state that bonds the contacting litter granules and adjacent litter granules together into a clump that becomes substantially rock hard when moisture curing due to moisture evaporation, clump is complete. Moisture curing of the clump preferably is complete when moisture content of the clump is no greater than about 12% by clump weight, due to moisture evaporation from the clump during drying of the clump, such as air drying of the clump in the litter box, producing a substantially rock hard clump having a clump retention rate of at least 95%, preferably at least 97%, more preferably at least 99% and/or a clump cross strength of at least 40 PSI, preferably 60 PSI, more preferably 80 PSI, and even more preferably 100 PSI when fully moisture cured.

The substrate granules or substrate particles can be organic, inorganic, smooth, rough, round, cylindrical, irregularly shaped, porous, non-porous, water absorbent, impervious to water, smooth, and/or rough, and preferably non-clumping, i.e., composed of a material whose particles do not agglomerate into clumps when the particles are wetted with water. Preferred substrate materials include nut shells or hulls, wood, paper, sand, perlite, and bentonite crushed, ground, milled or otherwise comminuted into relatively small sized substrate particles at least partially coated with a modified-starch water-absorbent clumping agent preferably in the form of a starch-based water-absorbent clump-facilitating material to form the self-clumping litter granules of the invention having an outer region of the modified-starch water-absorbent clumping agent at least partially covering and preferably substantially completely encapsulating each one of the substrate particles. The modified-starch water-absorbent clumping agent, preferably in the form of a starch-based water-absorbent clump facilitating material, which more preferably is a swelling and gelling material composed of modified starches configured by starch modification, preferably by extrusion, more preferably by ultrahigh pressure extrusion using a single screw extruder, to rapidly swell and absorb water and gel while doing so and which preferably also contains at least some previously native or unmodified starch modified into an at least partially water-soluble binder that at least partially solubilizes and flows upon water-wetting forming a flowable adhesive that adheres the swelling and gelling material to the substrate particles during manufacture of the litter granules. A preferred modified-starch water-absorbent clumping agent in the preferred form of a starch-based water-absorbent clump facilitating material more preferably is a starch-based sorbent swelling biopolymeric gellant, e.g., comprised of a gelling biopolymer or biopolymer which gels, preferably forms a gel, upon wetting, and is composed of a cold-water soluble extrusion-modified starch binder and a cold-water swellable extrusion-modified sorbent starch which preferably is or includes a cold-water swellable extrusion-modified cold water absorbent starch comminuted or otherwise particle sized reduced into the form of a flour or powder that coats the substrate particles when wetted. If desired, the powder or flour particles of such a modified-starch water-absorbent clumping agent are rejected or unused pellets or particles of an extruded cereal grain litter that were classified as being too small to be used in one or more of the litters disclosed in in one or more of commonly owned U.S. Pat. Nos. 9,491,926, 10,028,481, 10,098,317, 10,882,238, 11,013,211, and/or 11,083,168, the disclosure of each of which is expressly incorporated by reference herein. The resultant litter granules form a removably clumpable litter of the present invention as each granule has an outer self-clumping water-absorbent region surrounding an inner substrate particle whereby the outer region rapidly absorbs and swells upon contact with water with at least some of the outer region at least partially solubilizing and forming a flowable adhesive that flows therefrom along and in between contacting and adjacent litter granules and which also gels during agglomeration of the wetted litter granules into a clump thereof that is scoopable from the litter.

In a method of making self-clumping coated substrate litter granules of the present invention, a desired or predetermined amount of substrate particles having particle sizes falling within a desired particle size range or particle size distribution can be (a)(1) wetted with water while being agitated, (2) mixed with a modified-starch water-absorbent clumping agent that preferably is in the form of the starch-based water-absorbent clump facilitating flour or powder while continuing to be agitated while water is wetting outer surfaces of the substrate particles causing (i) some, but not all, of its water-soluble binder to at least partially solubilize and form flowable adhesive causing the starch-based water-absorbent clump facilitating flour or powder to adhere to the outer surfaces of the substrate particles, and (ii) gelling of some, but not all, of at least a plurality, preferably at least a plurality of pairs, i.e., at least three, of different types of modified starches in the starch-based water-absorbent clump facilitating flour or powder which thereby coalesces the wetted flour or powder particles together into an amorphous substantially homogenous mass of starch-based water-absorbent clump facilitating material around each of the substrate particles that forms the outer region thereon producing finished litter granules of the invention, which are then dried, such as with turbulently flowing air, heated air, and/or radiant heat directed towards and/or against the finished litter granules. Drying is done to reduce the moisture content of the still moist finished litter granules until each litter granules has less than 12%, preferably less than 10%, more preferably no more than 8% moisture content by granule weight. Moisture reduction is done to moisture cure the water soluble adhesive into a solid adhesive bonding the outer region starch-based water-absorbent clump facilitating material to the outer surface of each inner substrate particle as well as to prevent water activation and/or further moisture curing of at least some of the at least partially soluble binder of each finished litter granule, preferably by preventing retrogradation thereof, so that at least some water-activatable at least partially soluble binder in each granule remains available to clump granules together when wetted with water or urine.

The moisture removal step, preferably drying step, can be and preferably is performed while the newly finished still moist granules continue to be mixed, e.g., agitated, to cure the binder adhesively attaching the outer self-clumping water-absorbent region to the inner substrate particle while simultaneously preventing water-activation of binder within the portion of the outer region of the starch-based water-absorbent clump facilitating material not adhesively bonding the outer region to the outer surface of each substrate particle. The moisture removal step, preferably drying step, can be and preferably is performed while partially coated litter granules, e.g., partially finished litter granules, are being wetted and/or rewetted, including while further applications of the dry starch-based water-absorbent clump facilitating flour or powder material are performed while everything is being mixed, e.g., activated, such as in a barrel or drum of a mixer. While the moisture removable step, e.g., drying step, can be performed while the substrate particles are being coated with a slurry of the starch-based water-absorbent clump facilitating flour or powder and water, including during mixing of everything together, the moisture removable step preferably is performed after completion of the slurry application step.

In a preferred coated substrate litter and coated substrate litter granule embodiment, the modified-starch water-absorbent clumping agent is in the form of a starch-based water-absorbent clump facilitating flour or powder which is comprised of at least a plurality, preferably at least a plurality of pairs, i.e., at least three, of different types of modified starches, which each different type of modified starch having a molecular weight that is different, preferably less, than the unmodified or native starch from which the corresponding modified starch is formed. Each one of the different types of modified starches are formed from unmodified or native starches, such as preferably unmodified amylose starch and amylopectin starch, in one or more cereal grains and/or legumes in a cereal grain and/or legume containing admixture where the unmodified or native starches in the admixture are modified during extrusion using a single screw extruder at an ultrahigh extrusion pressure of at least 2500 PSI, preferably at least 3000 PSI, more preferably at least 4000 PSI, and even more preferably at least 5000 PSI, which modifies the unmodified or native starches to produce modified-starch water-absorbent clumping agent in the form of the starch-based water-absorbent clump facilitating material extrudate that is used in flour or powdered form in making self-clumping absorbent litter granules of the litter of the present invention.

A substrate water wetting method of making coated substrate litter granules of the invention involves wetting the substrate particles before applying the modified-starch water-absorbent clumping agent, preferably in the form of the starch-based water-absorbent clump facilitating flour or powder, with a greater amount of water used than the amount of modified-starch water-absorbent clumping agent flour or powder used, preferably starch-based water-absorbent clump facilitating flour or powder used. Water is added until the substrate granules or substrate particles begin agglomerate rating onto themselves to achieve proper wetting before adding any modified-starch water-absorbent clumping agent, whether it be in powder or flour form, the form of extruded pellets, or in the form of comminuted extruded pellets, e.g., comminuted using a high-speed high shear mixer.

In one method implementation, a ratio of between 6:1 and 10:1, preferably between 7:1 and 9:1, more preferably about 8:1 of water to modified-starch water-absorbent clumping agent flour or powder, preferably starch-based water-absorbent clump facilitating flour or powder, is used during the application step to coat the substrate granules or substrate particles with the modified-starch water-absorbent clumping agent flour or powder, preferably starch-based water-absorbent clump facilitating flour or powder. In carrying out the substrate water wetting method, a plurality of cycles of wetting the substrate, applying dry modified-starch water-absorbent clumping agent flour or powder, preferably dry starch-based water-absorbent clump facilitating flour or powder, to each one of the wetted substrate particles, wetting or rewetting the mixture thereof with additional water, applying more dry modified-starch water-absorbent clumping agent flour or powder, preferably dry starch-based water-absorbent clump facilitating flour or powder, to the at least partially coated wetted substrate granules or substrate particles are performed while the substrate granules or substrate particles and modified-starch water-absorbent clumping agent flour or powder, preferably starch-based water-absorbent clump facilitating flour or powder, are continuously mixed by tumbling, rolling, or another form of agitation preferably in a rotating barrel or rotating drum of a drum coater, cement mixer, drum mixer, mixing blender, or the like.

The slurry method uses much less water in comparison to the amount of particulate modified-starch water-absorbent clumping agent, preferably in the form of starch-based water-absorbent clumping agent flour or powder, preferably using between 0.5:1 to 2:1 and more preferably about 1:1 of water to particulate modified-starch water-absorbent clumping agent, preferably starch-based water-absorbent clump facilitating flour or powder, mixed together before applying the slurry onto the substrate particles and preferably mixing everything together. Mixing preferably is performed by tumbling in a mixer, e.g., pin mixer, drum coater, cement mixer, blender, e.g., ribbon blender, or using another type of mixing or blending device. In a preferred method implementation, a continuous slurry process is employed where the water and particulate modified-starch water-absorbent clumping agent, preferably in the form of starch-based water-absorbent clump facilitating flour or powder, are mixed and stored in a tank, vat or other vessel from which the slurry can be substantially continuously pumped to one or more misters, sprayers, nozzles, dispensers or other applicators that discharge the slurry onto the substrate particles while they are in a rotating drum, in a rotating barrel, or being carried on a conveyor while the substrate particles pass underneath the misters, sprayers, nozzles, dispensers or applicators in a continuous application process that preferably is a continuous flow application process. In another preferred method implementation, the slurry can be applied, such as using a mister, sprayer, nozzle, dispenser or other applicator, to substrate particles being agitated, tumbled, or otherwise mixed together, such as in a drum coater, drum mixer, concrete mixer, pin mixer, ribbon blender or other type of suitable blender or mixer to more uniformly coat the particles with particulate modified-starch water-absorbent clumping agent, preferably starch-based water-absorbent clump facilitating flour or powder, in or from the slurry advantageously producing self-clumping sorbent litter granules of the invention having a substantially homogenous outer region of modified-starch water-absorbent clumping agent, preferably starch-based water-absorbent clump facilitating material, of substantially the same thickness from litter granule to litter granule substantially completely encapsulating each one of the substrate particles therewith. Tumbling, rolling or otherwise agitating the particles during the modified-starch water-absorbent clumping agent application process, preferably starch-based water-absorbent clump facilitating material application process preferably in a rotating generally cylindrical or barrel or drum of coater, mixer or the like builds up an outer region of the modified-starch water-absorbent clumping agent, preferably starch-based water-absorbent clump facilitating material, which fills in any pockets and voids in the outer surface of the substrate particles also smoothing over other substrate particle surface irregularities advantageously producing a litter granule having a substantially smooth rounded exterior surface that does not hurt the paws of cats who have been declawed and is non-tracking is the smooth rounded granules are not readily picked up on cat's paws and tracked outside the litterbox onto areas of the floor outside the litterbox. Where the substrate particles are generally round, such as where substrate particles of paper, i.e., paper balls, are used, the resultant self-clumping, absorbent litter granules of the present invention which are produced each have an outer region of the modified-starch water-absorbent clumping agent, preferably starch-based water-absorbent clump facilitating material that is substantially smooth, which is rounded, and preferably produces litter granules that are substantially round and/or generally spherical, e.g., self-clumping absorbent litter granule balls of the present invention.

As previously noted, the rounded coated substrate litter granules are advantageously of a size that minimizes tracking of litter from the litter box during use and operation of the coated substrate litter of the present invention. The roundedness of the coated substrate litter granules advantageously helps prevent coated substrate litter granules from getting entrapped in a cat's paw during litter box use. In addition, the coated substrate litter granules are of a size that also helps prevent tracking by a cat from a litter box during litter box use by the cat. In a preferred embodiment, the coated substrate litter granules need to have a size bigger than a 25-mesh screen, i.e., larger than 25 mesh, but no bigger than a 10-mesh screen, i.e., no bigger than 10 mesh. At least 80% of the coated substrate litter granules should be smaller in size than 10 mesh and be bigger than 25 mesh (10/25). For example, in one embodiment, between 60% and 95%, and preferably at least about 80% (80%±15%), of the granules pass through a 12-mesh screen but are larger than a 25-mesh screen. The remainder of the coated substrate litter granules will be bigger than 10 mesh. Having rounded coated substrate litter granules with a particle size distribution of between 12 mesh and 20 mesh (12/20) provides the best feel for a cat's paw.

Therefore, in one preferred coated substrate cat litter embodiment, the coated substrate litter granules are generally rounded, have upraised projections, including spikes, and have a particle size distribution of between 12 mesh and 20 mesh (12/20) to produce a preferred embodiment of a low track litter in accordance with the present invention that minimizes tracking by a cat from a litter box. In another preferred coated substrate cat litter embodiment, the coated substrate litter granules are generally rounded, have upraised projections, including spikes, and have a particle size distribution of between 10 mesh and 25 mesh (10/25) to produce another preferred embodiment of a low track litter in accordance with the present invention that minimizes tracking by a cat from a litter box.

In a method of making self-clumping sorbent litter in accordance with the present invention, at least a plurality of different types, preferably at least a plurality of pairs of, i.e., at least three, different types of substrate particles are substantially simultaneously coated with an outer region of the modified-starch water-absorbent clumping agent during making of a batch of a litter of the present invention composed of self-clumping litter granules of the invention with at least a plurality of different types of substrate particles, preferably at least a plurality of pairs of i.e. at least three, different types of substrate particles. In one such method, at least one type of substrate particle is an organic substrate particle that is lower density than other type of inorganic substrate particle, preferably a functional substrate particle, whereby both types of substrate particles are substantially simultaneously coated or covered with particulate modified-starch water-absorbent clumping agent using either the slurry or the aqueous wetting liquid wetting and re-wetting litter granule manufacturing method.

In a preferred embodiment, the modified-starch water-absorbent clumping agent preferably is a starch-based water-absorbent clump facilitating material which is made by extruding a starch-based admixture, such as the aforementioned admixture containing one or more cereal grains and/or one or more legumes, from an extruder at a relatively low moisture content of no more than about 25% by weight at an ultrahigh extruder pressure of at least 2500 PSI, preferably at least 3000 PSI, more preferably at least 4000 PSI, and even more preferably 5000 PSI thereby extruding a modified-starch water-absorbent clumping agent preferably in the form of a starch-based water-absorbent clump facilitating material that more preferably is or comprises a starch-based sorbent swelling biopolymeric gellant containing modified starches modified in the extruder by ultrahigh extrusion pressure that swells and gels upon sorption, including absorption, of a liquid, such as an aqueous liquid, such as water at room temperature, or an aqueous solution, such as urine at the temperature of the body of a cat, which preferably is comprised of at least some of the starch in the admixture ultrahigh pressure extrusion modified into a cold water soluble binder and at least some of the other starch in the admixture ultrahigh pressure extrusion modified into a cold water swellable water absorbent modified starch. In one preferred litter granule embodiment and litter granule making method, waste fines from a process of making an absorbent starch-based litter, such as the extruded cereal-grain based litters disclosed in one or more of commonly owned U.S. Pat. Nos. 9,491,926, 10,028,481, 10,098,317, 10,882,238, 11,013,211, and/or 11,083,168, the entirety of each of which is expressly incorporated by reference herein, are either used as the particulate modified-starch water-absorbent clumping agent starch-based, preferably particulate water-absorbent clump facilitating material, which is applied directly or in a slurry onto the substrate particles or are ground, milled, comminuted or otherwise particle size reduced into even smaller flour or powder sized particles having the mesh sizes and/or mesh size ranges in accordance with those discussed elsewhere herein that are applied or slurried onto the substrate particles. Where the particulate modified-starch water-absorbent clumping agent, preferably in the form of starch-based water-absorbent clump facilitating particulate material, more preferably comprised of starch-based sorbent swelling biopolymeric gellant, is used in powder sized particulate form, the powder-sized particles preferably have a particle size smaller than 1,000 μm and preferably is composed of particles ranging in size from between 100 μm and 400 μm. Where the particulate modified-starch water-absorbent clumping agent, preferably in the form of starch-based water-absorbent clump facilitating particulate material, more preferably comprised of starch-based sorbent swelling biopolymeric gellant, is used in flour sized particulate form, the flour-sized particles preferably have particle sizes that pass through a 40-mesh screen, preferably pass through a 60-mesh screen, and even more preferably which pass through a 40-60 mesh screen and which rest upon an 80-mesh screen. Such extremely small particle sizes enable rapid wetting and activation of water-soluble binder in some of the particles but not all the water-soluble binder in the particles contacting and being applied onto the larger substrate particles.

The end result produces substantially instantly self-clumping, water-absorbent litter granules which are not friable, which minimizes dust creation during storage, packaging, shipment and actual litter use, which preferably reduce dust by attracting dust particles causing them to adhere thereto, which has a rounded granule shape to minimize cat tracking the litter granules out of the litter box, which has a smooth rounded exterior which do not hurt paws of de-clawed cats, and which forms a clump having a clump retention rate of at least 95%, preferably at least 97%, more preferably at least 99% which means the clump retains at least 95%, preferably at least 97%, more preferably at least 99% of its weight or mass, when a clump formed of litter granules wetted with 10 milliliters of water or urine and dried to a moisture content of about 12% by clump weight, is drop tested from a height of about ten inches onto a perforate mesh screen. In another preferred embodiment, each clump has a clump retention rate of at least 95%, preferably at least 97%, more preferably at least 99%, which means the clump retains at least 95%, preferably at least 97%, more preferably at least 99% of its weight or mass, when such a clump formed of litter granules wetted with 15 milliliters of water or urine and dried to a moisture content of about 12%, is drop tested from a height of about ten inches onto a mesh screen. In yet another preferred embodiment, each clump has a clump retention rate of at least 95%, preferably at least 97%, more preferably at least 99%, which means the clump retains at least 95%, preferably at least 97%, more preferably at least 99% of its weight or mass, when such a clump formed of litter granules wetted with 10 milliliters of water or urine and dried to a moisture content of about 12%, is drop tested from a height of about twelve inches onto the mesh screen. In still yet another preferred embodiment, each clump has a clump retention rate of at least 95%, preferably at least 97%, more preferably at least 99%, which means the clump retains at least 95%, preferably at least 97%, more preferably at least 99% of its weight or mass, when such a clump formed of litter granules wetted with 15 milliliters of water or urine and dried to a moisture content of about 12%, is drop tested from a height of about twelve inches onto the mesh screen. Each such clump dried to a moisture content of about 12% also has a clump crush strength of at least 40 PSI, preferably at least 60 PSI, more preferably 80 PSI and even more preferably 100 PSI.

In another preferred litter granule embodiment and manufacturing method, the outer region of each litter granule surrounding the inner substrate particle is composed of modified-starch water-absorbent clumping agent formed by or during ultrahigh pressure extrusion as discussed elsewhere herein that is comprised of at least one of (a) an at least partially water soluble water-activated moisture-curing modified starch binder, which is or comprises a thermoplastic modified starch component, which can be repeatedly wetted and dried and still retain its water-soluble binder and/or water-activated moisture curing adhesive properties, and (b) a one-shot at least partially water soluble water-activated moisture-curing modified starch binder, which is or comprises a thermoset modified starch component or thermosetting modified starch component whose adhesive, such as a gel or flowable adhesive, formed upon being wetted with water or urine is water activated a single time and moisture cures a single time as it dries such that it irreversibly moisture cures as it dries to a moisture content of no greater than 15%, preferably about 12% by weight, preferably clump weight, upon a clump the litter granules of the invention being formed and dried. The original folding of one or more of the proteins in the starch containing admixture is modified during ultrahigh pressure extrusion resulting from forces exhibited thereon during ultrahigh pressure extrusion due to the extrusion temperature, ultrahigh extrusion pressure and the shear forces exhibited thereon during extrusion forming proteins whose folding is modified in a manner that causes crosslinking of some of the extrusion modified starch, such as extrusion modified amylopectin and/or extrusion modified amylose, thereby forming an at least partially water soluble water-activated and moisture cured thermoplastic binder that is reversible in that rewetting, re-solubilization, flowable adhesive creation, gelling, and moisture-curing by drying can be done repeatedly, preferably indefinitely repeatedly.

The end result also produces substantially instantly self-clumping, water-absorbent litter granules which are not friable, which minimizes dust creation during storage, packaging, shipment and actual litter use, which preferably reduce dust by attracting dust particles causing them to adhere thereto, which has a rounded granule shape to minimize cat tracking the litter granules out of the litter box, which has a smooth rounded exterior which do not hurt paws of de-clawed cats, and which forms a clump having a clump retention rate of at least 95%, preferably at least 97%, more preferably at least 99% which means the clump retains at least 95%, preferably at least 97%, more preferably at least 99% of its weight or mass, when a clump formed of litter granules wetted with 10 milliliters of water or urine and dried to a moisture content of about 12% by clump weight, is drop tested from a height of about ten inches onto a perforate mesh screen. In another preferred embodiment, each clump has a clump retention rate of at least 95%, preferably at least 97%, more preferably at least 99%, which means the clump retains at least 95%, preferably at least 97%, more preferably at least 99% of its weight or mass, when such a clump formed of litter granules wetted with 15 milliliters of water or urine and dried to a moisture content of about 12%, is drop tested from a height of about ten inches onto a mesh screen. In yet another preferred embodiment, each clump has a clump retention rate of at least 95%, preferably at least 97%, more preferably at least 99%, which means the clump retains at least 95%, preferably at least 97%, more preferably at least 99% of its weight or mass, when such a clump formed of litter granules wetted with 10 milliliters of water or urine and dried to a moisture content of about 12%, is drop tested from a height of about twelve inches onto the mesh screen. In still yet another preferred embodiment, each clump has a clump retention rate of at least 95%, preferably at least 97%, more preferably at least 99%, which means the clump retains at least 95%, preferably at least 97%, more preferably at least 99% of its weight or mass, when such a clump formed of litter granules wetted with 15 milliliters of water or urine and dried to a moisture content of about 12%, is drop tested from a height of about twelve inches onto the mesh screen. Each such clump dried to a moisture content of about 12% also has a clump crush strength of at least 40 PSI, preferably at least 60 PSI, more preferably 80 PSI and even more preferably 100 PSI.

The present invention also is directed to a self-clumping sorbent granular litter composed of at least partially cold-water soluble water-activated moisture-curing binder-containing self-clumping and cold-water swellable water-absorbent starch-containing sorbent litter granules of the present invention each composed of an inner substrate, such as of a non-clumping material, that preferably is a coating nucleating substrate particle which has an exterior surface wetted with an aqueous liquid, preferably water, or is treated with a slurry of water and a particulate modified-starch water-absorbent clumping agent such that the substrate particle becomes a nucleator to which an outer region of the modified-starch water-absorbent water-activated clumping agent, which preferably is a self-clumping modified-starch containing material, adheres which more preferably is comprised of an extruded at least partially cold-water soluble water-activated moisture-cured binder-containing self-clumping and cold-water swellable water-absorbent modified-starch containing material. This particulate material, preferably having particles sizes of a flour or powder is applied and adheres while wet and becomes adhesively bonded to the outer surface of the substrate particles, such as by hydrogen bonds and/or preferably covalent bonds, during moisture curing of the finished moist litter granules by drying the litter granules. The at least partially cold-water soluble water-activated moisture-curing binder-containing self-clumping and cold-water swellable water-absorbent modified starch containing particulate material is formed by extruding a starch-containing admixture containing a relatively low-moisture content of no greater than about 25% by admixture weight using a single screw extruder under an ultrahigh extrusion pressure of at least 2500 PSI, preferably at least 3000 PSI, more preferably at least 4000 PSI, and even more preferably at least 5000 PSI to gelatinize at least a first amount of the starch in the admixture in the extruder during ultrahigh pressure extrusion, to modify, such as thermally modify and/or mechanically modify, a second amount of the admixture starch by being subjected to ultrahigh extrusion pressures in the extruder during extrusion into forming therefrom at least 5% by extrudate weight, preferably at least 7.5% by extrudate weight, more preferably at least 10% by extrudate weight of at least partially cold water-soluble ultrahigh extrusion pressure water-activated moisture-cured modified starch binder in the extrudate extruded from the extruder, and to modify, such as thermally modify and/or mechanically modify, a third amount of the admixture starch in the extruder during ultrahigh pressure extrusion into forming therefrom at least 5% by extrudate weight, preferably at least 10% by extrudate weight, more preferably at least 20% by extrudate weight of cold water-swellable ultrahigh extrusion pressure modified water-absorbent starch in the extrudate extruded from the extruder.

The present invention also is directed to a method of making such a self-clumping sorbent granular litter composed of water-sorbent litter granules which self-clump together when wetted with water composed of a particulate substrate with an exterior of a sorbent clumping material extruded from a starch-containing material under extrusion conditions which forms a cold-water swellable extrusion-modified water-sorbent starch, which preferably is or includes, e.g., is comprised of, a cold-water swellable extrusion-modified water-absorbent starch, and at least partially cold-water soluble extrusion-modified water-activated moisture-curing starch binder. In a preferred self-clumping granular litter of the invention, each self-clumping sorbent litter granule is formed of a smaller inner particle of a substrate, such as a substrate made of a non-clumping material, which can also be a non-absorbent material, even a non-sorbent material, to which even smaller particles of the extruded self-clumping sorbent material, such as a powder or flour of the extruded self-clumping sorbent material, are applied and adhered. The extruded self-clumping sorbent material of each litter granule covers or surrounds at least a majority of an outer surface of the inner substrate particle of each granule, preferably covers or surrounds at least 65% of the outer surface of the inner substrate particle of each granule, and more preferably covers or surrounds at least 75% of the outer surface of the inner substrate particle of each coated litter substrate granule. Each litter granule is composed of between 2% and 30% by volume, preferably between 3% and 27% by volume, and more preferably between 5% and 25% by volume of the extruded self-clumping sorbent material. Each litter granule of the present invention is composed of between 2% and 30% by weight, preferably between 3% and 27% by weight, and more preferably between 5% and 25% by weight of the extruded self-clumping sorbent material.

The extruded at least partially water-soluble water-activated moisture-cured modified starch binder containing self-clumping sorbent material of each self-clumping absorbent coated substrate litter granule contains a cold-water swellable extrusion-modified water-sorbent starch, preferably a cold-water swellable extrusion-modified water-absorbent starch, which absorbs at least two times its own weight in water, preferably absorbs at least three times its own weight in water, more preferably absorbs at least four times its own weight in water, even more preferably absorbs at least six times its own weight in water. The extruded at least partially water-soluble water-activated moisture-cured modified starch binder containing self-clumping sorbent material of each self-clumping absorbent coated substrate litter granule contains cold-water swellable extrusion-modified water-sorbent starch, preferably cold-water swellable extrusion-modified water-absorbent starch, in an amount sufficient in each litter granule for the coating on the substrate of each coated substrate litter granule to sorb, preferably absorb, at least a plurality of pairs of, i.e., at least three, times the weight of the substrate coating in water, urine, or a synthetic urine, preferably sorb, preferably absorb, at least four times substrate coating weight in water, urine, or a synthetic urine, more preferably sorb, preferably absorb, at least five times coating weight in water, urine, or a synthetic urine, even more preferably sorb, preferably absorb, at least six times coating weight in water, urine, or a synthetic urine, including during actual use of these litter granules in a self-clumping litter of the present invention composed of at least 60%, preferably at least 75%, and more preferably at least 85% by litter weight of the coated substrate litter granules of the present invention. In at least one preferred embodiment, the extruded self-clumping sorbent material of each coated substrate litter granule contains a cold-water swellable extrusion-modified water-sorbent starch, preferably a cold-water swellable extrusion-modified water-absorbent starch, in an amount sufficient in each coated substrate litter granule for the coating of each coated substrate litter granule to sorb, preferably absorb, at least a plurality of pairs of, i.e., at least three, times the weight of the substrate coating in water, urine, or a synthetic urine, preferably sorb, preferably absorb, at least four times coating weight in water, urine, or a synthetic urine, more preferably sorb, preferably absorb, at least five times coating weight in water, urine, or a synthetic urine, and even more preferably sorb, preferably absorb, at least six times coating weight in water, urine, or a synthetic urine during wetting of the granule with water, urine, or synthetic urine.

The extruded self-clumping sorbent material of each coated substrate litter granule contains a cold-water swellable extrusion-modified water-sorbent starch, preferably a cold-water swellable extrusion-modified water-absorbent starch, in an amount sufficient in each coated substrate litter granule for the outer coating of each coated substrate litter granule to sorb, preferably absorb, at least a plurality of pairs of, i.e., at least three, times the weight of the substrate coating in water, urine, or a synthetic urine, preferably sorb, preferably absorb, at least four times litter coating weight in water, urine, or a synthetic urine, more preferably sorb, preferably absorb, at least five times coating weight in water, urine, or a synthetic urine, and even more preferably sorb, preferably absorb, at least six times coating weight in water, urine, or a synthetic urine during wetting of the coated substrate granule with water, urine, or synthetic urine, including during actual use of a self-clumping litter of the present invention composed of at least 60%, preferably at least 75%, and more preferably at least 85% by litter weight of the coated substrate litter granules of the present invention. In one preferred embodiment, the extruded self-clumping sorbent material of each coated substrate litter granule contains a cold-water swellable extrusion-modified water-sorbent starch, preferably a cold-water swellable extrusion-modified water-absorbent starch, in an amount sufficient in each coated substrate litter granule for the coating of each coated substrate litter granule to sorb, preferably absorb, at least a plurality of pairs of, i.e., at least three, times the weight of the coating of the litter granule in water, urine, or a synthetic urine, preferably sorb, preferably absorb, at least four times substrate coating weight in water, urine, or a synthetic urine, more preferably sorb, preferably absorb, at least five times coating weight in water, urine, or a synthetic urine, and even more preferably sorb, preferably absorb, at least six times coating weight in water, urine, or a synthetic urine during wetting of the granule with water, urine, or synthetic urine, including during actual use of a self-clumping litter of the present invention composed of at least 60% and no more than 75%, i.e., between 60%-75%, preferably at least 75% and no more than 90%, i.e., between 75%-90%, and more preferably at least 90% and up to 100%, i.e., between 90%-100%, of the coated substrate litter granules of the present invention by total weight of the litter. The extruded self-clumping sorbent material of each coated substrate litter granule preferably is composed of at least 5%, preferably at least 7.5%, more preferably at least 10%, and even more preferably at least 15% of the cold-water swellable extrusion-modified water-sorbent starch, which preferably is or includes at least some cold-water swellable extrusion-modified water-absorbent starch by extruded self-clumping sorbent material weight. In a preferred litter granule embodiment, the extruded self-clumping coated substrate granule preferably is composed of at least 5%, preferably at least 7.5%, more preferably at least 10%, and even more preferably at least 15% of cold-water swellable extrusion-modified water-absorbent starch by weight of the extruded self-clumping sorbent material of each coated substrate litter granule.

To produce such a litter composed of at least 60% and no more than 75%, i.e., between 60%-75%, preferably at least 75% and no more than 90%, i.e., between 75%-90%, and more preferably at least 90% and up to 100%, i.e., between 90%-100%, of self-clumping sorbent coated substrate litter granules of the present invention by litter weight that also is a self-clumping litter that forms scoopable clumps of the self-clumping sorbent litter granules when wetted with water, urine or synthetic urine, the extruded self-clumping sorbent material of each self-clumping sorbent coated substrate litter granule of the litter contains enough at least partially cold-water soluble extrusion-modified water-activated moisture-cured starch binder for at least some of the water-activated moisture-cured at least partially cold-water soluble extrusion-modified starch binder in the extruded self-clumping sorbent material of each self-clumping sorbent coated substrate litter granule to at least partially or even completely solubilize when the self-clumping sorbent litter granule is wetted with water, urine or synthetic urine and form a flowable adhesive therefrom that flows from the wetted self-clumping sorbent coated substrate litter granule along and in between at least a plurality of contacting litter granules and/or at least a plurality of adjacent litter granules, preferably which also have been wetted with the water, urine or synthetic urine, forming a clump thereof that is scoopable from the litter using a handled litter scoop. In one such preferred self-clumping litter embodiment, the extruded self-clumping sorbent material of each self-clumping sorbent coated substrate litter granule contains at least 3%, preferably contains at least 5%, and more preferably contains at least 7.5% of the at least partially cold-water soluble water-activated moisture-cured extrusion-modified starch binder by weight of the extruded self-clumping sorbent material in each granule. This is a sufficient amount of cold-water soluble extrusion-modified starch binder in each coated substrate litter granule that at least partially solubilizes and forms a flowable adhesive that flows from the granule when wetted with water, urine or synthetic urine along and in between at least a plurality of contacting wetted pellets and at least a plurality of adjacent wetted pellets self-clumping them together into a clump that is scoopable from the litter with one hand using a conventional handled litter scoop, e.g., perforate litter scoop, withing thirty seconds of being wetted with the water, urine or synthetic urine.

A litter of the present invention be composed of less than 100% of the self-clumping sorbent coated substrate litter granules of the invention and still self-clump when wetted with water, urine or synthetic urine forming clumps of litter granules that are scoopable with a conventional handled perforate litter scoop. Such a litter of the present invention can be composed of no greater than 75% of its particulate and/or granular matter being self-clumping sorbent coated substrate litter granules of the invention and preferably be composed of between 60%-75% of its particulate and/or granular matter being self-clumping sorbent coated substrate litter granules of the invention and still be a self-clumping litter that forms clumps scoopable using a conventional handled perforate litter scoop when the litter is wetted with water, urine, or synthetic urine. In another preferred embodiment of a self-clumping litter of the present invention, the litter can be composed of no greater than 85% of its particulate and/or granular matter being self-clumping sorbent coated substrate litter granules of the invention and preferably be composed of between 70%-85% of its particulate and/or granular matter being self-clumping sorbent coated substrate litter granules of the invention and still be a self-clumping litter that forms clumps scoopable using a conventional handled perforate litter scoop when the litter is wetted with water, urine, or synthetic urine. In yet another preferred embodiment of a self-clumping litter of the present invention, the litter can be composed of no greater than 90% of its particulate and/or granular matter being self-clumping sorbent coated substrate litter granules of the invention and preferably be composed of between 75%-90% of its particulate and/or granular matter being self-clumping sorbent coated substrate litter granules of the invention and still be a self-clumping litter that forms clumps scoopable using a conventional handled perforate litter scoop when the litter is wetted with water, urine, or synthetic urine.

Where a litter of the present invention contains less than 100% of self-clumping sorbent coated substrate litter granules of the invention, the remainder of the litter can be composed of one or more types of granules or pellets not containing any extruded self-clumping sorbent material, which can be or include granules or pellets that are non-absorbent and/or non-clumping, which can be or include granules or pellets of a filler material, and/or which can be or include granules or pellets that are functional and that provide or are composed of one or more of a scent, fragrance, deodorizer, urea inhibitor, preservative, desiccant, humectant, activated charcoal and/or activated carbon, carbon black, odor mask, scent mask, odor block or odor blocker, scent block or scent blocker, urine scent mask or urine odor mask, urine scent block or blocker or urine odor block or blocker, fecal matter scent mask or fecal matter odor mask, dye such as a urine reactive dye or a fecal matter reactive dye, reagent such as a urine reactive reagent or a fecal matter reactive reagent, catalyst such as urine reactive or responsive catalyst and/or a fecal matter reactive or responsive catalyst, or which is composed or comprised of another type of functional chemical, molecule and/or constituent.

As a result of the extruded sorbent clumping material exterior of each self-clumping litter granule of the present invention containing a cold-water swellable extrusion-modified water-sorbent starch, preferably a cold-water swellable extrusion-modified water-absorbent starch, in an amount sufficient in each litter granule for each litter granule to sorb, preferably absorb, at least a plurality of pairs of, i.e., at least three, times the weight of the litter granule in water, urine, or a synthetic urine, preferably sorb, preferably absorb, at least four times litter granule weight in water, urine, or a synthetic urine, more preferably sorb, preferably absorb, at least five times granule weight in water, urine, or a synthetic urine, even more preferably sorb, preferably absorb, at least six times granule weight in water, urine, or a synthetic urine, and even further preferably sorb, preferably absorb, at least six times granule weight in water, urine, or a synthetic urine during wetting of the granule with water, urine, or synthetic urine, such as during actual use of a litter of the present invention composed of at least 60%, preferably at least 75%, and more preferably at least 85% by litter weight of the litter granules of the present invention.

In a preferred litter granule embodiment, the extruded sorbent clumping material forming an exterior surrounding at least a majority, preferably at least 65%, and more preferably at least 75% of an outer surface of each inner substrate particle which forms each litter granule is composed of at least 10%, preferably at least 15%, and more preferably at least 20% of the cold-water swellable extrusion-modified water-sorbent starch by weight of extruded sorbent clumping material in each litter granule. In one particularly preferred litter granule embodiment, the extruded sorbent clumping material exterior of each litter granule is composed of at least 10%, preferably at least 15%, and more preferably at least 20% of the cold-water swellable extrusion-modified water-absorbent starch by weight extruded sorbent clumping material of each litter granule.

The extruded self-clumping sorbent material of each litter granule contains a cold-water swellable extrusion-modified water-sorbent starch, preferably a cold-water swellable extrusion-modified water-absorbent starch, in an amount sufficient in each litter granule for each litter granule to sorb, preferably absorb, at least a plurality of pairs of, i.e., at least three, times the weight of the litter granule in water, urine, or a synthetic urine, preferably sorb, preferably absorb, at least four times litter granule weight in water, urine, or a synthetic urine, more preferably sorb, preferably absorb, at least five times granule weight in water, urine, or a synthetic urine, and even more preferably sorb, preferably absorb, at least six times granule weight in water, urine, or a synthetic urine during wetting of the granule with water, urine, or synthetic urine, including during actual use of a self-clumping litter of the present invention composed of at least 60%, preferably at least 75%, and more preferably at least 85% by litter weight of the litter granules of the present invention.

In one preferred embodiment, the extruded self-clumping sorbent material of each coated substrate litter granule contains a cold-water swellable extrusion-modified water-sorbent starch, preferably a cold-water swellable extrusion-modified water-absorbent starch, in an amount sufficient in each litter granule for the coating of each coated substrate litter granule to sorb, preferably absorb, at least a plurality of pairs of, i.e., at least three, times the weight of the litter granule in water, urine, or a synthetic urine, preferably sorb, preferably absorb, at least four times litter granule weight in water, urine, or a synthetic urine, more preferably sorb, preferably absorb, at least five times granule weight in water, urine, or a synthetic urine, even more preferably sorb, preferably absorb, at least six times granule weight in water, urine, or a synthetic urine, including during actual use of a self-clumping litter of the present invention composed of at least 60% and no more than 75%, i.e., between 60%-75%, preferably at least 75% and no more than 90%, i.e., between 75%-90%, and more preferably at least 90% and up to 100%, i.e., between 90%-100%, of the litter granules of the present invention by total weight of the litter. The extruded self-clumping sorbent material of each litter granule preferably is composed of at least 5%, preferably at least 7.5%, more preferably at least 10%, and even more preferably at least 15% of the cold-water swellable extrusion-modified water-sorbent starch, which preferably is or includes at least some cold-water swellable extrusion-modified water-absorbent starch by extruded self-clumping sorbent material weight. In a preferred litter granule embodiment, the extruded self-clumping granule preferably is composed of at least 5%, preferably at least 7.5%, more preferably at least 10%, and even more preferably at least 15% of cold-water swellable extrusion-modified water-absorbent starch by weight of the extruded self-clumping sorbent material of each pellet.

The at least partially soluble cold-water soluble extrusion-modified starch water-activated moisture-cured binder also contained in the extruded clumping material exterior of each litter granule at least partially solubilizes when wetted with water, urine, or synthetic urine such that at least some of the at least partially solubilized binder forms a flowable adhesive that flows from the wetted litter granules in between and around at least a plurality of contacting litter granules and at least a plurality of adjacent litter granules self-clumping them together into a clump composed of at least a plurality of pairs, i.e., at least three, preferably at least five, more preferably at least ten, and more preferably at least twenty, of the litter granules. Such a clump has a clump retention rate of at least 95%, preferably at least 97%, and more preferably at least 99%, and a clump crush strength of at least 40 PSI, preferably at least 60 PSI, more preferably at least 80 PSI, and most preferably at least 100 PSI, when the clump is air dried at room temperature to a moisture content of about 12%, by weight of the clump. This makes a litter of the present invention more efficient at clumping than a litter composed substantially completely, e.g., 95%±5%, of sodium bentonite.

In preparation for carrying out a method of making the litter in accordance with the present invention, particles of a desired substrate composed of a material that does not clump when wetted with water, urine or even synthetic urine can be and preferably are classified, such as by screening, sieving or the like, in a size classification step to eliminate particles that are undesirably too large as well as particles which are undesirably too small. In one preferred size classification step, a first or initial amount of unsized particles of the substrate are size classified using a plurality of different sized screens or sieves, whose mesh or sieve sizes are selected to obtain a second and desired amount of size classified particles having at least a plurality of pairs, i.e., at least three, of different particle sizes falling within a desired upper and lower particle size range, i.e., desired substrate particle size distribution range, respectively defined by at least one screen or sieve having a first mesh, screen or sieve size configured to define an upper or large particle size cutoff and at least one other screen having a second mesh, screen or sieve size configured to define a lower or small particle size cutoff.

In a preferred substrate particle size classification step, the plurality of size classifying screens are selected to size classify a first or initial amount of unsized substrate particles to obtain a second and desired amount of size classified substrate particles with at least 80%, preferably at least 90%, and more preferably at least about 95% of the substrate particles having particles sizes falling within a range, e.g., particle distribution range, of between (a) 0.0165 inch or 0.42 mm (No. 40 Sieve/Screen or 35 Mesh Screen) and 0.0937 inch or 2.38 mm (No. 8 Sieve/Screen or 8 Mesh Screen), (b) preferably between 0.0234 inch or 0.595 mm (No. 30 Sieve/Screen or 28 Mesh Screen) and 0.0787 inch or 2.00 mm (No. 10 Sieve/Screen or 9 Mesh Screen), (c) more preferably between 0.0278 inch or 0.707 mm (No. 25 Sieve/Screen or 24 Mesh Screen) and 0.0661 inch or 1.68 mm (No. 12 Sieve/Screen or 10 Mesh Screen), and (d) even more preferably between 0.0331 inch or 0.841 mm (No. 20 Sieve/Screen or 20 Mesh Screen) and 0.0661 inch or 1.68 mm (No. 12 Sieve/Screen or 10 Mesh Screen).

In one preferred litter granule embodiment of the present invention and implementation of a method of making the granule, one preferred type of substrate particle used as a litter granule nucleator to make the litter granule is a generally incompressible or crush-resistant inorganic particulate substrate material, such as preferably perlite, which also is non-clumping, preferably also porous, e.g., has micropores, preferably is at least slightly water-absorbent and is crushed, ground or otherwise comminuted into substrate particles having a particle size range (a) between 0.0278 inch or 0.707 mm (No. 25 Sieve/Screen or 24 Mesh Screen) and 0.0661 inch or 1.68 mm (No. 12 Sieve/Screen or 10 Mesh Screen), and/or (b) between 0.0278 inch or 0.707 mm (No. 25 Sieve/Screen or 24 Mesh Screen) and 0.0661 inch or 1.68 mm (No. 12 Sieve/Screen or 10 Mesh Screen). In another preferred litter granule embodiment of the present invention and implementation of a method of making the granule, a preferred type of substrate particle used as a litter granule nucleator to make the litter granules is a crush-resistant inorganic particulate substrate material that preferably are granules of sand, such as granules of nonporous and nonabsorbent silica sand, size classified to provide substrate particles, i.e., sand grains, with particle sizes or grain sizes ranging (a) between 0.0165 inch or 0.42 mm (No. 40 Sieve/Screen or 35 Mesh Screen) and 0.0937 inch or 2.38 mm (No. 8 Sieve/Screen or 8 Mesh Screen) and/or (b) between 0.0278 inch or 0.707 mm (No. 25 Sieve/Screen or 24 Mesh Screen) and 0.0661 inch or 1.68 mm (No. 12 Sieve/Screen or 10 Mesh Screen).

In yet another preferred litter granule embodiment of the present invention and implementation of a method of making the granule, a preferred type of substrate particle used as a litter granule nucleator is a water absorbent particulate smectite clay, such as preferably bentonite or a bentonite clay, which is relatively soft, so as to be crushable and/or friable, and which can be and preferably is porous, which is at least partially composed of montmorillonite, and which preferably has a particle size distribution range of between 0.0331 inch or 0.841 mm (No. 20 Sieve/Screen or 20 Mesh Screen) and 0.0661 inch or 1.68 mm (No. 12 Sieve/Screen or 10 Mesh Screen) but which can have a particle size distribution range of between 0.0278 inch or 0.707 mm (No. 25 Sieve/Screen or 24 Mesh Screen) and 0.0661 inch or 1.68 mm (No. 12 Sieve/Screen or 10 Mesh Screen). In one such preferred particulate substrate material, the substrate particles are each composed of a relatively soft non-clumping water absorbent smectite clay that preferably is a calcium bentonite having a particle size distribution range of between 0.0331 inch or 0.841 mm (No. 20 Sieve/Screen or 20 Mesh Screen) and 0.0661 inch or 1.68 mm (No. 12 Sieve/Screen or 10 Mesh Screen) or between 0.0278 inch or 0.707 mm (No. 25 Sieve/Screen or 24 Mesh Screen) and 0.0661 inch or 1.68 mm (No. 12 Sieve/Screen or 10 Mesh Screen). In another such preferred particulate substrate material having a similar or substantially the same particle size distribution range as one of the aforementioned particle size distribution ranges set forth above in this paragraph, the substrate particles are each composed of another type of a smectite, such attapulgite, Fullers Earth, sepiolite and/or kaolinite.

A self-clumping sorbent litter of the present invention can also be made of self-clumping sorbent litter granules made in accordance with the litter granule making method of the present invention using a plurality or even a plurality of pairs of different types of smectite clay nucleators in a mixture or blend thereof, including a combination of a plurality or plurality of pairs of calcium bentonite substrate particles, sodium bentonite substrate particles and/or one or more of attapulgite substrate particles, Fullers Earth substrate particles, sepiolite substrate particles and/or kaolinite substrate particles where all of the different types of substrate particles are mixed or blended together in a mixing step that can take place during the wetting step but which preferably is performed before the addition of the extruded self-clumping sorbent material particles. In one such mixture of different types of substrate particles, the combined substrate particle mixture can have a particle size distribution range of (a) between 0.0278 inch or 0.707 mm (No. 25 Sieve/Screen or 24 Mesh Screen) and 0.0661 inch or 1.68 mm (No. 12 Sieve/Screen or 10 Mesh Screen), and (b) between 0.0331 inch or 0.841 mm (No. 20 Sieve/Screen or 20 Mesh Screen) and 0.0661 inch or 1.68 mm (No. 12 Sieve/Screen or 10 Mesh Screen).

In another preferred self-clumping sorbent litter granule and method of making the self-clumping sorbent litter granule of the present invention, another preferred type of substrate material used in particulate form as litter granule nucleators to make the litter granules is composed of an organic material, which can be substantially completely organic, and which are in the form of substrate particles comprised or composed substantially completely of paper, wood fiber, e.g., wood or sawdust pellets, wood shavings, bark or the like, and having a substrate particle size distribution range of (a) between 0.0331 inch or 0.841 mm (No. 20 Sieve/Screen or 20 Mesh Screen) and 0.0661 inch or 1.68 mm (No. 12 Sieve/Screen or 10 Mesh Screen), and/or (b) between 0.0278 inch or 0.707 mm (No. 25 Sieve/Screen or 24 Mesh Screen) and 0.0661 inch or 1.68 mm (No. 12 Sieve/Screen or 10 Mesh Screen). In a preferred paper substrate particle embodiment, the paper substrate particles preferably are generally rounded and preferably substantially rounded or substantially spherical in shape and having particles sizes ranging (a) between 0.0331 inch or 0.841 mm (No. 20 Sieve/Screen or 20 Mesh Screen) and 0.0661 inch or 1.68 mm (No. 12 Sieve/Screen or 10 Mesh Screen), and/or (b) between 0.0278 inch or 0.707 mm (No. 25 Sieve/Screen or 24 Mesh Screen) and 0.0661 inch or 1.68 mm (No. 12 Sieve/Screen or 10 Mesh Screen).

In yet a further preferred self-clumping sorbent litter granule and method of making the self-clumping sorbent litter granule of the present invention, another preferred type of organic substrate material used in particulate form as litter granule nucleators to make litter granules of the present invention is a particulate nut shell material, preferably in the form of porous, e.g., microporous, absorbent walnut shells crushed, ground or otherwise comminuted into relatively small substrate particles having particle sizes ranging between 0.0331 inch or 0.841 mm (No. 20 Sieve/Screen or 20 Mesh Screen) and 0.0661 inch or 1.68 mm (No. 12 Sieve/Screen or 10 Mesh Screen) but which can be size classified to have particle sizes ranging between 0.0278 inch or 0.707 mm (No. 25 Sieve/Screen or 24 Mesh Screen) and 0.0661 inch or 1.68 mm (No. 12 Sieve/Screen or 10 Mesh Screen). In still yet a further preferred self-clumping sorbent litter granule and method of making the self-clumping sorbent litter granule of the present invention, another preferred type of organic nut shell substrate material used in particulate form as litter granule nucleators to make litter granules of the present invention is a particulate hazelnut shell material, preferably in the form of porous, e.g., microporous, absorbent hazelnut shells crushed, ground or otherwise comminuted into relatively small substrate particles having particle sizes ranging (a) between 0.0331 inch or 0.841 mm (No. 20 Sieve/Screen or 20 Mesh Screen) and 0.0661 inch or 1.68 mm (No. 12 Sieve/Screen or 10 Mesh Screen) and/or (b) between 0.0278 inch or 0.707 mm (No. 25 Sieve/Screen or 24 Mesh Screen) and 0.0661 inch or 1.68 mm (No. 12 Sieve/Screen or 10 Mesh Screen). In yet another preferred self-clumping sorbent litter granule and method of making the self-clumping sorbent litter granule of the present invention, another preferred type of organic nut shell substrate material used in particulate form as litter granule nucleators to make litter granules of the present invention is a particulate cashew shell material, preferably in the form of porous, e.g., microporous, absorbent cashew shells crushed, ground, or otherwise comminuted into relatively small substrate particles having particle sizes ranging (a) between 0.0331 inch or 0.841 mm (No. 20 Sieve/Screen or 20 Mesh Screen) and 0.0661 inch or 1.68 mm (No. 12 Sieve/Screen or 10 Mesh Screen) and/or (b) between 0.0278 inch or 0.707 mm (No. 25 Sieve/Screen or 24 Mesh Screen) and 0.0661 inch or 1.68 mm (No. 12 Sieve/Screen or 10 Mesh Screen). In still yet another preferred self-clumping sorbent litter granule and method of making the self-clumping sorbent litter granule of the present invention, another preferred type of organic nut shell substrate material used in particulate form as litter granule nucleators to make litter granules of the present invention is a particulate almond shell material, preferably in the form of porous, e.g., microporous, absorbent almond shells crushed, ground or otherwise comminuted into relatively small substrate particles having particle sizes ranging (a) between 0.0331 inch or 0.841 mm (No. 20 Sieve/Screen or 20 Mesh Screen) and 0.0661 inch or 1.68 mm (No. 12 Sieve/Screen or 10 Mesh Screen) and/or (b) between 0.0278 inch or 0.707 mm (No. 25 Sieve/Screen or 24 Mesh Screen) and 0.0661 inch or 1.68 mm (No. 12 Sieve/Screen or 10 Mesh Screen). Other types of nut shells, including outer hulls or shells from macadamia nuts, e.g., macadamia nut shells, outer hulls or shells from peanuts, e.g., peanut shells or peanut hulls, outer hulls or shells from Brazil nuts, e.g., Brazil nut shells, shells or outer hulls from pine nuts, e.g., pine nut shells, and outer hulls or shells from pecans, e.g., pecan shells can also be found or otherwise comminuted into particles used as litter granule nucleators in making litter granules of the present invention where the ground or comminuted shell substrate particles have particle sizes ranging (a) between 0.0331 inch or 0.841 mm (No. 20 Sieve/Screen or 20 Mesh Screen) and 0.0661 inch or 1.68 mm (No. 12 Sieve/Screen or 10 Mesh Screen) and/or (b) between 0.0278 inch or 0.707 mm (No. 25 Sieve/Screen or 24 Mesh Screen) and 0.0661 inch or 1.68 mm (No. 12 Sieve/Screen or 10 Mesh Screen).

It is also contemplated that other types of materials, including plastic, rubber, e.g., scrap tires, glass, wood pellets, sawdust pellets, wood shavings, bark and other types of non-clumping materials can be ground, crushed or otherwise comminuted into particles which are screened, sieved or size classified in another manner to have a particle size range or particle size distribution range falling within at least one of the preferred particle size ranges: (a) between 0.0331 inch or 0.841 mm (No. 20 Sieve/Screen or 20 Mesh Screen) and 0.0661 inch or 1.68 mm (No. 12 Sieve/Screen or 10 Mesh Screen), and/or (b) between 0.0278 inch or 0.707 mm (No. 25 Sieve/Screen or 24 Mesh Screen) and 0.0661 inch or 1.68 mm (No. 12 Sieve/Screen or 10 Mesh Screen). In a preferred paper substrate particle embodiment, the paper substrate particles preferably are generally rounded and preferably substantially rounded or substantially spherical in shape and having particles sizes ranging (a) between 0.0331 inch or 0.841 mm (No. 20 Sieve/Screen or 20 Mesh Screen) and 0.0661 inch or 1.68 mm (No. 12 Sieve/Screen or 10 Mesh Screen), and/or (b) between 0.0278 inch or 0.707 mm (No. 25 Sieve/Screen or 24 Mesh Screen) and 0.0661 inch or 1.68 mm (No. 12 Sieve/Screen or 10 Mesh Screen).

It should be noted that the present invention contemplates self-clumping sorbent litters composed of self-clumping sorbent litter granules made from at least a plurality and preferably at least a plurality of pairs of, i.e., at least three, different types of substrate particles, including where the different types of substrate particles are mixed or blended together prior to or during a wetting step where aqueous liquid, preferably water is applied to wet the substrate particles, an activation step, and/or a nucleating step (as well as any drying step(s)) where the wetted substrate particles each act as nucleators to which the extruded self-clumping sorbent material particles adhere and become adhesively attached thereto as a result of some, but not all, of the water soluble binder in the adhering extruded self-clumping sorbent material particles activating and becoming sticky by water on the wetted contacting substrate particles at least partially solubilizing some of the binder. In one preferred litter and litter granule making method embodiment, at least a plurality and preferably at least a plurality of pairs of, i.e., at least three, different types of crushed nut shell particles, such as a plurality of, preferably at least a plurality of pairs of walnut shell particles, hazelnut shell particles, cashew shell particles, pecan shell particles, peanut shell particles, macadamia nut shell particles, pine nut shell particles, almond shell particles and/or Brazil nut shell particles can be blended together, wetted together, and have the smaller extruded self-clumping sorbent material particles added to the wetted nutshell particle mixture or blend such that the activation step, nucleation step, and any drying step(s) are performed together.

In one preferred litter and litter granule making method embodiment, substrate particles of at least one type of substrate, such as one or more types of the aforementioned nut shells, are blended or mixed together with substrate particles of at least one other type of substrate, such as one or more types of smectite clay(s), perlite, paper, pellets, or another type of material suitable for use as an extruded self-clumping sorbent material nucleating substrate particle, in a combined substrate particle mixing step that can take place before or during wetting of the mixture or blend of each one of the different types of substrate particles prior to or during application of the extruded self-clumping sorbent material particles in the application and/or nucleating steps. In another preferred litter and litter granule making method embodiment, substrate particles of at least one type of smectite clay, preferably calcium bentonite, are blended or mixed together with substrate particles of an organic substrate material, such as paper and/or nut shells (preferably walnut shells), in a combined substrate particle mixing step where the different types of substrate particles are mixed or blended together preferably substantially simultaneously, which can be performed before or during wetting of the mixture or blend of the calcium bentonite substrate particles, paper substrate particles and/or nut shell substrate particles (preferably walnut shell substrate particles) prior to or during application of the extruded self-clumping sorbent material particles. In still another preferred litter and litter granule making method embodiment, substrate particles of at least one type of smectite clay, preferably calcium bentonite, are blended or mixed together with substrate particles of another substrate material, preferably perlite, in such a combined substrate particle mixing step that can take place before or during wetting of the mixture or blend of calcium bentonite and perlite substrate particles prior to or during application of the extruded self-clumping sorbent material particles in carrying out a preferred implementation of a litter making method of the invention. In yet another preferred litter and litter granule making method embodiment, substrate particles of at least one type of smectite clay, preferably calcium bentonite, are blended or mixed together with substrate particles of another substrate material, preferably sand, in such a combined substrate particle mixing step that can take place before or during wetting of the mixture or blend of calcium bentonite and sand substrate particles prior to or during application of the extruded self-clumping sorbent material particles in carrying out an implementation of a litter making method of the invention. In a further preferred litter and litter granule making method embodiment, substrate particles of at least one type of organic material, such as paper, wood pellets, wood shavings, bark, or another type of organic material, are blended or mixed together with substrate particles of another type of substrate material, such as sand, in a combined substrate particle mixing step that can take place before or during wetting of the mixture or blend of the substrate particles of the at least one type of organic material and the sand prior to or during application of the extruded self-clumping sorbent material particles in making self-clumping litter granules of the present invention. In a still further preferred litter and litter granule making method embodiment, substrate particles of at least one type of organic material, such as paper, wood pellets, wood shavings, bark, or another type of organic material, are blended or mixed together with substrate particles of another type substrate material, such as perlite, in such a combined substrate particle mixing step that can take place before or during wetting of the mixture or blend of the substrate particles of the at least one type of organic material and the perlite prior to or during application of the extruded self-clumping sorbent material particles. In yet a still further preferred litter and litter granule making method embodiment, substrate particles of at least one type of organic material, such as paper, wood pellets, wood shavings, bark, or another type of organic material, are blended or mixed together with substrate particles of another type of organic substrate material, such as nut shells, e.g., walnut shells, in a combined substrate particle mixing step that can take place before or during wetting of the mixture or blend of the substrate particles of the at least one type of organic material and the another type of organic material prior to or during application of the extruded self-clumping sorbent material particles in carrying out a preferred implementation of a litter making method of the invention.

In one agglomerated sand litter composed of self-clumping absorbent litter granules made of grains of sand as the substrate particles coated with modified starch absorbent clumping material or agent of the invention, only 10% by weight of the litter is composed of extruded fines/flour/powder of the modified starch absorbent clumping material or agent with the remaining 90% being composed of the sand grain, which clumps and produces dried clumps having a clump retention rate of at least 95% and a clump crush strength of at least 40 PSI, preferably at least 60 PSI, more preferably at least 80 PSI, even more preferably 100 PSI when dried to a moisture content of about 12% by clump weight.

Where sand is the non-clumping substrate, the coating thickness is less than 0.5 mm—between 0.25 mm and 0.5 mm thick coating comprised of: (a) a water soluble binder comprised of (i) an irreversibly retrograded water soluble binder portion, and (ii) a resolubilizing water soluble binder portion; (b) a granular non-clumping substrate, wherein no more than 35% by weight of the clumping litter is comprised of water soluble binder and extruded fines and powder composed of extruded modified starch absorbent clumping agent or material.

In one preferred litter and litter granule making method embodiment, substrate particles of at least one type of smectite clay, preferably calcium bentonite, are blended or mixed together with substrate particles of at least one other type of smectite clay, preferably sodium bentonite, in a combined substrate particle mixing step that can take place before or during wetting of the mixture or blend of the calcium bentonite and sodium bentonite substrate particles prior to or during application of the extruded self-clumping sorbent material particles in carrying out a preferred implementation of a litter making method of the invention. In another preferred litter and litter granule making method embodiment, one batch of self-clumping litter granules of the present invention are made using particles a first type of smectite clay, preferably a calcium bentonite or Ca-montmorillonite, as substrate particles that are also nucleators to which the smaller particles of the extruded self-clumping sorbent material adhere to when wetted, another batch of self-clumping litter granules of the present invention are made using particles a second type of smectite clay, preferably a sodium bentonite or Na-montmorillonite, as substrate particles that are also nucleators to which the smaller particles of the extruded self-clumping sorbent material adhere to when wetted, and the resultant self-clumping sorbent litter granules of the invention of both batches are combined together, such as by mixing or blending them together in a drum mixer or drum-type mixer, a pin mixer, or another type of commercial mixer or blender.

In one preferred litter and litter granule making method embodiment, at least a plurality and preferably at least a plurality of pairs of, i.e., at least three, different types of crushed nut shell particles, such as a plurality of, preferably at least a plurality of pairs of walnut shell particles, hazelnut shell particles, cashew shell particles, pecan shell particles, peanut shell particles, macadamia nut shell particles, pine nut shell particles, almond shell particles and/or Brazil nut shell particles can be blended together, wetted together, and have the smaller extruded self-clumping substrate material particles added to the wetted nutshell particle mixture or blend such that the activation step, nucleation step, and any drying step(s) are performed together.

The resultant self-clumping sorbent litter granules made using substrate particles having one of the preferred particle size ranges disclosed hereinabove have a similar range or distribution of particle size ranges, but which are between 1% and 8% larger in size than the substrate particles due to the thickness of the extruded self-clumping sorbent material applied thereto in carrying out one of the self-clumping litter granule method implementations disclosed hereinabove. For example, where substrate particles having a particle size range or particle distribution size range of between 0.0165 inch or 0.40 mm (No. 40 Sieve/Screen or 35 Mesh Screen) and 0.0937 inch or 2.38 mm (No. 8 Sieve/Screen or 8 Mesh Screen) are used, the resultant self-clumping litter granules formed from the substrate particles of this size range will be slightly larger having particle sizes ranging between about 0.018 inch or about 0.45 mm and about 0.0985 inch or about 2.5 mm. For example, where the substrate particles have particle sizes ranging between 0.0234 inch or 0.595 mm (No. 30 Sieve/Screen or 28 Mesh Screen) and 0.0787 inch or 2.00 mm No. 10 Sieve/Screen or 9 Mesh Screen) are used, the resultant self-clumping litter granules formed from the substrate particles of this size range will have particle sizes ranging between about 0.025 inch or about 0.635 mm and about 0.085 inch or about 2.16 mm. Where substrate particles having a particle size range or particle distribution size range of between 0.0278 inch or 0.707 mm (No. 25 Sieve/Screen or 24 Mesh Screen) and 0.0661 inch or 1.68 mm (No. 12 Sieve/Screen or 10 Mesh Screen) are used, the resultant self-clumping litter granules formed from the substrate particles of this size range will be slightly larger having particle sizes ranging between about 0.0290 inch or about 0.736 mm and about 0.075 inch or about 1.90 mm. Finally, where substrate particles having a particle size range or particle distribution size range of between 0.0331 inch or 0.841 mm (No. 20 Sieve/Screen or 20 Mesh Screen) and 0.0661 inch or 1.68 mm (No. 12 Sieve/Screen or 10 Mesh Screen) are used, the resultant self-clumping litter granules formed from the substrate particles of this size range will also be slightly larger having particle sizes ranging between about 0.0365 inch or about 0.927 mm and about 0.075 inch or about 1.90 mm. As such, the preferred substrate particle size ranges discussed above advantageously produces a self-clumping sorbent litter in accordance with the present invention where the resulting self-clumping sorbent litter granules of the present invention produced after application of a desired amount, e.g., desired mass, weight or volume, of extruded self-clumping sorbent material particles to a desired amount of one or more of the above-discussed types of substrate particles with particle sizes, particle size ranges or particle size distributions within one of the particle size ranges disclosed hereinabove produces self-clumping sorbent litter granules of the present invention having particle sizes falling within a similar particle size range of the substrate particles used to make the litter granules but which are larger in size by being between 1% and 5% larger than sizes of the substrate particles used to make the litter granules.

The resultant self-clumping litter granules of the present invention made with substrate particles as litter granule nucleators during application of the outer region of the extruded self-clumping sorbent material produced finished litter granules with an extruded self-clumping sorbent material granule coating weight of between 5% and 45% by litter granule weight on each substrate particle, preferably between 10% and 40% by litter granule weight of extruded self-clumping sorbent material on each substrate particle, and more preferably between 15% and 35% by weight of extruded self-clumping sorbent material on each substrate particle. Where the self-clumping sorbent litter granules have been made using sand as the substrate particle and granule nucleator, the application rate of the extruded self-clumping sorbent material on each sand grain is between 5% and 20% by litter granule weight, preferably between 10% and 20% by litter granule weight, and more preferably between 5% and 15% by litter granule weight. Where the self-clumping sorbent litter granules have been made using calcium bentonite as the substrate particle and granule nucleator, the application rate of the extruded self-clumping sorbent material on each calcium bentonite particle is between 10% and 40% by litter granule weight, preferably between 15% and 30% by litter granule weight, and more preferably between 20% and 25% by litter granule weight.

It has been found that the larger the substrate particle, the greater the amount of granule coating weight of the modified-starch water-absorbent clumping agent, preferably extruded self-clumping absorbent material, which is required to be applied to each substrate particle during making of the litter granules to ensure that each finished litter granule contains enough modified-starch water-absorbent clumping agent, preferably extruded self-clumping absorbent material, which makes up each outer litter granule region to ensure good clumping when litter made with the litter granules is wetted with water or urine. In other words, it has been found that the larger the size of the substrate particle used to make the litter granules, the greater the amount of the coating weight of the particulate modified-starch water-absorbent clumping agent, preferably extruded self-clumping absorbent material, that is required to be adhered to the substrate particle of each litter granule to ensure that each finished litter granule contains enough extruded self-clumping absorbent material that makes up its outer absorbent water soluble binder emitting region in order to ensure rapid removably scoopable clumps of wetted litter granules having a clump retention rate of at least 97%, preferably at least 99%, are formed when litter made with the litter granules is wetted with water or urine.

The self-clumping sorbent litter granules of the present invention made an accordance with a method of making the litter granules of the present invention have granules formed of substrate particles each at least partially covered or encapsulated with extruded sorbent clumping material, whereby the modified-starch water-absorbent clumping agent, preferably in the form of extruded sorbent clumping material, forms between 2% and 40%, preferably between 5% and 35%, more preferably between 5% and 25%, by weight of each granule, absorbs at least a plurality of pairs of, i.e., at least three, times the weight of the granule in water or urine, preferably absorbs at least four times the weight of the granule in water or urine, more preferably absorbs at least five times the weight of the granule in water or urine, and even more preferably absorbs at least six times the weight of the granule in water or urine, while the water or urine wetted granules self-clump together into clumps having a clump retention rate of at least 95%, preferably at least 97%, and more preferably at least 99%, and a clump crush strength of at least 40 PSI, preferably at least 60 PSI, more preferably at least 80 PSI and even more preferably at least 100 PSI when the clumps are air dried at room temperature to a moisture content of about 12% by clump weight.

In a preferred implementation of a method of making self-clumping sorbent litter granules of the present invention, particles of a substrate that can be and which preferably are non-clumping, e.g., composed of a non-clumping material, and which also can be non-absorbent, e.g., composed of a material which does not absorb water, are wetted with an aqueous liquid, such as preferably only water, in a wetting step to prepare the substrate particles for application of even smaller particles of the modified-starch water-absorbent clumping agent, preferably extruded sorbent clumping material, while the substrate particles are wet. In this step, wetting the substrate particles with an aqueous liquid that preferably is water prepares the particles by wetting their outer surfaces so that even smaller particles of the modified-starch water-absorbent clumping agent, preferably extruded sorbent clumping material, can be applied thereon and will adhere thereto during the performance of subsequent steps of the litter making method of the present invention that produces the self-clumping sorbent litter granules of the invention when finished. Wetting the substrate particles with an aqueous liquid, such as preferably water, ensures at least some water, preferably enough water, is available on the outer surfaces of the substrate particles to at least partially solubilize some, but not all, of the cold-water soluble extrusion-modified starch binder of the smaller particles of modified-starch water-absorbent clumping agent, preferably extruded sorbent clumping material which comes in contact with the wetted substrate particle surface. When these smaller sized particles of modified-starch water-absorbent clumping agent, preferably extruded sorbent clumping material come into contact with the water wetted outer substrate particle surfaces, at least some, but not all, of the of the cold-water soluble extrusion-modified starch binder of the smaller particles of modified-starch water-absorbent clumping agent, preferably extruded sorbent clumping material forming at least some flowable adhesive that initially facilitates or further facilitates adherence to the outer surfaces of the substrate particles before being substantially immovably adhesively fixed thereto as the flowable adhesive moisture cures and hardens as it dries. In the process of doing so, the at least partially solubilized water-soluble binder from the wetted extruded sorbent clumping material particles forms flowable adhesive that adhesively binds initially to one part of the outer surface of a corresponding one of the wetted substrate particles through intermolecular attraction but then thereafter becomes substantially immovably bound or fixed to the same part of the outer surface of the corresponding one of the wetted substrate particles through intramolecular attraction as the flowable adhesive moisture cures and sets by hardening into a hard solid glassy material in a glassy material state. This occurs as the resultant finished self-clumping litter granules that are formed moist dries, preferably to a moisture content of no greater than 12% by weight, preferably no greater than 10% by weight, and more preferably no greater than about 8% by weight to ensure proper moisture curing, hardening and adhesive bonding of the outer region to each substrate particle of each finished litter granule.

In a preferred implementation of a method of making the litter granules, at least some, but not all, of the cold-water soluble extrusion-modified starch water-activated moisture-curing binder is at least partially solubilized such that at least 5% and no more than 65%, i.e., between 5%-65%, preferably at least 10% and no more than 50%, i.e., between 10%-50%, and more preferably at least 15% and no more than 45%, i.e., between 15%-45%, by weight of the cold-water soluble extrusion-modified starch water-activated moisture-curing binder in the wetted smaller particles of extruded self-clumping sorbent material is at least partially solubilized during the application step and/or nucleating substep. In another method implementation, of the 5%-65%, preferably 10%-50%, and more preferably 15%-45% by weight of the cold-water soluble extrusion-modified starch moisture-curing binder that is at least partially solubilized during one or more of the wetting and/or application steps and/or nucleating substep, at least some, but not all, of the at least partially solubilized cold-water soluble extrusion-modified water-activated moisture-curing starch binder of the particulate modified-starch water-absorbent clumping agent applied to the substrate particles is substantially completely solubilized in or by the water of the aqueous wetting liquid providing the substrate particle wetting during the wetting step, the application step and/or the nucleating sub step.

In a further preferred method implementation, at least some, but not all, of the cold-water soluble extrusion-modified starch water-activated moisture-curing binder of the modified-starch water-absorbent clumping agent is at least partially solubilized such that at least 5% and no more than 65%, i.e., between 5%-65%, preferably at least 10% and no more than 50%, i.e., between 10%-50%, and more preferably at least 15% and no more than 45%, i.e., between 15%-45%, by weight of the cold-water soluble extrusion-modified starch binder in the wetted smaller particles of extruded self-clumping sorbent material is at least partially solubilized during the wetting step, the application step, and the nucleating substep. In a still further method implementation, of the 5%-65%, preferably 10%-50%, and more preferably 15%-45% by weight of the cold-water soluble extrusion-modified starch binder that is at least partially solubilized during one or more of the wetting and/or application steps and/or nucleating sub step, at least some of the at least partially solubilized cold-water soluble extrusion-modified starch binder is substantially completely solubilized in or by the water providing the wetting during the wetting step, the application step and/or the nucleating substep.

In yet another preferred method implementation, at least some, but not all, of the cold-water soluble extrusion-modified starch water-activated moisture-cured binder is solubilized, preferably substantially completely water solubilized in or by the wetting water, such that at least 5% and no more than 65%, i.e., between 5%-65%, preferably at least 10% and no more than 50%, i.e., between 10%-50%, and more preferably at least 15% and no more than 45%, i.e., between 15%-45%, by weight of the cold-water soluble extrusion-modified starch binder in the wetted smaller particles of extruded self-clumping sorbent material is solubilized, preferably substantially completely water solubilized, during the application step, and the nucleating substep. In a further preferred method implementation, at least some, but not all, of the cold-water soluble extrusion-modified starch binder is solubilized, preferably substantially completely water solubilized in or by the wetting water, such that at least 5% and no more than 65%, i.e., between 5%-65%, preferably at least 10% and no more than 50%, i.e., between 10%-50%, and more preferably at least 15% and no more than 45%, i.e., between 15%-45%, by weight of the cold-water soluble extrusion-modified starch binder in the wetted smaller particles of extruded self-clumping sorbent material is solubilized, preferably substantially completely solubilized in or by the wetting water, during the wetting step, the application step, and the nucleating substep which occurs during the adhering step.

During this time, the at least partial solubilization of the cold water-soluble binder and any cold water soluble starches of the particles of the extruded self-clumping sorbent material which have become adhered to corresponding outer wetted surfaces of the litter granule nucleating substrate particles not only forms a flowable adhesive that flows the wetted extruded self-clumping sorbent material but which also causes the cold water soluble binder and other cold water soluble starches of each one of the adhering extruded self-clumping sorbent material particles to flow together thereby causing the adhering extruded self-clumping sorbent material particles to coalesce into a substantially homogeneous and uniform outer region of the extruded self-clumping sorbent material at least partially and preferably substantially completely surrounding or encapsulating the wetted outer substrate particle surface with the flowable adhesive drying, retrograding and adhesively bonding the substantially homogeneously coalesced outer region of extruded self-clumping absorbent material thereto.

Because only some, but not all, of the cold-water soluble extrusion-modified starch water-activated moisture-cured binder of the at least partially wetted extruded sorbent clumping material particles is partially or completely solubilized during at least the activation step, the adhering step and/or the nucleating substep (and also the wetting step where the extruded self-clumping sorbent particulate material is added while the wetting step is being performed), at least some other of the cold-water soluble extrusion-modified starch binder of the at least partially wetted extruded sorbent clumping material particles is not partially or completely solubilized thereby remaining available for being at least partially or completely solubilized upon the resultant self-clumping sorbent litter granule formed therefrom is wetted with water, urine or synthetic urine.

In at least one preferred implementation of a method of making the self-clumping sorbent litter granules from any of the aforementioned substrate particles, a drying step can be and preferably is performed during or after the application step, the adhering step and/or the nucleating step have been completed in order to (a) remove excess moisture from each one of the litter granules newly formed of a region extruded self-clumping sorbent material at least partially and preferably substantially completely encapsulating the outer surface(s) of a respective substrate particle that forms the nucleus of the granule, and (b) set, cure or at least facilitate setting, or facilitate curing of the at least partially solubilized water-soluble water-activated moisture-cured binder from the extruded self-clumping sorbent material particles thereby adhesively fixing or binding the extruded self-clumping sorbent material region to the substrate particle that forms the nucleus of the granule. In one preferred drying step, a stream of turbulently flowing heated air at a temperature of at least 100° F., preferably at least 125° F., and more preferably at least 150° F. is introduced into the drum where flows around within the drum impinging against the newly formed litter granules thereby drying each litter granule by reducing the moisture content of the outer region of extruded self-clumping sorbent material of each granule. As the outer region of extruded self-clumping sorbent material of each litter granule is dried with the heated air, the heated air rapidly retrogrades, solidifies, and moisture cures or sets the flowable adhesive formed of the water-soluble binder that had previously been at least partially solubilized into the flowable adhesive by the water wetting the substrate particle to which the outer region of extruded self-clumping sorbent material has now become fixedly adhesively bonded. In one such preferred drying step, a high enough rate of flow of the heated air is introduced into the drum to accelerate retrogradation and drying by the heated air turbulently flowing into and throughout the drum impinging against the newly formed litter granules while the drum continues to agitate the litter granules preferably by continuing to rotate. In such a preferred drying step, the temperature of the flowing heated air is heated to a temperature high enough to rapidly retrograde the previously water-soluble starches in the flowable adhesive within at least 3 to 5 minutes, preferably within one to three minutes, and more preferably within 30 seconds to one minute after the drying step begins to be performed. It is desired to cause such rapid retrogradation of the previously at least partially solubilized starches of the water-soluble water-activated moisture-cured binder that formed the flowable adhesive upon being wetted with water on the outer surface of the contacting substrate particle of the finished self-clumping sorbent litter granule of the present invention while the drum is rotating to substantially simultaneously agitate the self-clumping sorbent litter granules of the invention during drying to help ensure that any of the adjacent self-clumping sorbent litter granules in the drum that come into contact with each other do not agglomerate and form clumps within the drum. In addition, the rapid retrogradation induced by this drying step also helps rapidly eliminate any tackiness of the outer surfaces of the finished self-clumping sorbent litter granules that might have been present thereby also helping to prevent any of them from agglomerate rating by sticking together and clumping.

When wetted with water, urine or synthetic urine, such as during use of the litter granules in a litter box or the like, the un-solubilized cold-water soluble extrusion-modified starch water-activated moisture-cured binder at least partially or completely solubilizes forming a flowable adhesive that flows therefrom along and in between contacting wetted litter granules and adjacent wetted litter granules self-clumping them together forming a scoopable clump of at least a plurality of pairs, i.e., at least three, of the wetted litter granules. The scoopable clump formed has a clump retention rate of at least 95%, preferably at least 97%, and more preferably at least 99%, and a clump crush strength of at least 40 PSI, preferably at least 60 PSI, more preferably at least 80 PSI, even more preferably 100 PSI, when the clump is dried, preferably air dried, at room temperature to a moisture content of about 12%, by weight of the clump.

During the wetting step of one preferred implementation of the litter granule making method, the substrate particles are collectively substantially simultaneously wetted by application of an aqueous liquid, which can be an aqueous solution, but which preferably is water. In one preferred wetting phase or step, the aqueous liquid, preferably water, is misted onto the substrate particles while the particles are agitated, such as by being shaken or rotated in a drum or rotary drum-type mixer, e.g., a rotary drum-type cement mixer, to more uniformly distribute the aqueous liquid, preferably water, on and along substantially the entire outer surface of each particle thereby substantially uniformly wetting each particle with a region of aqueous liquid, preferably water. In another preferred implementation of the wetting step, the aqueous liquid, preferably water, one or more streams of aqueous liquid, preferably water, are sprayed from a sprayer onto the substrate particles while the particles are agitated, such as by being shaken or rotated in a drum or rotary drum type mixer, to more uniformly distribute the aqueous liquid, preferably water, on and along substantially the entire outer surface of each particle thereby substantially uniformly wetting each particle with a region of aqueous liquid, preferably water.

During the wetting step, the amount of the aqueous liquid, preferably water, is controlled or regulated in a manner to ensure enough aqueous liquid, preferably water is applied to wet substantially all of the outer surface(s) of each one of the substrate particles in the wetting chamber, which preferably is a drum of a rotary drum type mixer, such as a rotary drum cement mixer, which is rotated during introduction of the aqueous liquid, preferably water, into the drum to agitate the substrate particles to thereby more uniformly wet their outer surfaces with the aqueous liquid, preferably water. During the wetting step, the rotary drum is oriented about a generally central axis of drum rotation such that the drum is inclined upwardly relative to horizontal at an acute included angle of between 5° and 60°, preferably between 7.5° and 50°, and more preferably between 10° and 45° relative to horizontal to help not only facilitate wetting of the outer surfaces of the substrate particles but also to later facilitate mixing of the extruded self-clumping sorbent material particles with the wetted substrate particles to cause adherence thereto. During carrying out the method of making the self-clumping sorbent litter granules of the present invention, the angle of drum orientation relative to horizontal, the rotational speed of the drum, and the amount and/or rate of the aqueous liquid, preferably water, introduced into the drum, such as by misting or spraying, are all adjusted in real time during the wetting step, the application step, when the extruded self-clumping sorbent material particles are introduced into the drum, and the nucleation step, when the wetted substrate particles become nucleators causing the extruded self-clumping sorbent material particles to adhere thereto building up at least a partial region or coating of the extruded self-clumping sorbent material on each one of the substrate particles.

The amount of the aqueous solution, preferably water, used during the wetting step is an amount that is enough to substantially completely wet the outer surfaces of each one of the substrate particles prior to application of the smaller particles of the extruded sorbent clumping material thereto and/or thereon during an application step as disclosed in more detail below along with at least an additional 2%, preferably an additional 5% of the aqueous liquid, preferably water, to ensure there is an amount of excess water present beyond that which is needed to wet substantially all of the surface area of the outer surfaces of all of the substrate particles. Applying an amount of aqueous solution, preferably water, greater than the amount needed merely wet substantially the entire surface area of the outer surfaces of all of the amount of substrate particles used to make a batch of the self-clumping sorbent litter of the invention ensures there is sufficient water present to at least partially solubilize some, but not all, of the cold-water soluble extrusion-modified starch water-activated moisture-cured binder of the smaller particles of extruded sorbent clumping material coming in contact with the wetted outer surfaces of the substrate particle. This not only facilitate adherence of the smaller particles of extruded sorbent clumping material coming in contact with the wetted outer surface of each larger substrate particle during the application step but the partial solubilization of at least some, but not all, of the cold-water soluble extrusion-modified starch binder of the contacting extruded sorbent clumping material particles securely adhesively binds the extruded sorbent clumping material particles thereto.

In a further preferred method implementation, enough of an aqueous liquid, such as preferably water, is added to a mixture of the substrate particles and smaller particles of the extruded self-clumping sorbent material being agitated, such as by being shaken or rotated, to form a slurry composed of the aqueous liquid, e.g., water, substrate particles, and extruded self-clumping sorbent material particles. Agitation, shaking or rotation of the slurry of the substrate and extruded self-clumping absorbent material particle mixture continues causing the substrate particles to become nucleators to which particles of the extruded self-clumping absorbent material begin to adhere.

After the wetting step is completed or even during carrying out the wetting step, smaller particles of the extruded sorbent clumping material is added during an application step to cause each one of the wetted substrate particles to be at least partially covered, at least partially coated, and/or at least partially encapsulated by at least some of the extruded sorbent clumping material particles added and preferably mixed therewith, such as by using agitation, shaking, mechanical mixing, or another mixing method and/or mixing means. After or during the wetting of the substrate particles with the aqueous solution, preferably water, smaller particles of extruded sorbent clumping material are added during the application step, the wetted substrate particles become clumping sorbent litter granule nucleators during a nucleating substep whereby the smaller particles of the extruded sorbent clumping material are attracted to and even become drawn into contact with corresponding wetted substrate particles, including by one or more of surface tension acting between the water wetting the outer substrate particle surfaces and the extruded sorbent clumping material particles in close proximity therewith drawing them into contact with each other, capillary adhesion acting between molecules of each substrate particle and the molecules of extruded sorbent clumping particles in close enough proximity and/or in contact therewith, and/or intermolecular forces, such as preferably Van der Waals forces and/or intermolecular adhesion, acting between molecules of water wetting the outer surface of each substrate particle and/or molecules of the outer surface of each substrate particle and molecules of extruded sorbent clumping particles in extremely close proximity and/or in contact therewith. During this nucleation phase or substep of the extruded sorbent clumping material application step, an initial region of the particles of the extruded sorbent clumping material becomes drawn towards and into contact with water on the outer surface of each substrate particle wetted with aqueous liquid, preferably water, until at least some of the water wetting the outer surfaces of the substrate particle wets at least some of the extruded sorbent clumping material particles in close enough proximity and/or in contact therewith.

Where the nucleating substep overlaps with the wetting step, it only overlaps with part of the wetting step, beginning after at least one-half of the wetting step has been performed, preferably beginning after at least three-quarters of the wetting step has been performed, and more preferably beginning after nearly 90% to 95% of the wetting step has been performed. An advantage of beginning the nucleating step during the wetting step is that the amount of water needed to complete the wetting process can be adjusted to add an additional amount of excess water beyond that which is needed for only wetting the substrate particles in order to ensure the nucleating sub step reaches a stage where extruded sorbent clumping material particles adhere to at least 50%, preferably at least 65%, and more preferably at least 75% of the outer surface of the substrate particles by the time the wetting step is completed and the adding of water stopped.

The mixing or agitating step continues after the wetting step is finished and the adding of water stopped in order to continue carrying out the nucleating substep where unadhered particles of the extruded sorbent clumping material also become adhered to either (i) portions of the outer surface(s) of substrate particles not previously having any extruded sorbent clumping material particles adhered thereto, and/or (ii) other portions of the outer surface(s) of substrate particles already having extruded sorbent clumping material particles adhered thereto thereby increasing the thickness of the region of extruded sorb ent clumping material particles adhered thereto. As the mixing or agitating step continues, more and more of the previously unadhered extruded sorbent clumping material particles become adhered to either (i) previously unadhered surface area(s) of the substrate particles, and/or (ii) surface area(s) of the substrate particles to which extruded sorbent clumping material particles have been adhered thereby further increasing the thickness of the region of extruded sorbent clumping material particles adhered thereto.

In one preferred method of making a self-clumping litter comprised of self-clumping sorbent litter granules each formed of a non-clumping substrate particle to which smaller particles in the form of a powder or flour of an extruded self-clumping sorbent material composed of cold-water soluble extrusion modified starch water-activated moisture-cured binder and cold-water swellable extrusion modified starch, preferably in the form of a cold-water swellable extrusion-modified starch pregel, the following steps are performed:

Turn the rotary drum mixer on and add the substrate particles to be coated with the powder or flour particles of the extruded self-clumping sorbent material. Record the weight of the substrate being introduced into the rotating drum of the rotary mixer.

Change the angle of the barrel of the drum to maximize the rolling agitation or rolling action of the substrate particles to be coated induced by rotation of the drum of the mixer. Changing the angle means varying an acute included angle defined by a central axis of rotation of the drum relative to the generally horizontal ground upon which the rotary mixer is supported in a manner that maximizes or optimizes the agitation or tumbling of the substrate particles within the rotating barrel in a manner that are uniformly wets the substrate particles with water during application of water into the drum during the wetting step;

Initiate the wetting step by adding enough water to the barrel of the drum of the rotary mixer while the drum is rotating to fully wet the outer surfaces of the particles of the substrate. Allow the water to mix with and wet the substrate particles for up to 4 minutes, preferably no more than about 3 minutes, more preferably between 1 and 3 minutes, and check for free water. The substrate particles should be well wetted but not so wet that water will drain off and pool at the bottom of the barrel of the drum of the mixer. Remove a sample of the wetted substrate particles from the rotating barrel, hold the sample in your hand, and squeeze the sample to try to ball the sample up while continuing to hold and squeeze it in your hand. Any ball that forms when you open your hand should only slightly or loosely hold the shape of the ball, e.g., hold together slightly. Particles of inorganic substrates like sand, perlite, rubber, glass, and sand, only need a few seconds, preferably less than five seconds, to stabilize water sorption to thereby ensure more than adequate wetting with the water. Particles of organic substrates, like paper, wood fibers, wood pellets, and nut shells require a two-step wetting process whereby enough water is added to fully coat the organic substrate particles while the drum of the mixer continues to rotate for about 5 minutes. This provides enough time for the organic substrate particles to become fully wetted while also allowing absorption by the particles of least some of water to begin such as preferably by drawing at least some of the water into the fibers of the organic substrate particles. While the fibers on the outer surface of the organic substrate particles are instantly wetted, it takes time for some of the water to be drawn through the exterior fibers and wet the fibers of the interior of the organic substrate particles. Additional time is needed for organic substrate particles to allow the water to traverse or travel through the exterior fibers of each particle and begin to wet additional regions underneath the outer particle surface. If this second step is not performed to ensure that wetting extends into surface fibers of each particle and preferably into the fibers in the regions below the exterior surface, the actual region of water wetting the outer fibrous surface of each organic substrate particle will not be consistent or uniform. In other words, the water wetting the outside of each organic substrate particle will not have a consistent or uniform coating of water on the fibrous exterior of each organic substrate particle if this additional water wetting step or sub-step is not performed. The roughness of the outer surface of the organic substrate particles also will impact this water re-wetting sub-step because rougher outer substrate particle surfaces will require additional re-wetting cycles to be performed so that enough water soaks into the outer surface of each particle to ensure that a uniform coating of water ends up wetting the exterior of the rough substrate particles. So therefore, depending on the roughness of the fibrous surface of the substrate particles, we will need to rewet and add additional water at least a plurality of times and sometimes at least a plurality of pairs of times. Performing multiple re-wetting cycles where additional water is added to the drum during each re-wetting cycle keeps the outer surface of each one of the organic substrate particles saturated with water but does so without over-wetting or over saturating each particle with water that would result in pooling of water in the bottom of the mixture of the organic substrate particles in the bottom of the rotating drum. The aggregate amount of water used during the entire wetting step, including any additional water used during any re-wetting substeps, is recorded.

In the application step, the extruded self-clumping sorbent substrate coating powder or flour particles are added to the rotating drum, either while the wetting step is being performed, or more preferably after the wetting step has been completed. The powder or flour particles are controllably gradually introduced into the drum, such as preferably by sifting them into the drum, to help ensure the wetted outer surfaces of the substrate particles become coated, preferably substantially completely, e.g., fully, coated by the powder or flour particles.

During the application step, additional powder or flour particles of the extruded self-clumping sorbent material continue to be added to the drum onto the wetted substrate particles until the coated outer surface that builds up on the nucleating substrate particles becomes less and less tacky until region that builds up on the substrate particles becomes substantially tack free and preferably completely tack free. The powder or flour particles must be controllably and gradually continuously added while the drum is rotating thereby agitating or rolling the at least partially coated substrate particles to prevent the gel that forms from the cold-water soluble water-activated moisture-cured binder and cold water-swellable starch from causing adjacent coated substrate particles that come into contact with each other during agitation by the rotating drum to stick together and agglomerate. It is important that any clumps that form due to this gel agglomeration phenomena be sifted out either during drum rotation or after removal of the completed self-clumping sorbent litter granules of the present invention from the drum mixer. Any smaller clumps from gel agglomeration, such as any two or three pellet clumps, will be broken up and resized during a subsequent particle size reduction process using a particle size reducer, such as a counterrotating roll particle size reducer, or another type of particle size reducer, such as a hammer mill.

The extruded self-clumping sorbent powder or flour is an instantized starch powder or flour composed of an ultrahigh pressure extrusion modified starch pregel, which preferably is comprised of a cold water swellable extrusion modified starch, with the powder or flour also containing a sufficient amount of cold water-soluble water-activated moisture-cured binder to ensure not only some of it solubilizes during application of the powder or flour onto the wetted outer substrate particle surfaces to adhere thereto but also so that some remains in the finished self-clumping sorbent litter granules of the present invention so there will be at least some water soluble binder that forms a flowable adhesive when the litter granules are wetted with water, urine or a synthetic urine during actual litter use. It is critical to maximize at least the starch damage of starch in the admixture being extruded and preferably also the protein damage in the admixture of the starch being extruded through the configuration of the single screw extruder used to extrude the extruded self-clumping sorbent powder or flour including by operating the single screw extruder at an ultrahigh extrusion pressure of at least 2500 PSI, preferably at least 3000 PSI, more preferably at least 4000 PSI, and even more preferably 5000 PSI, as measured within the extruder at the extruder die, thereby extruding a self-clumping sorbent powder or flour comprised of at least some instantized starch, at least some cold-water swellable water absorbent starch modified during ultrahigh pressure extrusion.

In a preferred method and embodiment for extruding the self-clumping sorbent powder or flour, it is critical to use a single screw extruder barrel longer than twelve inches, preferably longer than fourteen inches, to ensure that starches are being modified during ultrahigh pressure extrusion in the single screw extruder by virtue of the longer extruder barrel increasing starch retention time in the extruder that thermally modifies a sufficient amount of the starch into an instantized starch that preferably is a cold-water swellable water-absorbent extrusion modified starch that more preferably is a cold-water swellable water-absorbent extrusion modified pregelatinized starch or cold-water swellable water-absorbent extrusion modified starch pregel. The use of longer extruder barrels in the single screw extruder ensures that if some of the starch has not been mechanically damaged and instantized and/or pregelatinized during extrusion, the longer barrel will ensure a sufficient retention time or dwell time of the starches inside the extruder barrel so that a sufficient amount of the starches become modified by or during extrusion, preferably by being thermally modified during extrusion to form instantized starch that preferably is a cold water swellable pregel. This maximizes the amount and number of starches that gel when wetted when in contact with the water-wetted outer surfaces of the substrate particles and coat the water-wetted outer substrate particles surfaces therewith thereby become well adhered thereto preferably via hydrogen bonds upon the wetted gel drying.

In a self-clumping sorbent litter granule finishing step that is performed after the coating step is completed, an additional amount of extruded self-clumping sorbent flour or powder is applied, such as by sprinkling or dusting the flour or powder onto the outer surfaces of the coated substrate particles, i.e., the outer surfaces of the self-clumping sorbent litter granules of the present invention, to ensure there is at least a thin exterior region of the extruded self-clumping sorbent flour or powder thereon that was never wetted and which will contribute substantially all of its cold water soluble extrusion modified starch water-activated moisture-cured binder when the finished litter granules are wetted with water, urine or synthetic urine during use of the litter in a litter box. The post-coating self-clumping sorbent litter granule finishing step can be and preferably is performed while the outer surfaces of the self-clumping sorbent litter granules are still moist or tacky to thereby facilitate adherence of the region of the dry extruded self-clumping sorbent flour or powder thereto. The post coating self-clumping sorbent litter granule finishing step can be and preferably is performed while the drum of the mixer is rotating to continue agitating the nearly finished self-clumping water absorbent litter granules of the present invention to help ensure a more consistent and uniform distribution of the dry flour or powder particles so that an outer region having a more consistent and uniform thickness is formed. In a preferred implementation of a self-clumping sorbent litter granule making method of the present invention, a region of the dry extruded self-clumping sorbent flour or powder is applied while at least a portion and preferably substantially all of the outer surfaces the self-clumping sorbent litter granules are comprised of a starch gel formed of at least some of the modified, preferably thermally modified, starch that was modified, preferably thermally modified, while in the barrel of the extruder during extrusion of the extruded self-clumping sorbent flour or powder. In one such preferred implementation of a self-clumping sorbent litter granule making method of the present invention, the region of the dry extruded self-clumping sorbent flour or powder is applied while at least a portion and preferably substantially all of the outer surfaces the self-clumping sorbent litter granules are comprised of such a starch gel while still in a gel-state and preferably before the gel has not fully been transformed, such as preferably by retrogradation of starches that form the gel, from a semi-solid into a solid.

In such a preferred implementation of a self-clumping sorbent litter granule making method of the present invention, the region of the dry particulate modified-starch water-absorbent clumping agent preferably in the form of extruded self-clumping sorbent flour or powder is applied while at least a portion and preferably substantially all of the outer surfaces the self-clumping sorbent litter granules are comprised of such a starch gel that is still moist and/or tacky. Doing so not only facilitates adherence of the dry particles of the extruded self-clumping sorbent flour or powder, as a result of the outer gel surface still being moist and/or tacky, but the application of the dry particles of the extruded self-clumping sorbent flour or powder soaks up at least some of the exterior surface moisture and de-tackifies the outer gel surface forming self-clumping litter granules of the present invention with a dry-ready-to-wet self-clumping sorbent exterior. In addition, the starch, including the cold water-soluble extrusion modified starch water-activated moisture-cured binder and the cold-water swellable water absorbent extrusion modified starch of this dry extruded self-clumping sorbent flour or powder will advantageously not become retrograded during the application of heated air thereon during the self-clumping sorbent litter granule drying step. The finished self-clumping absorbent litter granules are preferably dried to a moisture content of no greater than 8% by granule weight and preferably to a moisture content of less than 8% by granule weight to ensure any residual moisture or water remaining will not be enough to plasticize the starches in the outer region of extruded self-clumping absorbent material of the litter granules and lead to additional retrogradation of starches in this outer region of the granules.

Where the self-clumping sorbent litter granules are formed of a water-wetted nutshell substrate particle to which the coating or region of the extruded self-clumping water absorbent flour or powder becomes adhered forming an outer region of the extruded self-clumping absorbent flour or powder that also comprises a gel that facilitates its adhesive attachment to the substrate particle, the region of the dry extruded self-clumping absorbent flour or powder applied to the outer self-clumping water absorbent litter granule region while it is still wet and comprised of a gel still in the gelled state facilitates adhesion of the dry flour or powder particles thereby creating a dry shell over the outer gelled region. This dry exterior region is well adhered to the outer gel region which is in turn well adhered to the outer surface of the substrate particle preferably through adhesive attachment via hydrogen bonds between the outer gel region and the outer substrate particle surface.

During the drying step, the heated air introduced in the drum to dry the self-clumping water absorbent litter granules of the present invention preferably during or after completion of the post-coating self-clumping sorbent litter granule finishing step not only facilitates drying of the of moist gelled starch adhered to the outer surface of the substrate particle, but the heated air retrogrades starch, including the starch gel, wetted by water on the outer surface of the substrate particle hardening this inner region adhered to and preferably adhesively bonded to the outer surface of the substrate particle that is located between the outer surface of the substrate particle and the outer region of the dry extruded self-clumping water absorbent flour or powder adhered to and preferably adhesively bonded to the inner region forming a finished self-clumping water absorbent litter granule of the present invention.

These and various other features, aspects, and advantages of the present invention will be made apparent from the following descriptions of the drawings.

### DRAWING DESCRIPTION

One or more preferred exemplary embodiments of the invention are illustrated in the accompanying drawings in which like reference numerals represent like parts throughout and in which:

FIG. 1 is an enlarged cross-sectional view of a sorbent granule that is a self-clumping sorbent litter granule composed of an inner substrate particle at least partially covered, preferably substantially completely covered, with a modified starch absorbent clumping material, preferably modified starch absorbent clumping agent;

FIG. 2A is an enlarged photomicrograph of particles of calcium bentonite used as a non-clumping granular substrate in one embodiment of the present invention;

FIG. 2B is an enlarged photomicrograph of exemplary grains of sand used as a non-clumping granular substrate in one second embodiment of the present invention;

FIG. 2C is an enlarged photomicrograph of additional exemplary sand grains used as a non-clumping granular substrate in another second embodiment of the present invention;

FIG. 2D is a photomicrograph of particles of comminuted walnut shells used as a non-clumping granular substrate in a third embodiment of the present invention;

FIG. 2E is a photomicrograph of particles of a cellulosic material that preferably is or contains paper and used as a non-clumping granular substrate in a fourth embodiment of the present invention;

FIG. 2F is an enlarged photomicrograph of particles of perlite used as a non-clumping granular substrate in a sixth embodiment of the present invention;

FIG. 2G is an enlarged photomicrograph of wood particles used as a non-clumping granular substrate in a fifth embodiment of the present invention;

FIG. 2H is an enlarged photomicrograph of wood pellets used as a non-clumping granular substrate in a seventh embodiment of the present invention;

FIGS. 3-5 are enlarged photomicrographs of a plurality of pairs of calcium bentonite substrate particles each coated with an outer region of extrusion-modified starch water-absorbent clumping agent;

FIG. 6 is a first video frame grab of at least a plurality of self-clumping sorbent litter granules prior to wetting with water showing each litter granule made of an outer region of extrusion-modified starch water-absorbent clumping agent that coats a calcium bentonite substrate particle;

FIG. 7 is a second video frame grab which takes place at least a plurality of seconds after the first video frame grab of FIG. 6 depicting initial wetting with water of the litter granules of FIG. 6 causing at least some of the outer region of extrusion-modified starch water-absorbent clumping agent of at least a plurality of the granules wetted with the water to at least partially solubilize in the water forming a flowable adhesive that flows from the wetted granules into the water towards contacting and adjacent litter granules;

FIG. 8 is a third video frame grab which takes place at least a plurality of seconds after the second video frame grab of FIG. 7 depicting additional wetting with water of the litter granules of FIG. 7 causing some of the outer region of extrusion-modified starch water-absorbent clumping agent of the granules wetted with the water to absorb some of the water and swell while causing some other of the outer region of the extrusion-modified starch water-absorbent clumping agent of the same wetted granules wetted to at least partially solubilize in the water and form flowable adhesive that flows from the wetted granules in the water towards contacting and adjacent litter granules increasing in viscosity over time transforming into an adhesive gel that begins agglomerating wetted, contacting and adjacent granules together into a clump—FIG. 8 also illustrate the viscosity of at least some of the adhesive gel that formed earliest from the water soluble binder further increasing thereby thickening the a bonding gel that begins to adhere contacting wetted granules and even some adjacent granules such as preferably using intermolecular forces, such as liquid adhesion forces, surface tension, Van der Waals forces and even some hydrogen bonds in the early stages of forming a clump of the wetted, contacting and adjacent litter granules—FIG. 8 also shows how the at least partially solubilized binder transforms into flowable adhesive that flows from wetted granules along and in between contacting and adjacent granules increasing in viscosity over time thickening into an adhesive gel that facilitates adherence of the contacting and adjacent granules in the beginning stages of litter clump formation;

FIG. 9 is a fourth video frame grab which takes place at least a plurality of seconds after the third video frame grab of FIG. 9 depicting (a) even further wetting with water of the litter granules of FIG. 8, (b) even more creation of flowable adhesive from wetted at least partially soluble binder of some of the outer region of extrusion-modified starch water-absorbent clumping agent of each one of the wetted granules, (c) even more swelling and even gelling from water absorption by the water swellable water absorbent extrusion modified starch of some of the outer region of extrusion-modified starch water-absorbent clumping agent of each one of the wetted granules, (d) the transition of more flowable adhesive into viscous slower flowable adhesion gel, and (e) the transition of at least some and preferably more and more of the adhesion gel into a stable, firm bonding gel that flows very little if at all;

FIG. 10 is a fifth video frame grab which takes place at least a plurality of seconds after the fourth video frame grab of FIG. 9 depicting solubilizing of at least some of the water soluble binder present in at least some of the outer region of extrusion-modified starch water-absorbent clumping agent of each one of the wetted granules, swelling and gelling during water absorption by at least some of the cold water swellable cold water absorbent extrusion modified starch also present in at least some of the outer region of extrusion-modified starch water-absorbent clumping agent of each one of the wetted granules;

FIG. 11 is a sixth video frame grab which takes place at least a plurality of seconds after the fifth video frame grab of FIG. 10 depicting widespread solubilization of the water soluble binder into flowable adhesive in water wetting the outer region of extrusion-modified starch water-absorbent clumping agent of all of the granules and also illustrating widespread swelling and gelling by the volumetric expansion of the cold water swellable cold water absorbent extrusion-modified starch of the outer region of extrusion-modified starch water-absorbent clumping agent of all of the granules depicting substantially of the granules being wetted coalescing into an amorphous gelled mass where the boundaries of the wetted granules become increasing less well defined:

FIGS. 12-15 show the further progression of the water-wetted self-clumping water absorbent litter granules of the present invention with further gelling and swelling occurring, including resulting from or in more flowable adhesive being formed from at least partially water-soluble binder that flows from, around, along and in between the litter granules released from as well as contacting litter granules and adjacent granules that increases in viscosity over time into an adherent gel that facilitates agglomeration of the litter granules in contact therewith and adjacent thereto which further increases in viscosity over time into a bonding gel that adhesively bonds together the litter granules in contact there with and adjacent thereto all while continuing to moisture cure, harden and eventually within 120 seconds, forming a clump of the litter granules there at least the bonding gel hardens into a substantially hard adhesive in the form of glassy state material producing a clump that is substantially rock hard and which has a moisture retention rate of at least 95%, preferably at least 97%, more preferably at least 99% and which has a clump crush strength of at least 40 PSI, preferably at least 60 PSI, more preferably at least 80 PSI and even more preferably at least 100 PSI when dried to a moisture content of about 12% by clump weight.

FIG. 16 is an enlarged photomicrograph of a top view of a clump formed of at least a plurality of pairs self-clumping litter granules each having of an outer region of ultrahigh pressure modified starch extrudate composed of modified-starch water-absorbent clumping agent coating and adhering to inner substrate particles that are each grains of sand—FIG. 5 shows the top view of an extrudate coated sand clump after drying and particularly shows the abundance of ultrahigh pressure extrusion modified starch globules, preferably ultrahigh pressure extrusion modified starch partially solubilized gel globules, more preferably ultrahigh pressure extrusion modified starch water insoluble and/or partially water soluble water-wetted pregelatinized starch globules, even more preferably ultrahigh pressure extrusion modified starch water insoluble water-wetted pregelatinized starch gel globules—these starch globules have floated to the top of the clump exposing at least some of the outer surfaces of the inner sand grains after wetting with water or urine during clumping;

FIG. 17 is an enlarged photomicrograph of a bottom view of the clump of FIG. 16 formed of at least a plurality of pairs of water or urine wetted self-clumping litter granules each having of an outer region of ultrahigh pressure modified starch extrudate composed of modified-starch water-absorbent clumping agent coating and adhering to inner substrate particles that are each grains of sand—in the bottom view of the extrudate coated sand granules there is a lack of free starch, e.g., —note lack of free starch—only sand showing extrusion modified starch globules attached to the sand grains;

FIG. 18 is an enlarged photomicrograph of a side view of the clump of FIGS. 16 & 17 formed of at least a plurality of pairs self-clumping litter granules each having of an outer region of ultrahigh pressure modified starch extrudate composed of modified-starch water-absorbent clumping agent coating and adhering to inner substrate sand grains or sand grain particles—the side view of the clump of the extrudate coated sand granules also shows extrusion-modified starch globules that have floated to the top of the clump;

FIGS. 19-26 is a sequence of video grabs showing the water re-activation of the at least partially soluble modified starch binder, including producing water-reactivated moisture re-curing flowable adhesive therefrom when previously water wetted self-clumping absorbent litter granules of the present invention composed of grains of sand as substrate particles covered by an outer region of the modified starch absorbent clumping material or modified starch absorbent clumping agent are re-wetted with water with a sequence showing a progression of flowable adhesive from the water wetted granules flowing therefrom that gels while water is absorbed into the outer region of modified starch water absorbent clumping material or clumping agent remaining on the sand grains substrate particles swells the volume thereof—after re-wetting and drying the flowable adhesive and at least some of the adhesive remaining in the older region of the modified starch water absorbent clumping material or agent that has not dissolved in the re-wetting water re-cures via moisture re-curing and hardens into a substantially hard mass or clump transitioning into a solid glassy material state whereby mass or clump has a clump retention rate of at least 95%, preferably at least 97%, more preferably at least 99%, and a crush or compressive strength of at least 40 PSI, preferably at least 60 PSI, more preferably at least 80 PSI, and even more preferably at least 100 PSI when dried to a moisture content of about 12% by weight.

FIG. 27 is an enlarged photomicrograph of particles of crushed walnut shells prior to being coated with ultrahigh pressure extrudate comprised of extrusion-modified starch water-absorbent clumping;

FIG. 28 is an enlarged photomicrograph of particles of crushed walnut shells each coated with ultrahigh pressure extrudate that is or comprises extrusion-modified starch water-absorbent clumping agent forming a thin outer coating that is adhered to the outer surface of each crushed walnut shell substrate particle forming self-clumping sorbent litter and self-clumping sorbent litter granules of the present invention;

FIG. 29 is another enlarged photomicrograph of particles of crushed walnut shells each coated with ultrahigh pressure extrudate that is or comprises extrusion-modified starch water-absorbent clumping agent forming a thin outer coating that is adhered to the outer surface of each crushed walnut shell substrate particle forming self-clumping sorbent litter and self-clumping sorbent litter granules of the present invention;

FIG. 30 is an enlarged photomicrograph of particles of crushed walnut shells each coated with ultrahigh pressure extrudate that is or comprises extrusion-modified starch water-absorbent clumping agent forming a thin outer coating that is adhered to the outer surface of each crushed walnut shell substrate particle forming self-clumping litter granules thereof after ten grams of the self-clumping litter granules were washed twenty seconds and thereafter dried reducing the granule coating weight of the thin outer coating of the ultrahigh pressure extrudate that is or comprises extrusion-modified starch water-absorbent clumping agent of each litter granule from about 15%-16% granule coating weight (by litter granule weight) to about 4.5% granule coating weight (by litter granule weight) such that each litter granule still has enough of the coating to absorb water or urine and at least weakly agglomerate when wetted and preferably still also form a clump when wetted; and

FIG. 31 is an enlarged photomicrograph of particles of crushed walnut shells each coated with ultrahigh pressure extrudate that is or comprises extrusion-modified starch water-absorbent clumping agent forming a thin outer coating that is adhered to the outer surface of each crushed walnut shell substrate particle forming self-clumping litter granules thereof after twenty grams of the self-clumping litter granules were washed twenty seconds and thereafter dried reducing the granule coating weight of the thin outer coating of the ultrahigh pressure extrudate that is or comprises extrusion-modified starch water-absorbent clumping agent of each litter granule from about 15%-16% granule coating weight (by litter granule weight) to about 5% granule coating weight (by litter granule weight) such that each litter granule still has enough of the coating to absorb water or urine and at least weakly agglomerate when wetted and preferably still also form a clump when wetted.

While preferred embodiments of a method of making self-clumping litter using a granular non-clumping substrate in accordance with the present invention have worked with as many types of granular non-clumping substrates as has been tried to date, it is contemplated that the litter making methods of the present invention will also work with many other types of substrate particles, both non-clumping and clumping substrate particles.

Before explaining one or more embodiments of the invention in detail, it is to be understood that the invention is not limited in its application to the details of construction and the arrangement of the components set forth in the following description and illustrated in the drawings. The invention is capable of other embodiments or being practiced or carried out in various ways. Also, it is to be understood that the phraseology and terminology employed herein is for the purpose of description and should not be regarded as limiting.

### DETAILED DESCRIPTION OF THE INVENTION

### Definitions

Before explaining one or more embodiments of the invention in detail, it is to be understood that the invention is not limited in its application to the details of construction and the arrangement of the components set forth in the following description and illustrated in the drawings. The invention is capable of other embodiments or being practiced or carried out in various ways.

Before the present materials, products and methods are described hereinbelow, it is to be further understood that this invention is not limited to the particular methodology, protocols, materials, and reagents described, as these may vary. It is also to be understood that the terminology used herein is for the purpose of describing particular embodiments only and is not intended to limit the scope of the present invention, which will be limited only by the appended claims.

It must be noted that as used herein and in the appended claims, the singular forms “a”, “an”, and “the” include plural reference unless the context clearly dictates otherwise. As well, the terms “a” (or “an”), “one or more” and “at least one” can be used interchangeably herein. It is also to be noted that the terms “comprising”, “including”, and “having” can be used interchangeably.

For purposes of the present invention, terms which indicate direction, such as “top,” “bottom,” “upper,” “lower,” “above,” “below,” “left,” “right,” “horizontal,” “vertical,” “up,” “down,” and the like, as well as terms which indicate positioning and orientation are merely used for convenience in describing the various embodiments of the present invention. The embodiments of the present invention also may be oriented in various ways. For example, the diagrams, apparatuses, etc., shown in the drawing figures may be flipped over, rotated by ninety (90) degrees in any direction, reversed, mirror imaged, etc.

Unless defined otherwise, all technical and scientific terms used herein have the same meanings as commonly understood by one of ordinary skill in the art to which this invention belongs. Although any methods and materials similar or equivalent to those described herein can be used in the practice or testing of the present invention, the preferred methods and materials are now described. All publications and patents specifically mentioned herein are incorporated by reference for all purposes including describing and disclosing the ingredients, reagents, chemicals, devices, manufactures, statistical analysis and methodologies which are reported in the publications which might be used in connection with the invention. All references cited in this specification are to be taken as indicative of the level of skill in the art. Nothing herein is to be construed as an admission that the invention is not entitled to antedate such disclosure by virtue of prior invention.

Where the definition of any of the following terms departs from the commonly used meaning of the term, applicant intends to utilize the definitions provided below, unless specifically indicated.

For purposes of the present invention, a value or property is “based” on a particular value, property, the satisfaction of a condition or other factor, if that value is derived by performing a mathematical calculation or logical decision using that value, property, or other factor.

For purposes of the present invention, the term “blend” refers to a uniform or substantially uniform mixture of two or more solid materials. One or more materials in a blend may be coated.

For purposes of the present invention, the term “substantially uniform” refers to a mixture that has substantially the same density throughout the mixture.

For purposes of the present invention, the term “uniform” refers to a mixture of two or more solid materials wherein a measured density of the composition for ten or more samples of the mixture has a standard deviation of no greater than 2.0 lbs./ft′ throughout the mixture. One or more of the solid materials may be coated.

For purposes of the present invention, the term “uniform blend” refers to a blend that is uniform.

For purposes of the present invention, the term “uniform mixture” refers to a mixture that is uniform.

For purposes of the present invention, the terms “wetting agent” or “wetting liquid” refers to a liquid that wets sorbent granules, such as litter granules. Examples of wetting agents or wetting liquids include liquids such as water, aqueous solutions, urine, synthetic urine, and the like.

For purposes of the present invention, the term “cellulose-containing material” refers to a material in which at least 10% or more of the material is composed of cellulose. Examples of cellulose-containing materials include paper, wood fiber, sawdust, fibers, hulls, etc.

For purposes of the present invention, the term “clumping additive” refers to a clumping agent other than sodium bentonite.

For purposes of the present invention, the term “clumping agent” refers to a material that causes granules containing the clumping agent to clump together when wetted with a wetting agent forming a cohesive clump of at least a plurality of pairs, i.e., at least three, of the wetted granules that becomes substantially hard when dried to a moisture content of no greater than 15% by weight of the hardened clump.

For purposes of the present invention, the term “clump strength” refers to the numerical value of average clump compressive strength in pounds per square inch (PSI) for a clump that has been dried to a moisture content of about 12% and crushed while measuring compressive or crush strength.

For purposes of the present invention, the term “filler” and the term “filler material” refer to a material in a litter product other than a clumping agent, i.e., other than sodium bentonite or a clumping additive. In one embodiment of the present invention, a filler material may be calcium bentonite. In another embodiment of the present invention, the filler material may be sand. In a further embodiment of the present invention, the filler material may be a cellulose-containing material.

For purposes of the present invention, the term “fines” refers to particles that are generally smaller than 1/32 inch 800 microns) but larger than 2/125 inch 400 microns) which pass through a #20 US Mesh screen or sieve and which stand on a #40 US Mesh screen or sieve.

For purposes of the present invention, the term “flour” refers to particles smaller than fines and which pass through a #40 US Mesh screen or sieve.

For purposes of the present invention, the term “fragrance” is a compound configured to give off an odor that is perceived as a pleasant smell and/or is a compound such as in the form of a masking fragrance that neutralizes or hides an odor that is unpleasant or undesirable. The term “fragrance” can refer to a coating comprising a fragrance such as by being added to a coating or by the fragrance itself being a coating. A fragrance coating may include one or more other constituents or components.

For purposes of the present invention, the term “granular” refers to a solid material having a particle size below two (2) mesh. A solid material used in a mixture of the present invention may be ground to form a granular material.

For purposes of the present invention, the term “granular filler” and the term “granular filler material” refer to a filler that is granular.

For purposes of the present invention, the term “heterogeneous mixture” refers to a composition in which the components of the mixture may be readily separated from each other.

For purposes of the present invention, the term “homogeneous mixture” refers to a composition that is uniform.

For purposes of the present invention, the term “mixture” refers to a composition comprising two or more different components that are mixed but not combined chemically. An individual component of a heterogenous mixture may comprise two or more substances that are combined chemically, such as a substrate that is a filler material that is coated with a sorbent swelling and gelling starch-containing biopolymeric clumping agent of the present invention.

For purposes of the present invention, the term “non-calcium bentonite clay” refers to a clay other than calcium bentonite. Because a filler material cannot be sodium bentonite, a “non-calcium bentonite clay” cannot be sodium bentonite.

For purposes of the present invention, the term “removably clumpable” refers to a litter that, when exposed to a wetting agent or wetting liquid forms a clump comprised of at least a plurality of pairs of granules of the litter having a firmness of sufficient structural integrity and hardness to withstand mechanical separation from unwetted litter for disposal and which has a clump retention rate of at least 98%, preferably at least 99%, when a clump of the litter granules is drop tested in accordance with the Standard Litter Drop Test defined hereinbelow.

### INTRODUCTION

The present invention is directed to a granular swelling and gelling sorbent composed of particles of an inorganic or organic substrate, which can be either a non-sorbent substrate or a minimally sorbent substrate, where are sorbent granule-forming nucleators to which an exteriorly disposed modified-starch water-absorbent clumping agent that preferably is a modified-starch-based sorbent swelling biopolymeric gellant is applied and adhered thereto. The resultant granules of swelling and gelling sorbent are preferably self-clumping sorbent litter granules each composed of an exterior coating or region which at least partially covers and can substantially completely encapsulate an inner non-sorbent or minimally sorbent substrate particle or granule. During sorbent use, wetting with a liquid, such as preferably an aqueous liquid, causes an outer region of the modified-starch water-absorbent clumping agent which preferably includes a sorbent swelling biopolymeric gellant of each swelling and gelling sorbent granules to sorb at least some of the liquid and swell in size and volume while also substantially simultaneously gelling. The gel formed of the liquid-sorbed gellant of each wetted swelling and gelling sorbent granule swells and expands as a result of liquid sorption coalescing with the gel formed of the liquid-sorbed gellant of adjacent wetted swelling and gelling sorbent granules forming an agglomerated or agglutinated mass of wetted swelling and gelling sorbent granules. The wetted sorbent swelling biopolymeric gellant of each swelling and gelling sorbent granule not only swells and forms a water-activated moisture-curing adhesive gel as it sorbs the liquid, preferably aqueous liquid, e.g., water, urine, or an aqueous solution, but expands in size and volume during sorption and gelling while also moisture curing into a substantially hard adhesive bonding the wetted granules together as they dry forming a substantially rock hard clump. Such a clump, when moisture cured by drying the clump to a moisture content of about 12% by clump weight, as a clump retention rate of at least 95%, preferably at least 97%, or preferably at least 99% while also having a clump crush strength or clump compressive strength of at least 40 PSI, preferably at least 60 PSI, more preferably at least 80 PSI, and even more preferably at least 100 PSI.

In a preferred embodiment, the wetted sorbent swelling biopolymeric gellant not only forms an adhesive gel when wetted, but also forms a water-activated moisture-curing modified starch flowable adhesive which flows from the granules in and around contacting granules and adjacent granules agglomerated or agglutinated the granules into a clump thereof. Such a clump, when moisture cured by drying the clump to a moisture content of about 12% by clump weight, as a clump retention rate of at least 95%, preferably at least 97%, or preferably at least 99% while also having a clump crush strength or clump compressive strength of at least 40 PSI, preferably at least 60 PSI, more preferably at least 80 PSI, and even more preferably at least 100 PSI.

The present invention most preferably also is directed to a self-clumping litter composed of self-clumping litter granules each formed of a non-clumping substrate particle to which is adhered a water-activated moisture-curing water-absorptive swelling and gelling polymer or biopolymer clumping agent composed of at least 5% water-soluble binder which not only imparts culpability to the non-clumping substrate particle but which also forms clumps of at least a plurality of pairs of wetted self-clumping litter granules that form a substantially hard, i.e. rock hard, clump when dried.

The present invention also is directed to a method of making a granular sorbent composed of water absorbent gelling and swelling sorbent granules of a nonabsorbent or minimally absorptive substrate carrying an outer region composed of the starch-based water absorbent gellant that contains modified starch water polymer binder that is water-activated and moisture cures into a solid adhesive in a starch glassy state as it dries. The present invention most preferably is directed to a method of making a self-clumping litter composed of self-clumping litter granules each formed of a non-clumping substrate particle to which water-activated moisture cured water absorptive swelling and gelling polymer or biopolymer clumping agent is adhered.

In an implementation of a method of making water absorbent gelling and swelling sorbent granules, the nonabsorbent or minimally absorbent substrate particles are wetted with a wetting liquid which preferably is water or an aqueous solution in a wetting step to prepare an outer surface of each one of the substrate particles for adherence of a powdered starch-based water absorbent gellant containing modified starch water soluble polymer binder that is applied thereto during an application step. During the application step, the powdered starch-based water absorbent gellant containing modified starch water polymer binder and the wetted substrate particles are mixed together until an outer region of the powdered starch-based water absorbent modified starch water soluble polymer binder-containing gellant adheres to each one on of the wetted substrate particles producing the water absorbent gelling and swelling sorbent granules of the present invention. Preferably each one of the wetted substrate particles is at least partially encapsulated and preferably substantially completely encapsulated by an outer region of the powdered starch-based water absorbent modified starch water soluble polymer binder-containing gellant. During the application step, at least some of the modified starch water soluble polymer binder in the starch-based water absorbent gellant powder in contact with each one of the wetted substrate particles is solubilized by the wetting liquid, preferably water or an aqueous solution, adhering partially wetted and unwetted water absorbent gellant powder particles to each one of the substrate particles. After the application step is completed, a moisture curing step is performed where moisture is removed, preferably by drying, to cause the solubilized water-soluble polymer binder that has adhered partially wetted and unwetted water absorbent gellant powder particles to each one of the wetted substrate particles to cure and adhesively affix a region of the water absorbent gellant powder particles to each one of the substrate particles.

The present invention also is directed to a self-clumping sorbent granular litter and method of making the self-clumping sorbent granular litter composed of self-clumping absorbent litter granules which include generally rounded self-clumping absorbent coated substrate litter granules. Each one of the generally rounded self-clumping absorbent coated substrate litter granules has a coating with a generally round outer surface at least partially, preferably substantially completely, filled with microscopic water absorption enhancing projections, e.g., spikes, upraised from the granule outer surface formed during agglomeration. The outer surface of the coating of each one of the generally rounded self-clumping absorbent coated substrate litter granules also is configured with myriad water absorption enhancing micro-cracks formed in the outer surface during curing after agglomeration as well as during post-curing drying after agglomeration.

Each one of the coated-substrate litter granules is formed of an inner substrate, in the form of a litter granule nucleating substrate particle, and an outer modified starch water-absorbent clumping agent configured to absorb water or urine during litter use, agglomerate, and self-clump into a removably scoopable clump of wetted litter granules, which include at least a plurality of pairs of the coated-substrate litter granules, which can be scooped using a handled perforate litter scoop, which has a clump retention rate of at least 95%, preferably at least 97%, more preferably at least 99%, and which has a clump crush strength of at least 40 pounds per square inch (PSI), preferably at least 60 PSI, more preferably 80 PSI, even more preferably 100 PSI, when dry. In a preferred self-clumping absorbent coated-substrate litter granule embodiment, each coated-substrate litter granule of the present invention has an outer coating of the modified starch water-absorbent clumping agent adhesively self-adhered to an outer surface of the inner substrate particle by an inner self-adhering region using an agglomeration method of the present invention discussed in more detail below.

In one preferred embodiment, a self-clumping litter according to the present invention has at least 20%, preferably has at least 30%, and more preferably has at least a majority, i.e., at least 50%, by litter weight, composed of the self-clumping absorbent coated-substrate litter granules of the present invention forming a multicomponent litter which can have the remainder composed of one or more other types of granular components, e.g., non-clumping calcium bentonite granules and/or non-clumping organic granules, and still form removably scoopable clumps upon wetting with water or urine that have a clump retention rate of at least 95%, preferably at least 97%, more preferably at least 99%, and a clump crush strength of at least 40 PSI, preferably 60 PSI, more preferably 80 PSI, even more preferably 100 PSI, when dry. Such a self-clumping sorbent granular litter, which can be a multicomponent litter, which is composed of anywhere from 20% and 100% of the self-clumping absorbent coated-substrate litter granules of the present invention, advantageously improves upon one or more of the properties and/or characteristics of past and present sodium bentonite litters and sodium bentonite based litters, is lighter in weight, cheaper to make and ship, easier to handle during transport, easier for users to lift, carry, and pour, produces less dust, preferably is non-dusting or even dust-inhibiting, and produces rounded coated-substrate litter granules which are not easily caught in a cat's paw thereby advantageously also reducing tracking from the litterbox.

During making of the coated-substrate litter granules, a coating of modified starch water-absorbent clumping agent is adhered via agglomeration, preferably wet agglomeration, to the outer surface of a substrate granule forming an inner self-adhering region of the coating using some, but not all, of the modified starch water-absorbent clumping agent which directly adheres to the substrate granule outer surface. The inner self-adhered region of the coating is directly adhered to the substrate granule outer surface by wetting at least one of the outer surface and the modified starch water-absorbent clumping agent material applied onto the outer surface. This leaves the rest of the modified starch water-absorbent clumping agent in an outer region of the coating surrounding the inner self-adhered region of the coating substantially unmodified, substantially unchanged, and available to absorb water and facilitate clumping upon being wetted with water or urine during litter or absorbent use. The inner adhering region is self-adhering because it is formed of the same modified starch water-absorbent clumping agent as the outer region but has some of its adhesive activated to directly adhere the inner adhering region to the outer surface of the substrate granule. In addition to at least one constituent of the modified starch water-absorbent clumping agent of each coated substrate coating being water absorbent, the modified starch water-absorbent clumping agent has at least one other constituent of each coated substrate coating that is a water-activated adhesive, preferably is a moisture-curing water-activated adhesive, that becomes activated when wetted with an aqueous wetting liquid, such as water or urine, by at least becoming tacky and which preferably also becomes flowable, forms a flowable adhesive, and which can also gel, i.e., thicken, during or after flowing.

In a preferred embodiment, the modified starch water-absorbent clumping agent has a first adhesive constituent that is a one-time water activated, one time water cured at least partially water-soluble adhesive, and a second adhesive constituent that is a water reactivated and water re-cured at least partially water-soluble adhesive. The second adhesive constituent preferably can be water reactivated and water re-cured at least a plurality of, preferably at least a plurality of pairs of, i.e., at least three, times. In a preferred embodiment, the first adhesive constituent is a starch modified at least physically during extrusion, i.e., a physically modified starch, and which preferably is a dextrinized starch which can be or include dextrin, but which is not necessarily dextrin. In such a preferred embodiment, the second adhesive constituent is a starch modified during extrusion into forming a starch pregel or pregelatinized starch which has adhesive properties.

A coating applied onto a substrate granule or substrate particle contains both the first adhesive constituent and the second adhesive constituent. In a preferred embodiment, a coating applied onto a substrate granule or substrate particle contains the first adhesive constituent, the second adhesive constituent, and a third water absorbent constituent configured to absorb room temperature water or cat-body temperature urine. In one embodiment, at least one of the first constituent, the second constituent, and the third constituent include or are composed of cold-water soluble starch that can be water and urine absorbent and which at least partially solubilizes in room temperature water and cat-body temperature urine. In another embodiment, at least both the first constituent and the second constituent are composed of or include water absorbent starch that is water and urine absorbent and are composed of or include modified starch which at least partially solubilizes in room temperature water and cat-body temperature urine.

During making of the coated substrate litter granules, preferably by agglomeration, either or both the modified starch water-absorbent clumping agent and the outer surface of the substrate granule are wetted with an aqueous wetting liquid, preferably water, ultimately causing wetting of at least some of the modified starch water-absorbent clumping agent activating some, but not all, of the water-activated adhesive in the modified starch water-absorbent clumping agent in forming the inner self-adhering region. In at least one preferred embodiment of the modified starch water-absorbent clumping agent at least some of the adhesive activated by the aqueous wetting liquid becomes at least somewhat tacky, preferably does become tacky, causing at least some of the modified starch water-absorbent clumping agent to stick to and adhere to the outer substrate granule surface. In at least another preferred embodiment of the modified starch water-absorbent clumping agent, at least some of the adhesive activated by the aqueous wetting liquid gels causing at least some of the modified starch water-absorbent clumping agent to stick to and adhere to the outer substrate granule surface in forming the inner self-adhering region. In at least a further preferred embodiment of the modified starch water-absorbent clumping agent, at least some of the adhesive activated by the aqueous wetting liquid becomes flowable, preferably forms a flowable adhesive, causing at least some of the modified starch water-absorbent clumping agent to stick to and adhere to the outer substrate particle surface in forming the inner self-adhering region. In at least one preferred embodiment of the modified starch water-absorbent clumping agent, at least some of the adhesive activated by aqueous wetting liquid wetting the modified starch water-absorbent clumping agent becomes tacky, at least some of the adhesive activated by aqueous wetting liquid wetting the modified starch water-absorbent clumping agent gels, and/or at least some of the adhesive activated by the aqueous wetting liquid wetting the modified starch water-absorbent clumping agent forms a flowable water-activated adhesive causing at least some of the modified starch water-absorbent clumping agent to stick to and adhere to the outer substrate particle surface in forming the inner self-adhering region.

The combination of this tackiness and the use of a tumbling action of the substrate granule during agglomeration, such as in a rotating drum into a coated substrate litter granule of the present invention leads to the formation of an outer coated substrate litter granule surface that has a multitude of upraised projections, which preferably include spikes, over substantially the entire outer coated substrate litter granule surface. These microscopic projections, including spikes, are microscopic in size by extending outwardly from the coated substrate litter granule surface no greater than 5 microns, preferably no greater than 2 microns, and more preferably no greater than about 1 micron (1 micron±0.25 microns). Preferably, these microscopic projections, including spikes, are nanoscale in size or nanosized each extending outwardly from the outer surface no farther than 1 micron. This tumbling action, such as carried out in a rotating drum, also is responsible for producing coated substrate litter granules of the present which are rounded and which can be substantially round, which minimize tracking by minimizing the likelihood of being picked up by a cat's paw during litter use. Because these projections, including any spikes, are so small as to be microscopic in size, they advantageously enhance absorption by speeding absorption by more rapidly spreading water or urine wetting the projections, including spikes, via wicking or capillary action substantially along the entire coated substrate litter granule outer surface while still maintaining the generally rounded configuration or shape of the coated substrate litter granule that minimizes tracking.

Thereafter, upon curing the projections, including the spikes, become substantially hard and absorption-enhancing micro-cracks form in the outer surface. These micro-cracks continue forming and propagating after curing, during drying and even during storage of the coated substrate litter granules after being packaged and prior to use. These micro-cracks can range in length from being nanoscale or nanosized, i.e., less than 1 micron, to being as long as the multi-micron thickness of the clumping agent coating at least partially covering the substrate particle or substrate granule that forms the substrate coated litter granule. In a preferred embodiment, these microcracks range in size from having a root thickness of no more than about 1 micron and length of no more than about 50 microns (50 microns±5 microns) to a root thickness as little as about 5 nanometers (5 nanometers±3 nanometers) and a length of as little as about 5 nanometers, e.g., root thickness of between about 5 nanometers and about 1 micron and length of between about 5 nanometers and about 50 microns. These microcracks further enhance absorption via wicking or capillary action to open up portions of the outer coated substrate litter granule coating upon wetting with water or urine thereby rapidly increasing the magnitude of the surface area thereof in contact with water or urine which can absorb the water or urine. The projections, including the spikes, work in concert with the microcracks to not only enhance absorption by speeding absorption but also speeding flow of flowable adhesive from each wetted coated substrate litter granule thereby also enhancing clumping.

In a preferred method and embodiment, at least some of the adhesive of the first adhesive constituent of the modified starch water-absorbent clumping agent is activated and cures thereby helping to bond the self-adhering region to the outer substrate granule surface. At least some of the adhesive of the second adhesive constituent also is activated and cures thereby also helping to bond the self-adhering region to the outer substrate granule surface.

A preferred self-clumping litter of the present invention includes self-clumping absorbent coated substrate litter granules each having a granule coating weight of each inner substrate particle of between about 5% and about 35%, preferably between about 5% and 50%, more preferably between about 5% and 85% of modified starch water-absorbent clumping agent by coated substrate litter granule weight and which produces self-clumping coated substrate litter granules of the invention which each absorb at least two times, preferably at least three times, more preferably at least four times, most preferably at least six times their coating weight in water, such as preferably room temperature water having a temperature of between 68°-72° Fahrenheit and urine, such as cat body temperature urine having a temperature between about 100° Fahrenheit and about 104°. The wetted coated substrate litter granules do so while also agglomerating with adjacent water or urine wetted litter granules in self-clumping together into a clump that is removably scoopable from other unwetted or unsoiled litter granules using a handled perforate litter scoop. Self-clumping absorbent coated substrate litter granules of the invention absorb at least one times their coating weight in water, preferably room temperature water, or urine, preferably cat body temperature urine, within one minute, i.e., sixty seconds of being wetted with the water or urine, preferably within thirty seconds, more preferably within twenty seconds of being wetted during agglomeration with other wetted litter granules into a clump composed of at least a plurality of pairs of the coated substrate litter granules. In such a preferred embodiment, each coated substrate litter granule is composed of between about 5% and about 35%, preferably between about 5% and 50%, more preferably between about 5% and 85% by granule weight of the modified starch water-absorbent clumping agent. In one such preferred embodiment and method of making coated substrate litter granules of the invention, modified starch water-absorbent clumping agent is applied onto each substrate granule until a granule coating weight of between 5% and 35%, preferably between about 5% and 50%, more preferably between about 5% and 85% by granule weight of the modified starch water-absorbent clumping agent on the substrate particle is obtained such that each finished coated substrate litter granule contains between 5% and 35%, preferably between about 5% and 50%, more preferably between about 5% and 85% by granule weight of the modified starch water-absorbent clumping agent.

The self-clumping absorbent coated substrate litter granules of a preferred self-clumping litter of the present invention each have a granule coating weight of between about 5% and about 35%, preferably between about 5% and 50%, more preferably between about 5% and 85%, by granule weight of the outer modified starch water-absorbent clumping agent on the inner substrate granule, which is a granule coating weight sufficient to produce a coating on the self-clumping coated substrate litter granules that each absorb at least one time the coated substrate litter granule's coating weight in water or urine and swell at least 25%, preferably at least 35%, more preferably at least 50%, most preferably at least 80%, in volume as the water or urine is absorbed compared to the volume of the litter granule before wetting. In a preferred embodiment, each one of the self-clumping absorbent coated substrate litter granules of the present invention have a granule coating weight of between about 5% and about 35%, preferably between about 5% and 50%, more preferably between about 5% and 85%, by granule weight of the outer modified starch water-absorbent clumping agent on the inner substrate granule, which is a granule coating weight sufficient to produce a coating on the self-clumping coated substrate litter granules that each absorb at least two times the coated substrate litter granule's coating weight in water or urine and swell at least 25%, preferably at least 35%, more preferably at least 50%, most preferably at least 80%, in volume as the water or urine is absorbed compared to the volume of the litter granule before wetting.

Each self-clumping absorbent coated substrate litter granule of the present invention preferably is a swelling and gelling self-clumping absorbent coated substrate litter granule in which the outer region of its modified starch water-absorbent clumping agent outer coating swells as it absorbs water or urine, preferably room temperature water or cat body temperature urine, wetting the granule and also substantially simultaneously forms a gel on, along and for a depth below the outer surface of the coated substrate litter granule that preferably is tacky when wetted and which can be, include, or otherwise preferably does contain a water-activated moisture curing adhesive which facilitates clumping with other contacting litter granules by its stickiness or tackiness creating adhesion therebetween that adhesively bonds the contacting granules thereto into a clump by moisture curing by the moisture evaporating from the clump as the clump dries. In one embodiment of a coated substrate litter granule of the invention, the modified starch water-absorbent clumping agent outer coating of each wetted coated substrate litter granule at least partially solubilizes in water or urine, preferably room temperature water or cat body temperature urine, forming a flowable water-activated moisture-curing adhesive with a viscosity that remains low enough, preferably no greater than 15,000 centipoise, more preferably no greater than 10,000 centipoise, even more preferably no greater than about 5,000 for a long enough period of time, preferably for at least one second after being wetted, more preferably for at least 4 seconds after being wetted, enabling it to flow from the water or urine wetted of modified starch water-absorbent clumping agent of the litter granule along and in between contacting granules and adjacent granules until the viscosity increases forming back into a tacky semisolid gel having a viscosity of at least about 30,000 centipoise, preferably at least 50,000 centipoise, more preferably at least 80,000 centipoise within 20 seconds after being wetted, preferably within 10 seconds after being wetted, more preferably within 5 seconds after being wetted. As the flowable adhesive increases in viscosity, it gels (but remains at least slightly tacky), and hardens into a glassy material having a glassy material state at room temperature as the formed clump moisture cures during drying thereby bonding together the clumped granules. These bonds can include one of hydrogen bonds and covalent bonds, preferably covalent bonds. In any event, the resultant clump formed becomes hard enough to have a clump retention rate of at least 95%, preferably at least 97%, more preferably at least 99% and a clump crush strength of at least 40 PSI, preferably at least 60 PSI, more preferably 80 PSI, even more preferably at least 100 PSI, when the clump is dried to a moisture content of about 12% (12%±1.5%) by clump weight.

Preferably, at least a portion of the modified starch water-absorbent clumping agent of each litter granule of the invention at least partially solubilizes in room temperature water or cat body temperature urine wetting the granule by contacting the granule and forms a flowable adhesive that preferably is a flowable water-activated adhesive that also is moisture curing that flows from the wetted granule outwardly therefrom along and between contacting and adjacent granules of the litter. The flowable adhesive initially is of a flowable viscosity greater than the viscosity of water that increases in viscosity over time solidifying into an adhesive gel which initially adheres contacting pellets thereto and to each other, such as by surface tension, capillarity, liquid adhesion and/or intermolecular forces, e.g., Van der Waals forces, transitions into a more viscous bonding gel as it moisture cures as it dries, more strongly adhering the contacting pellets thereto and to each other, such as preferably at least with hydrogen bonds and/or preferably at least some covalent bonds. As the initially flowable adhesive, which transitioned over time into an adhesive gel and then a bonding gel, even further moisture cures as it dries to a moisture content of less than 15%, preferably no greater than 12%, by weight, it becomes a substantially fully cured solid adhesive that is a glassy material in a glassy state adhesively bonding contacting litter granules of the litter thereto, at least with hydrogen bonds, i.e., hydrogen bonding, and/or preferably with covalent bonds, i.e., covalent bonding. Such a clump formed of at least a plurality of pairs, i.e., at least three, of the litter granules of the invention wetted with water or urine adhesively bonded together with hydrogen bonds, covalent bonds, or a combination of hydrogen bonds and covalent bonds by the solid adhesive formed from the initial flowable adhesive becoming substantially fully moisture cured into a rock hard clump with a clump moisture content of about 12% by clump weight, which has a clump crush strength of at least 40 PSI, preferably at least 60 PSI, more preferably at least 80 PSI, and even more preferably at least 100 PSI, and a clump retention rate of at least 95%, preferably at least 97%, more preferably at least about 99%.

In a preferred embodiment of the modified-starch water-absorbent clumping agent of each coated substrate litter granule of the litter of the present invention, the modified starch water absorbent clumping agent is composed of (1) a water swellable modified starch, preferably a cold water swellable modified starch, which also is water absorbent and which swells as water is absorbed, absorbing at least four and a half times, preferably at least six times the weight of the litter granule weight in room temperature water or cat body temperature urine, and (2) a water soluble modified starch binder, which preferably is a cold water soluble modified starch binder, which is at least partially cold water-soluble in room temperature water and at least partially soluble in cat body temperature urine, which forms a flowable exclusive upon becoming at least partially solubilized, flows from wetted litter granules, increases in viscosity during moisture curing into an adhesive gel which is tacky and adheres granules together with at least one of liquid adhesion, hydrogen bonding, and/or other intermolecular forces which even further increases in viscosity during further moisture curing into a bonding gel adheres granules together with at least one of hydrogen bonding and covalent bonding, and which becomes a substantially solid adhesive that is a glassy material having a glassy material state when substantially fully moisture cured to a moisture content of less than 15%, preferably no greater than 12% by weight. The water swellable modified starch, preferably cold water swellable modified starch of the modified starch water absorbent clumping agent in each litter granule is composed of native starch, such as native starch from one or more cereal grains, such as from or of one or more of corn or maize, rice, wheat, rye, barley, millet, triticale, oats, fonio, and sorghum, and/or one or more legumes, such as from or of one or more of beans, soybeans, peas, chickpeas, peanuts, lentils, lupins, mesquite, carob, tamarind, alfalfa, and/or clover, modified, preferably physically modified, so as to degrade granules of the starch and/or reduce a molecular weight of one or both of the amylose and/or amylopectin molecules of the native starch using a starch modification method or process, such as extrusion, where the native starch is processed in a starch-modifying machine, such as an extruder, preferably a single screw extruder, subjecting the native starch to an ultrahigh extrusion pressure of at least 2500 PSI, preferably at least 3000 PSI, more preferably at least 4000 PSI, even more preferably at least 5000 PSI, at an extrusion temperature of at least 100° Fahrenheit, within the extruder which modifies native starch into modified starch which is water-swellable water-absorbent modified starch, preferably cold water-swellable cold water-absorbent modified starch. The at least partially soluble, preferably at least partially cold water-soluble, modified starch binder of the modified starch water absorbent clumping agent of each litter granule also is composed of native starch, such as native starch from one or more cereal grains, such as one or more of corn or maize, rice, wheat, rye, barley, millet, triticale, oats, fonio, and sorghum, and/or one or more legumes, such as one or more of beans, soybeans, peas, chickpeas, peanuts, lentils, lupins, mesquite, carob, tamarind, alfalfa, and/or clover, which is modified, preferably physically modified, so as to degrade granules of the starch and/or reduce a molecular weight of one or both of the amylose and/or amylopectin molecules of the starch using a starch modification method or process, such as extrusion, where the native starch is processed in a starch-modifying machine, such as an extruder, preferably a single screw extruder, subjecting the native starch to an ultrahigh extrusion pressure of at least 2500 PSI, preferably at least 3000 PSI, more preferably at least 4000 PSI, even more preferably at least 5000 PSI, at an extrusion temperature of at least 100° Fahrenheit, in the extruder which modifies the native starch into modified starch which is an at least partially water soluble modified starch, preferably an at least partially cold water soluble modified starch composed of a water-activated moisture-curing binder that is activated by room temperature water and/or cat body temperature urine into a flowable adhesive having the properties and characteristics discussed hereinabove.

During making of coated substrate litter granules of the present invention, a comminuted form, preferably milled form, i.e., made by milling, of the modified-starch water-absorbent clumping agent is used that has relatively small particle sizes, smaller than even the smallest sized substrate particles, which preferably has particle sizes in the size range of a flour or powder, such as which pass through a 40-mesh screen, preferably pass through a 60-mesh screen, and even more preferably which pass through a 40-60 mesh screen and which rest upon a smaller mesh screen, such as an 80-mesh screen. In doing so, as-extruded pellets, such as made using the extrusion method above and/or as disclosed elsewhere herein, are milled using a milling machine into a powder or flour having the aforementioned mesh measurements disclosed above in this paragraph.

In one preferred embodiment and implementation of a method of making coated substrate litter granules, as-extruded pellets made in accordance with at least one of the modified starch water-absorbent clumping agent extrusion methods disclosed herein can be used as the modified starch water-absorbent clumping agent used to agglomerate with the substrate granules or particles to make a coated substrate litter in accordance with the present invention. In one such preferred embodiment and method implementation, as-extruded pellets can be mixed with water to form a slurry that is applied onto substrate granules or substrate particles in such a manner as discussed in more detail below. In another such preferred embodiment and method implementation, water can be applied onto substrate granules or substrate pellets in an agglomerator or coater, preferably a rotating or tumbling agglomerator or coater, before as-extruded pellets can be mixed therewith to agglomerate the substrate granules or substrate particles into coated substrate litter granules of the present invention in such a manner as also discussed in more detail below.

In another preferred embodiment and method implementation, as-extruded pellets are comminuted into smaller particles of modified starch water-absorbent clumping agent using a high-speed high shear mixer, such as a batch, in-line, or granulator high speed high shear mixer. In one such preferred embodiment and method implementation, as-extruded pellets are comminuted with water in such a high-speed shear mixer to form a substantially homogenous slurry of smaller sized pellet particles of modified starch water-absorbent clumping agent that is thereafter applied as a slurry onto substrate granules or substrate particles being agitated, preferably tumbled, in a rotary agglomerator or coater in such a manner as discussed in more detail below.

In yet another preferred embodiment and method implementation, the modified starch water-absorbent clumping agent is formed of a combination of powder or flour having the mesh measurements defined hereinabove and as-extruded pellets made in accordance with at least one of the modified starch water-absorbent clumping agent extrusion methods disclosed herein. In one such preferred embodiment and method implementation, a mixture of powdered or flour modified starch water-absorbent clumping agent and as-extruded pellets are homogenized into a water-containing slurry using a high-speed high shear mixer such as in the manner described hereinabove.

If desired, the modified-starch water-absorbent clumping agent can be in the form of particles of a cereal grain litter that were classified as being too small to be used in one or more of the extruded litters disclosed in in one or more of commonly owned U.S. Pat. Nos. 9,491,926, 10,028,481, 10,098,317, 10,882,238, 11,013,211, and/or 11,083,168, the entirety of each of which is hereby expressly incorporated by reference herein. Where needed, the particles of modified-starch water-absorbent clumping agent from rejected particles of extruded litter made in accordance with one or more of can be further size reduced, such as by milling, e.g. hammer milling, using another particle size reduction machine, and/or using another method of particle size reduction or particle comminution, such as the particle size reduction system, equipment and methods disclosed in commonly owned U.S. Pat. No. 11,013,211, the entirety of which is hereby expressly incorporated by reference herein.

As described in more detail herein, in a method of manufacturing self-clumping absorbent litter granules of a preferred litter in accordance with the present invention, these powder-like or flourlike relatively small particles of modified-starch water-absorbent clumping agent are wetted with an aqueous wetting liquid, such as water, thereby activating some, but not all, of the at least partially water-soluble binder in at least some, but not all, of the modified-starch water-absorbent clumping agent particles, causing at least some, but not all, of the modified-starch water-absorbent clumping agent particles to adhere while wet to the outer surface of each substrate particle and thereafter become adhesively bonded to the outer surface of each substrate particle when substantially completely moisture cured when dried, forming the inner adherence region between the inner substrate particle and the outer region of modified-starch water-absorbent clumping agent of each litter granule. The wetting of substantially all of the particles modified-starch water-absorbent clumping agent fee aqueous wetting liquid activates at least some, but not all, of the at least partially water-soluble binder of the remaining unadhered wetted particles of the modified-starch water-absorbent clumping agent causing at least some, but not all, of the modified-starch water-absorbent clumping agent particles contacting the inner adherence region to themselves to adhere while wet to the inner adherence region and thereafter become adhesively bonded thereto when substantially completely moisture cured when dried, forming one or more additional regions modified-starch water-absorbent clumping agent to each one of the litter granules being manufactured.

In one preferred litter granule manufacturing method, wetting of the modified-starch water-absorbent clumping agent particles is done by mixing dry powder-sized or flour-sized particles of the modified-starch water-absorbent clumping agent with the aqueous wetting liquid, preferably water, to form a slurry which then is applied onto the substrate particles, preferably while substantially simultaneously mixing the slurry in the substrate particles together, by tumbling, agitation or in another manner, such as by using a mixer, coater, blender, or another mixing device or arrangement causing the inner adhering region to form on the outer surface of each substrate particle before the outer region of modified-starch water-absorbent clumping agent becomes formed thereon. In another preferred litter granule manufacturing method, wetting of the modified-starch water-absorbent clumping agent particles is done indirectly by wetting the substrate particles with the aqueous liquid, preferably water, before applying the dry powder-sized or flour-sized particles of the modified-starch water-absorbent clumping agent onto the wetted substrate particles and preferably doing so while tumbling, agitating or otherwise mixing the wetted substrate particles and the applied modified-starch water-absorbent clumping agent particles causing water on the surfaces of the substrate particles to wet the modified-starch water-absorbent clumping agent particles coming into contact therewith causing the inner adhering region to form on the outer surface of each substrate particle. Preferably, one or more wetting cycles and the application cycles are performed where additional aqueous wetting liquid is applied onto the at least partially coated substrate particles during each rewetting cycle either substantially simultaneously with or substantially immediately followed by another application cycle where additional dry powder-sized or flour-sized particles of the modified-starch water-absorbent clumping agent are applied on the wetted at least partially coated substrate particles all while the tumbling, agitation or other mixing of the wetted at least partially coated substrate particles is being performed until one or more additional outer regions are added on top of the inner adhering region of each formed litter granule.

As a result of applying the aqueous wetting liquid, preferably water, onto the substrate particles at the beginning and the at least partially formed litter granules until a desirably thick coating of the modified-starch water-absorbent clumping agent particles accumulates on each substrate particle thereby forming a finished litter granule, wetting of the modified-starch water-absorbent clumping agent particles being applied on each substrate particle coalesces the modified-starch water-absorbent clumping agent particles of the outer region of each litter granules surrounding its inner substrate particle into an amorphous substantially homogeneous region of the modified-starch water-absorbent clumping agent material adhesively bonded when substantially completely moisture cured to its inner substrate particle of the finished litter granule. A preferred self-clumping absorbent granule of the present invention produced from a method of manufacture disclosed herein has an outer region of modified-starch water-absorbent clumping agent having a thickness of no greater than 1 mm, preferably no greater than 0.8 mm, and preferably no greater than about 0.5 mm, and even more preferably no greater than about 0.3 mm and having at least 50%, preferably at least 80%, more preferably at least 95%, even more preferably substantially the entire outer surface of each substrate particle of each litter granule being covered with the modified-starch water-absorbent clumping agent material. One preferred self-clumping absorbent granule of the present invention produced from a method of manufacture disclosed herein has an outer modified-starch water-absorbent clumping agent region of a thickness of between 20 microns, i.e., 0.02 mm, and 1000 microns, i.e., 1 mm, preferably between 20 microns, i.e., 0.02 mm, and 800 microns, i.e., 0.8 mm, more preferably between 20 microns, i.e., 0.02 mm, and 500 microns, i.e., 0.5 mm, and even more preferably between 20 microns, i.e., 0.02 mm, and 300 microns, i.e., 0.3 mm with at least 50%, preferably at least 80%, more preferably at least 95%, and even more preferably substantially the entire outer surface of each substrate particle of each litter granule covered with the modified-starch water-absorbent clumping agent material.

In a preferred embodiment, the rounded coated substrate litter granules are advantageously of a size that minimizes tracking of litter from the litter box during use and operation of the coated substrate litter of the present invention. The roundedness of the coated substrate litter granules advantageously helps prevent coated substrate litter granules from getting entrapped in a cat's paw during litter box use. In addition, the coated substrate litter granules are of a size that also helps prevent tracking by a cat from a litter box during litter box use by the cat. In a preferred embodiment, the coated substrate litter granules need to have a size bigger than a 25-mesh screen, i.e., larger than 25 mesh, but no bigger than a 10-mesh screen, i.e., no bigger than 10 mesh. At least 80% of the coated substrate litter granules should be smaller in size than 10 mesh and be bigger than 25 mesh (10/25). For example, in one embodiment, between 60% and 95%, and preferably at least about 80% (80%±15%), of the granules pass through a 12-mesh screen but are larger than a 25-mesh screen. The remainder of the coated substrate litter granules will be bigger than 10 mesh. Having rounded coated substrate litter granules with a particle size distribution of between 12 mesh and 20 mesh (12/20) provides the best feel for a cat's paw.

Therefore, in one preferred coated substrate cat litter embodiment, the coated substrate litter granules are generally rounded, have upraised projections, including spikes, and have a particle size distribution of between 12 mesh and 20 mesh (12/20) to produce a preferred embodiment of a low track litter in accordance with the present invention that minimizes tracking by a cat from a litter box. In another preferred coated substrate cat litter embodiment, the coated substrate litter granules are generally rounded, have upraised projections, including spikes, and have a particle size distribution of between 10 mesh and 25 mesh (10/25) to produce another preferred embodiment of a low track litter in accordance with the present invention that minimizes tracking by a cat from a litter box.

In a method of applying modified-starch water-absorbent clumping agent onto substrate particles to make self-clumping absorbent coated substrate litter granules of the present invention, depending on the type and size of the substrate particles, an amount of slurry containing a predetermined amount, e.g., predetermined weight or mass, of particles of modified-starch water-absorbent clumping agent is applied for a given amount, e.g., given weight or mass, of the substrate particles, with the respective predetermined amount of modified-starch water-absorbent clumping agent slurried in water selected based on the size or size range and given amount of the substrate particles to be coated and turned into self-clumping absorbent granules of the invention. In a preferred method of making self-clumping absorbent litter granules of the invention using a slurry of water and particles of modified-starch water-absorbent clumping agent, the slurry is applied onto substrate granules or substrate particles being tumbled in a rotating barrel or drum of a drum mixer, cement mixer, drum coater or the like using one or more spaced apart spray heads, nozzles, misters, or another type of slurry applicator or slurry dispenser that is configured or operated to controllably discharge the slurry onto the substrate particles in the rotating mixer or coater barrel in making self-clumping absorbent litter granules of the present invention. In another preferred method of applying modified starch water-absorbent clumping agent onto substrate granules or substrate particles to make self-clumping absorbent coated substrate litter granules of the present invention, the substrate particles are wetted with an aqueous wetting liquid, such as water, and dry particles of the modified starch water-absorbent clumping agent are applied while the substrate particles, modified starch water-absorbent clumping agent particles, and aqueous wetting liquid, preferably water, while initially the substrate particles and then the substrate particles, modified starch water-absorbent clumping agent particles, and aqueous wetting liquid, preferably water, are tumbled or otherwise agitated, such as preferably in a rotating barrel of a drum mixer, cement mixer, drum coater or the like to mix everything together. One or more cycles of wetting by application of aqueous wetting liquid, preferably water, onto the at least partially coated substrate particles followed by application of particles of modified starch water-absorbent clumping agent is performed as needed until each substrate particle has a desired amount of granule coating weight, e.g., coverage, and/or outer region thickness of modified starch water-absorbent clumping agent is achieved producing finished self-clumping absorbent litter granules of the present invention. Thereafter, the at least partially moist finished self-clumping absorbent litter granules are subjected to a moisture curing step that preferably is a moisture removal step, such as by drying the at least partially moist finished litter granules using convective drying with flowing air, preferably turbulently flowing air, directed at the litter granules, drying in a heated oven using one or more of radiant heat, convective drying with heated air, or another type of heated drying method, until moisture curing is complete or substantially complete in each one of the litter granules upon drying each granule to a moisture content of no greater than 12%, preferably greater than 10% and more preferably no greater than 8% by litter granule weight.

Where a slurry is used in making self-clumping absorbent coated substrate litter granules of the invention, the slurry is a slurry of water and relatively small particles of modified-starch water-absorbent clumping agent, preferably having the size of a powder or flour, whereby the modified-starch water-absorbent clumping agent particles are mixed with the water until a substantially uniform mixture or slurry is formed. As previously noted, mixing can be done using a high-speed high shear mixer. In a preferred slurry, the ratio of the amount of modified-starch water-absorbent clumping agent to water, when water is used as the aqueous wetting liquid, is about 1:1±10% by weight. The slurry is applied onto substrate granules or substrate particles while the substrate particles are being agitated, tumbled, or otherwise mixed, such as in a rotating barrel, drum or chamber of a mixer, coater or blender, thereby causing a region of modified-starch water-absorbent clumping agent to build up on each one of the substrate particles until a desired region thickness or a desired granule coating weight of the modified-starch water-absorbent clumping agent on the substrate particles is reached. Tumbling in a rotating barrel or drum type mixer or coater is preferred because it also ensures that the resultant coated substrate litter granule produced are rounded in the manner discussed above to minimize tracking from a litter box. The water in the slurry activates at least some, but not all, of the water-soluble modified starch binder, preferably cold water-soluble modified starch binder, in the modified-starch water-absorbent clumping agent particles in the slurry producing tacky gel(s) and flowable adhesive(s) which adheres modified-starch water-absorbent clumping agent particles to the substrate particles onto which the slurry is applied. This tackiness helps ensure the formation of upraised projections, including spikes, in the outer surface of the coated substrate granule which thereby enhances the amount and speed of water absorption during litter use. The slurry is applied onto the substrate particles while they are being agitated, tumbled, or mixed to not only facilitate more uniform adherence of modified-starch water-absorbent clumping agent particles to each substrate particle, but also to help prevent the at least partially coated substrate particles from agglomerating during slurry-based self-clumping absorbent litter granule manufacture. The slurry is applied on the substrate particles while they are being tumbled, agitated and/or mixed therewith until a desired thickness or granule coating weight of the modified-starch water-absorbent clumping agent particles on the substrate particles is reached. In a preferred method implementation, initial application of the slurry onto the substrate particles causes each one of the substrate particles to act as a litter granule nucleator causing modified-starch water-absorbent clumping agent in the slurry to adhere to the outer surface of each substrate particle forming an inner adhering region whose aqueous wetness more rapidly facilitates adherence of another outer region of modified-starch water-absorbent clumping agent.

In a preferred slurry application method, depending on the type and size of the substrate particles, an amount of slurry containing a predetermined amount, e.g., predetermined weight or mass, of particles of modified-starch water-absorbent clumping agent is applied for a given amount, e.g., given weight or mass, of the substrate particles, with the respective predetermined amount of modified-starch water-absorbent clumping agent slurried in water selected based on the size or size range and given amount of the substrate particles to be coated and turned into self-clumping absorbent granules of the invention. In a preferred method of making self-clumping absorbent litter granules of the invention using a slurry of water and particles of modified-starch water-absorbent clumping agent, the slurry is applied onto substrate particles being tumbled in a rotating barrel or drum of a drum mixer, cement mixer, drum coater or the like using one or more spaced apart spray heads, nozzles, misters, or another type of slurry applicator or slurry dispenser that is configured or operated to controllably discharge the slurry onto the substrate particles in the rotating mixer or coater barrel in making self-clumping absorbent litter granules of the present invention.

In a preferred slurry application method implementation, the amount and preferably the rate, such as the volumetric rate or metering, of application of the slurry onto the substrate particles is varied in real time during application of the slurry onto the substrate particles in order to (a) control amount of granule coating weight coverage and/or thickness of the modified-starch water-absorbent clumping agent that forms an outer region around each substrate particle, and (b) prevent substrate particles at least partially covered with a region of the modified-starch water-absorbent clumping agent from agglomerating while being tumbled, agitated or otherwise mixed. The ratio of the amount of modified-starch water-absorbent clumping agent to water can also be controllably regulated or varied in real time by as much as ±25%, such as 1:1 up to +25% or 1:1 down to −25%, during application of the slurry onto the substrate particles to control (a) water activation of the at least partially soluble modified starch binder, (b) the rate of granule coating weight coverage of modified-starch water-absorbent clumping agent that adheres and/or covers each one of the substrate particles, (c) the amount of granule coating weight coverage of modified-starch water-absorbent clumping agent that adheres and/or covers each one of the substrate particles, (d) the thickness of the outer region of the modified-starch water-absorbent clumping agent that adheres and/or covers each one of the substrate particles during making of litter granules of the present invention, (e) the viscosity of the slurry, and/or (f) prevent agglomeration of partially coated or partially formed litter granules while being tumbled, agitated or otherwise mixed.

In one preferred method implementation, the slurry formed can be and preferably is in the form of (a) a suspension composed of an aqueous wetting liquid, preferably water, and dry particles of modified-starch water-absorbent clumping agent mixed together, such as by using a high shear mixer, another suitable type of blender, or another suitable type of mixer, until the suspension is formed, or (b) an emulsion composed of the aqueous wetting liquid, preferably water, and dry particles of modified-starch water-absorbent clumping agent mixed together, such as by using a high shear mixer, another suitable type of blender, or another suitable type of mixer, until the suspension is formed. Where a slurry is used that is in the form of such an suspension, the suspension can include one or more surfactants, including one or more super surfactants, to facilitate suspension of dry powder sized or flour sized particles of modified-starch water-absorbent clumping agent in the aqueous wetting liquid, preferably water, during a slurry suspension mixing step where all of the constituents of the suspension are mixed together. Where a slurry is used that is in the form of such an emulsion, the emulsion can include (1) one or more surfactants, including one or more super surfactants, and/or (2) one or more emulsifiers to emulsify or facilitate emulsion all of the dry powder sized or flour sized particles of modified-starch water-absorbent clumping agent in the aqueous wetting liquid, preferably water, during a slurry emulsion mixing step where all of the constituents of the emulsion are mixed together. At least one of the viscosity, rate of modified-starch water-absorbent clumping agent coating thickness buildup, the amount of modified-starch water-absorbent clumping agent coating thickness, and/or the granule coating weight of modified-starch water-absorbent clumping agent on each substrate particle can be controlled during application of the slurry onto the substrate particles by controlling the ratio of water to modified-starch water-absorbent clumping agent in the slurry suspension or emulsion preferably in real time during application of the slurry suspension or emulsion onto the substrate particles. Such a slurry suspension or emulsion, preferably is a substantially homogenous suspension or emulsion of particles of modified-starch water-absorbent clumping agent suspended or emulsified in water, is applied onto substrate particles while the substrate particles are being agitated, tumbled or otherwise mixed thereby causing a region of modified-starch water-absorbent clumping agent to build up on an outer surface of each one of the substrate particles until a desired region thickness or a desired granule coating weight of the modified-starch water-absorbent clumping agent on the substrate particles is reached. The water in the slurry activates at least some, but not all, of the water-soluble modified starch binder, preferably cold water-soluble modified starch binder, in the modified-starch water-absorbent clumping agent particles in the slurry producing tacky gel(s) and flowable adhesive(s) which adheres the modified-starch water-absorbent clumping agent in the suspension or emulsion to the substrate particles onto which the slurry suspension or emulsion is applied. The slurry suspension or emulsion is applied onto the substrate particles while they are being agitated, tumbled or mixed not only to facilitate more uniform adherence of modified-starch water-absorbent clumping agent to each substrate particle, but also to help prevent the at least partially coated substrate particles/partially finished litter granules from agglomerating during application of the slurry suspension or emulsion while being tumbled, agitated or otherwise mixed during slurry-based self-clumping absorbent litter granule manufacture.

The slurry, slurry suspension, or slurry emulsion is applied on the substrate particles while they are being tumbled, agitated and/or mixed therewith until a desired thickness or granule coating weight of the modified-starch water-absorbent clumping agent particles on the substrate particles is reached thereby producing self-clumping absorbent litter granules of the present invention. Thereafter, the moisture of the finished litter granules is reduced to moisture cure the at least partially soluble modified starch binder which was activated during slurry application and formed a flowable adhesive and gel adhering one or more outer regions of the modified-starch water-absorbent clumping agent to each substrate particle. The moisture of the finished litter granules is reduced to a moisture content of no greater than 12%, preferably no greater than 10% and more preferably no greater than about 8% by finished litter granule weight to substantially completely moisture cure the water-activated at least partially soluble modified starch binder, flowable adhesive and gel into a solid adhesive in a glassy material state adhesively bonding the outer region of modified-starch water-absorbent clumping agent to each inner substrate particle. At least a portion of the at least partially soluble modified starch binder in the outer region of modified-starch water-absorbent clumping agent of each finished self-clumping absorbent litter granule of the present invention remains un-activated and/or uncured thereby ready to be wetted with water, such as room temperature water, or urine, such as urine at cat body temperature, and at least partially solubilize into flowable adhesive that flows from the wetted litter granules long and in between contacting litter granules and litter granules adjacent thereto increasing in viscosity during initial moisture curing into an adhesive or adherent gel which transitions into a bonding gel as further moisture curing occurs which finally transition into a solid adhesive in a glassy starch state that bonds the contacting litter granules and adjacent litter granules together into a clump that becomes substantially rock hard when moisture curing due to moisture evaporation, clump is complete. Moisture curing of the clump preferably is complete when moisture content of the clump is no greater than about 12% by clump weight, due to moisture evaporation from the clump during drying of the clump, such as air drying of the clump in the litter box, producing a substantially rock hard clump having a clump retention rate of at least 95%, preferably at least 97%, more preferably at least 99% and/or a clump cross strength of at least 40 PSI, preferably 60 PSI, more preferably 80 PSI, and even more preferably 100 PSI when fully moisture cured.

The substrate granules or substrate particles can be organic, inorganic, smooth, rough, round, cylindrical, irregularly shaped, porous, non-porous, water absorbent, impervious to water, smooth, and/or rough, and preferably non-clumping, i.e., composed of a material whose particles do not agglomerate into clumps when the particles are wetted with water. Preferred substrate materials include nut shells or hulls, wood, paper, sand, perlite, and bentonite crushed, ground, milled or otherwise comminuted into relatively small sized substrate particles at least partially coated with a modified-starch water-absorbent clumping agent preferably in the form of a starch-based water-absorbent clump-facilitating material to form the self-clumping litter granules of the invention having an outer region of the modified-starch water-absorbent clumping agent at least partially covering and preferably substantially completely encapsulating each one of the substrate particles. The modified-starch water-absorbent clumping agent, preferably in the form of a starch-based water-absorbent clump facilitating material, which more preferably is a swelling and gelling material composed of modified starches configured by starch modification, preferably by extrusion, more preferably by ultrahigh pressure extrusion using a single screw extruder, to rapidly swell and absorb water and gel while doing so and which preferably also contains at least some previously native or unmodified starch modified into an at least partially water-soluble binder that at least partially solubilizes and flows upon water-wetting forming a flowable adhesive that adheres the swelling and gelling material to the substrate particles during manufacture of the litter granules. A preferred modified-starch water-absorbent clumping agent in the preferred form of a starch-based water-absorbent clump facilitating material more preferably is a starch-based sorbent swelling biopolymeric gellant, e.g., comprised of a gelling biopolymer or biopolymer which gels, preferably forms a gel, upon wetting, and is composed of a cold-water soluble extrusion-modified starch binder and a cold-water swellable extrusion-modified sorbent starch which preferably is or includes a cold-water swellable extrusion-modified cold water absorbent starch comminuted or otherwise particle sized reduced into the form of a flour or powder that coats the substrate particles when wetted. If desired, the powder or flour particles of such a modified-starch water-absorbent clumping agent are rejected or unused pellets or particles of an extruded cereal grain litter that were classified as being too small to be used in one or more of the litters disclosed in in one or more of commonly owned U.S. Pat. Nos. 9,491,926, 10,028,481, 10,098,317, 10,882,238, 11,013,211, and/or 11,083,168, the disclosure of each of which is expressly incorporated by reference herein. The resultant litter granules form a removably clumpable litter of the present invention as each granule has an outer self-clumping water-absorbent region surrounding an inner substrate particle whereby the outer region rapidly absorbs and swells upon contact with water with at least some of the outer region at least partially solubilizing and forming a flowable adhesive that flows therefrom along and in between contacting and adjacent litter granules and which also gels during agglomeration of the wetted litter granules into a clump thereof that is scoopable from the litter.

In a method of making self-clumping coated substrate litter granules of the present invention, a desired or predetermined amount of substrate particles having particle sizes falling within a desired particle size range or particle size distribution can be (a)(1) wetted with water while being agitated, (2) mixed with a modified-starch water-absorbent clumping agent that preferably is in the form of the starch-based water-absorbent clump facilitating flour or powder while continuing to be agitated while water is wetting outer surfaces of the substrate particles causing (i) some, but not all, of its water-soluble binder to at least partially solubilize and form flowable adhesive causing the starch-based water-absorbent clump facilitating flour or powder to adhere to the outer surfaces of the substrate particles, and (ii) gelling of some, but not all, of at least a plurality, preferably at least a plurality of pairs, i.e., at least three, of different types of modified starches in the starch-based water-absorbent clump facilitating flour or powder which thereby coalesces the wetted flour or powder particles together into an amorphous substantially homogenous mass of starch-based water-absorbent clump facilitating material around each of the substrate particles that forms the outer region thereon producing finished litter granules of the invention, which are then dried, such as with turbulently flowing air, heated air, and/or radiant heat directed towards and/or against the finished litter granules. Drying is done to reduce the moisture content of the still moist finished litter granules until each litter granules has less than 12%, preferably less than 10%, more preferably no more than 8% moisture content by granule weight. Moisture reduction is done to moisture cure the water soluble adhesive into a solid adhesive bonding the outer region starch-based water-absorbent clump facilitating material to the outer surface of each inner substrate particle as well as to prevent water activation and/or further moisture curing of at least some of the at least partially soluble binder of each finished litter granule, preferably by preventing retrogradation thereof, so that at least some water-activatable at least partially soluble binder in each granule remains available to clump granules together when wetted with water or urine.

The moisture removal step, preferably drying step, can be and preferably is performed while the newly finished still moist granules continue to be mixed, e.g., agitated, to cure the binder adhesively attaching the outer self-clumping water-absorbent region to the inner substrate particle while simultaneously preventing water-activation of binder within the portion of the outer region of the starch-based water-absorbent clump facilitating material not adhesively bonding the outer region to the outer surface of each substrate particle. The moisture removal step, preferably drying step, can be and preferably is performed while partially coated litter granules, e.g., partially finished litter granules, are being wetted and/or rewetted, including while further applications of the dry starch-based water-absorbent clump facilitating flour or powder material are performed while everything is being mixed, e.g., activated, such as in a barrel or drum of a mixer. While the moisture removable step, e.g., drying step, can be performed while the substrate particles are being coated with a slurry of the starch-based water-absorbent clump facilitating flour or powder and water, including during mixing of everything together, the moisture removable step preferably is performed after completion of the slurry application step.

In a preferred coated substrate litter and coated substrate litter granule embodiment, the modified-starch water-absorbent clumping agent is in the form of a starch-based water-absorbent clump facilitating flour or powder which is comprised of at least a plurality, preferably at least a plurality of pairs, i.e., at least three, of different types of modified starches, which each different type of modified starch having a molecular weight that is different, preferably less, than the unmodified or native starch from which the corresponding modified starch is formed. Each one of the different types of modified starches are formed from unmodified or native starches, such as preferably unmodified amylose starch and amylopectin starch, in one or more cereal grains and/or legumes in a cereal grain and/or legume containing admixture where the unmodified or native starches in the admixture are modified during extrusion using a single screw extruder at an ultrahigh extrusion pressure of at least 2500 PSI, preferably at least 3000 PSI, more preferably at least 4000 PSI, and even more preferably at least 5000 PSI, which modifies the unmodified or native starches to produce modified-starch water-absorbent clumping agent in the form of the starch-based water-absorbent clump facilitating material extrudate that is used in flour or powdered form in making self-clumping absorbent litter granules of the litter of the present invention.

A substrate water wetting method of making coated substrate litter granules of the invention involves wetting the substrate particles before applying the modified-starch water-absorbent clumping agent, preferably in the form of the starch-based water-absorbent clump facilitating flour or powder, with a greater amount of water used than the amount of modified-starch water-absorbent clumping agent flour or powder used, preferably starch-based water-absorbent clump facilitating flour or powder used. Water is added until the substrate granules or substrate particles begin agglomerate rating onto themselves to achieve proper wetting before adding any modified-starch water-absorbent clumping agent, whether it be in powder or flour form, the form of extruded pellets, or in the form of comminuted extruded pellets, e.g., comminuted using a high-speed high shear mixer.

In one method implementation, a ratio of between 6:1 and 10:1, preferably between 7:1 and 9:1, more preferably about 8:1 of water to modified-starch water-absorbent clumping agent flour or powder, preferably starch-based water-absorbent clump facilitating flour or powder, is used during the application step to coat the substrate granules or substrate particles with the modified-starch water-absorbent clumping agent flour or powder, preferably starch-based water-absorbent clump facilitating flour or powder. In carrying out the substrate water wetting method, a plurality of cycles of wetting the substrate, applying dry modified-starch water-absorbent clumping agent flour or powder, preferably dry starch-based water-absorbent clump facilitating flour or powder, to each one of the wetted substrate particles, wetting or rewetting the mixture thereof with additional water, applying more dry modified-starch water-absorbent clumping agent flour or powder, preferably dry starch-based water-absorbent clump facilitating flour or powder, to the at least partially coated wetted substrate granules or substrate particles are performed while the substrate granules or substrate particles and modified-starch water-absorbent clumping agent flour or powder, preferably starch-based water-absorbent clump facilitating flour or powder, are continuously mixed by tumbling, rolling, or another form of agitation preferably in a rotating barrel or rotating drum of a drum coater, cement mixer, drum mixer, mixing blender, or the like.

The slurry method uses much less water in comparison to the amount of particulate modified-starch water-absorbent clumping agent, preferably in the form of starch-based water-absorbent clumping agent flour or powder, preferably using between 0.5:1 to 2:1 and more preferably about 1:1 of water to particulate modified-starch water-absorbent clumping agent, preferably starch-based water-absorbent clump facilitating flour or powder, mixed together before applying the slurry onto the substrate particles and preferably mixing everything together. Mixing preferably is performed by tumbling in a mixer, e.g., pin mixer, drum coater, cement mixer, blender, e.g., ribbon blender, or using another type of mixing or blending device. In a preferred method implementation, a continuous slurry process is employed where the water and particulate modified-starch water-absorbent clumping agent, preferably in the form of starch-based water-absorbent clump facilitating flour or powder, are mixed and stored in a tank, vat or other vessel from which the slurry can be substantially continuously pumped to one or more misters, sprayers, nozzles, dispensers or other applicators that discharge the slurry onto the substrate particles while they are in a rotating drum, in a rotating barrel, or being carried on a conveyor while the substrate particles pass underneath the misters, sprayers, nozzles, dispensers or applicators in a continuous application process that preferably is a continuous flow application process. In another preferred method implementation, the slurry can be applied, such as using a mister, sprayer, nozzle, dispenser or other applicator, to substrate particles being agitated, tumbled, or otherwise mixed together, such as in a drum coater, drum mixer, concrete mixer, pin mixer, ribbon blender or other type of suitable blender or mixer to more uniformly coat the particles with particulate modified-starch water-absorbent clumping agent, preferably starch-based water-absorbent clump facilitating flour or powder, in or from the slurry advantageously producing self-clumping sorbent litter granules of the invention having a substantially homogenous outer region of modified-starch water-absorbent clumping agent, preferably starch-based water-absorbent clump facilitating material, of substantially the same thickness from litter granule to litter granule substantially completely encapsulating each one of the substrate particles therewith. Tumbling, rolling or otherwise agitating the particles during the modified-starch water-absorbent clumping agent application process, preferably starch-based water-absorbent clump facilitating material application process preferably in a rotating generally cylindrical or barrel or drum of coater, mixer or the like builds up an outer region of the modified-starch water-absorbent clumping agent, preferably starch-based water-absorbent clump facilitating material, which fills in any pockets and voids in the outer surface of the substrate particles also smoothing over other substrate particle surface irregularities advantageously producing a litter granule having a substantially smooth rounded exterior surface that does not hurt the paws of cats who have been declawed and is non-tracking is the smooth rounded granules are not readily picked up on cat's paws and tracked outside the litterbox onto areas of the floor outside the litterbox. Where the substrate particles are generally round, such as where substrate particles of paper, i.e., paper balls, are used, the resultant self-clumping, absorbent litter granules of the present invention which are produced each have an outer region of the modified-starch water-absorbent clumping agent, preferably starch-based water-absorbent clump facilitating material that is substantially smooth, which is rounded, and preferably produces litter granules that are substantially round and/or generally spherical, e.g., self-clumping absorbent litter granule balls of the present invention.

As previously noted, the rounded coated substrate litter granules are advantageously of a size that minimizes tracking of litter from the litter box during use and operation of the coated substrate litter of the present invention. The roundedness of the coated substrate litter granules advantageously helps prevent coated substrate litter granules from getting entrapped in a cat's paw during litter box use. In addition, the coated substrate litter granules are of a size that also helps prevent tracking by a cat from a litter box during litter box use by the cat. In a preferred embodiment, the coated substrate litter granules need to have a size bigger than a 25-mesh screen, i.e., larger than 25 mesh, but no bigger than a 10-mesh screen, i.e., no bigger than 10 mesh. At least 80% of the coated substrate litter granules should be smaller in size than 10 mesh and be bigger than 25 mesh (10/25). For example, in one embodiment, between 60% and 95%, and preferably at least about 80% (80%±15%), of the granules pass through a 12-mesh screen but are larger than a 25-mesh screen. The remainder of the coated substrate litter granules will be bigger than 10 mesh. Having rounded coated substrate litter granules with a particle size distribution of between 12 mesh and 20 mesh (12/20) provides the best feel for a cat's paw.

Therefore, in one preferred coated substrate cat litter embodiment, the coated substrate litter granules are generally rounded, have upraised projections, including spikes, and have a particle size distribution of between 12 mesh and 20 mesh (12/20) to produce a preferred embodiment of a low track litter in accordance with the present invention that minimizes tracking by a cat from a litter box. In another preferred coated substrate cat litter embodiment, the coated substrate litter granules are generally rounded, have upraised projections, including spikes, and have a particle size distribution of between 10 mesh and 25 mesh (10/25) to produce another preferred embodiment of a low track litter in accordance with the present invention that minimizes tracking by a cat from a litter box.

In a method of making self-clumping sorbent litter in accordance with the present invention, at least a plurality of different types, preferably at least a plurality of pairs of, i.e., at least three, different types of substrate particles are substantially simultaneously coated with an outer region of the modified-starch water-absorbent clumping agent during making of a batch of a litter of the present invention composed of self-clumping litter granules of the invention with at least a plurality of different types of substrate particles, preferably at least a plurality of pairs of i.e. at least three, different types of substrate particles. In one such method, at least one type of substrate particle is an organic substrate particle that is lower density than other type of inorganic substrate particle, preferably a functional substrate particle, whereby both types of substrate particles are substantially simultaneously coated or covered with particulate modified-starch water-absorbent clumping agent using either the slurry or the aqueous wetting liquid wetting and re-wetting litter granule manufacturing method.

In a preferred embodiment, the modified-starch water-absorbent clumping agent preferably is a starch-based water-absorbent clump facilitating material which is made by extruding a starch-based admixture, such as the aforementioned admixture containing one or more cereal grains and/or one or more legumes, from an extruder at a relatively low moisture content of no more than about 25% by weight at an ultrahigh extruder pressure of at least 2500 PSI, preferably at least 3000 PSI, more preferably at least 4000 PSI, and even more preferably 5000 PSI thereby extruding a modified-starch water-absorbent clumping agent preferably in the form of a starch-based water-absorbent clump facilitating material that more preferably is or comprises a starch-based sorbent swelling biopolymeric gellant containing modified starches modified in the extruder by ultrahigh extrusion pressure that swells and gels upon sorption, including absorption, of a liquid, such as an aqueous liquid, such as water at room temperature, or an aqueous solution, such as urine at the temperature of the body of a cat, which preferably is comprised of at least some of the starch in the admixture ultrahigh pressure extrusion modified into a cold water soluble binder and at least some of the other starch in the admixture ultrahigh pressure extrusion modified into a cold water swellable water absorbent modified starch. In one preferred litter granule embodiment and litter granule making method, waste fines from a process of making an absorbent starch-based litter, such as the extruded cereal-grain based litters disclosed in one or more of commonly owned U.S. Pat. Nos. 9,491,926, 10,028,481, 10,098,317, 10,882,238, 11,013,211, and/or 11,083,168, the entirety of each of which is expressly incorporated by reference herein, are either used as the particulate modified-starch water-absorbent clumping agent starch-based, preferably particulate water-absorbent clump facilitating material, which is applied directly or in a slurry onto the substrate particles or are ground, milled, comminuted or otherwise particle size reduced into even smaller flour or powder sized particles having the mesh sizes and/or mesh size ranges in accordance with those discussed elsewhere herein that are applied or slurried onto the substrate particles. Where the particulate modified-starch water-absorbent clumping agent, preferably in the form of starch-based water-absorbent clump facilitating particulate material, more preferably comprised of starch-based sorbent swelling biopolymeric gellant, is used in powder sized particulate form, the powder-sized particles preferably have a particle size smaller than 1,000 μm and preferably is composed of particles ranging in size from between 100 μm and 400 μm. Where the particulate modified-starch water-absorbent clumping agent, preferably in the form of starch-based water-absorbent clump facilitating particulate material, more preferably comprised of starch-based sorbent swelling biopolymeric gellant, is used in flour sized particulate form, the flour-sized particles preferably have particle sizes that pass through a 40-mesh screen, preferably pass through a 60-mesh screen, and even more preferably which pass through a 40-60 mesh screen and which rest upon an 80-mesh screen. Such extremely small particle sizes enable rapid wetting and activation of water-soluble binder in some of the particles but not all the water-soluble binder in the particles contacting and being applied onto the larger substrate particles.

The end result produces substantially instantly self-clumping, water-absorbent litter granules which are not friable, which minimizes dust creation during storage, packaging, shipment and actual litter use, which preferably reduce dust by attracting dust particles causing them to adhere thereto, which has a rounded granule shape to minimize cat tracking the litter granules out of the litter box, which has a smooth rounded exterior which do not hurt paws of de-clawed cats, and which forms a clump having a clump retention rate of at least 95%, preferably at least 97%, more preferably at least 99% which means the clump retains at least 95%, preferably at least 97%, more preferably at least 99% of its weight or mass, when a clump formed of litter granules wetted with 10 milliliters of water or urine and dried to a moisture content of about 12% by clump weight, is drop tested from a height of about ten inches onto a perforate mesh screen. In another preferred embodiment, each clump has a clump retention rate of at least 95%, preferably at least 97%, more preferably at least 99%, which means the clump retains at least 95%, preferably at least 97%, more preferably at least 99% of its weight or mass, when such a clump formed of litter granules wetted with 15 milliliters of water or urine and dried to a moisture content of about 12%, is drop tested from a height of about ten inches onto a mesh screen. In yet another preferred embodiment, each clump has a clump retention rate of at least 95%, preferably at least 97%, more preferably at least 99%, which means the clump retains at least 95%, preferably at least 97%, more preferably at least 99% of its weight or mass, when such a clump formed of litter granules wetted with 10 milliliters of water or urine and dried to a moisture content of about 12%, is drop tested from a height of about twelve inches onto the mesh screen. In still yet another preferred embodiment, each clump has a clump retention rate of at least 95%, preferably at least 97%, more preferably at least 99%, which means the clump retains at least 95%, preferably at least 97%, more preferably at least 99% of its weight or mass, when such a clump formed of litter granules wetted with 15 milliliters of water or urine and dried to a moisture content of about 12%, is drop tested from a height of about twelve inches onto the mesh screen. Each such clump dried to a moisture content of about 12% also has a clump crush strength of at least 40 PSI, preferably at least 60 PSI, more preferably 80 PSI and even more preferably 100 PSI.

In another preferred litter granule embodiment and manufacturing method, the outer region of each litter granule surrounding the inner substrate particle is composed of modified-starch water-absorbent clumping agent formed by or during ultrahigh pressure extrusion as discussed elsewhere herein that is comprised of at least one of (a) an at least partially water soluble water-activated moisture-curing modified starch binder, which is or comprises a thermoplastic modified starch component, which can be repeatedly wetted and dried and still retain its water-soluble binder and/or water-activated moisture curing adhesive properties, and (b) a one-shot at least partially water soluble water-activated moisture-curing modified starch binder, which is or comprises a thermoset modified starch component or thermosetting modified starch component whose adhesive, such as a gel or flowable adhesive, formed upon being wetted with water or urine is water activated a single time and moisture cures a single time as it dries such that it irreversibly moisture cures as it dries to a moisture content of no greater than 15%, preferably about 12% by weight, preferably clump weight, upon a clump the litter granules of the invention being formed and dried. The original folding of one or more of the proteins in the starch containing admixture is modified during ultrahigh pressure extrusion resulting from forces exhibited thereon during ultrahigh pressure extrusion due to the extrusion temperature, ultrahigh extrusion pressure and the shear forces exhibited thereon during extrusion forming proteins whose folding is modified in a manner that causes crosslinking of some of the extrusion modified starch, such as extrusion modified amylopectin and/or extrusion modified amylose, thereby forming an at least partially water soluble water-activated and moisture cured thermoplastic binder that is reversible in that rewetting, re-solubilization, flowable adhesive creation, gelling, and moisture-curing by drying can be done repeatedly, preferably indefinitely repeatedly.

The end result also produces substantially instantly self-clumping, water-absorbent litter granules which are not friable, which minimizes dust creation during storage, packaging, shipment and actual litter use, which preferably reduce dust by attracting dust particles causing them to adhere thereto, which has a rounded granule shape to minimize cat tracking the litter granules out of the litter box, which has a smooth rounded exterior which do not hurt paws of de-clawed cats, and which forms a clump having a clump retention rate of at least 95%, preferably at least 97%, more preferably at least 99% which means the clump retains at least 95%, preferably at least 97%, more preferably at least 99% of its weight or mass, when a clump formed of litter granules wetted with 10 milliliters of water or urine and dried to a moisture content of about 12% by clump weight, is drop tested from a height of about ten inches onto a perforate mesh screen. In another preferred embodiment, each clump has a clump retention rate of at least 95%, preferably at least 97%, more preferably at least 99%, which means the clump retains at least 95%, preferably at least 97%, more preferably at least 99% of its weight or mass, when such a clump formed of litter granules wetted with 15 milliliters of water or urine and dried to a moisture content of about 12%, is drop tested from a height of about ten inches onto a mesh screen. In yet another preferred embodiment, each clump has a clump retention rate of at least 95%, preferably at least 97%, more preferably at least 99%, which means the clump retains at least 95%, preferably at least 97%, more preferably at least 99% of its weight or mass, when such a clump formed of litter granules wetted with 10 milliliters of water or urine and dried to a moisture content of about 12%, is drop tested from a height of about twelve inches onto the mesh screen. In still yet another preferred embodiment, each clump has a clump retention rate of at least 95%, preferably at least 97%, more preferably at least 99%, which means the clump retains at least 95%, preferably at least 97%, more preferably at least 99% of its weight or mass, when such a clump formed of litter granules wetted with 15 milliliters of water or urine and dried to a moisture content of about 12%, is drop tested from a height of about twelve inches onto the mesh screen. Each such clump dried to a moisture content of about 12% also has a clump crush strength of at least 40 PSI, preferably at least 60 PSI, more preferably 80 PSI and even more preferably 100 PSI.

### Self-Clumping Coated Substrate Litter Granule

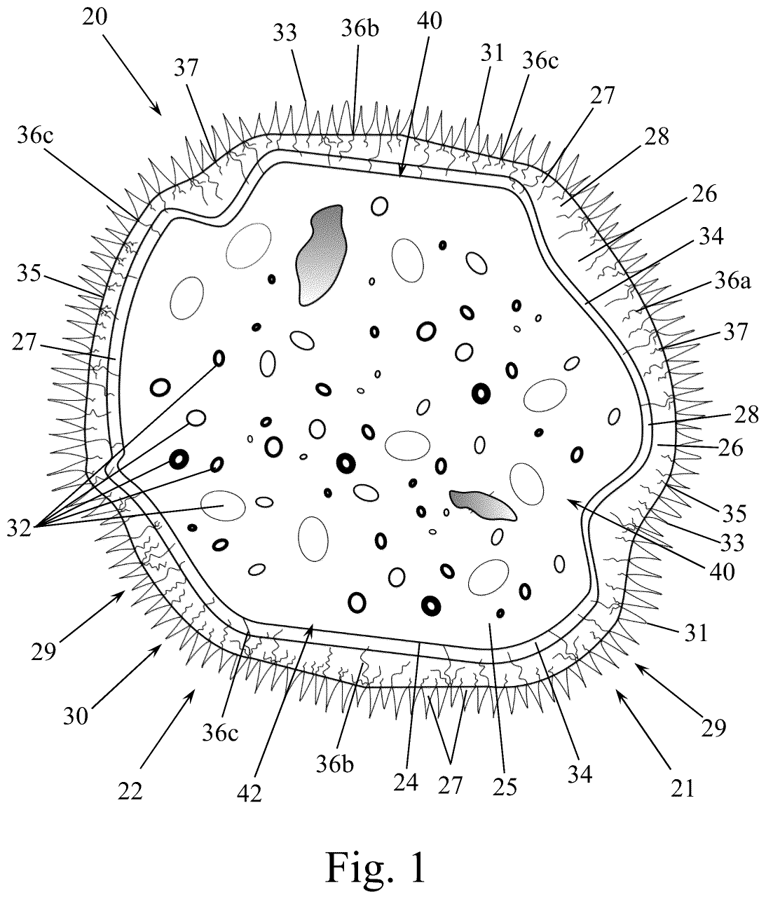

FIG. 1 illustrates a preferred but exemplary embodiment of a single self-clumping absorbent litter granule 20 of the present invention of a coated substrate clumping litter 21 composed of at least a plurality of pairs, preferably at least eight, of the granules 20 per cubic centimeter. Each granule 20 can be characterized as an absorbent clumping material coated substrate litter granule 22 and which is formed of a granule coating nucleating inner particle 42 of a substrate 40, which preferably is composed of an inner substrate material 25, providing an inner substrate granule 42 having an outer surface 24 around which is respectively disposed an inner region 34 and an outer region 26 of a water-absorbent clumping agent coating 28.

Coating 28 has an exterior 29 which preferably is composed of at least a plurality of pairs, i.e., at least three, upraised projections 31 formed during and preferably by agglomeration, at least a plurality of pairs, i.e., at least three, of which can be in the form of spikes 33 spaced apart along and throughout substantially the entire exterior 29 of each granule 22. These upraised projections 31, including spikes 33, facilitate water and urine absorption by surface tension and/or wicking water or urine onto the exterior 29 which more rapidly spreads the water or urine over substantially the entirety of the exposed exterior 29 of each wetted granule 22. The upraised projections 31, including spikes 33, preferably are nanoscale as they are nano-sized having a size of at least a plurality, preferably a plurality of pairs, i.e., at least three, nanometers and no greater than one nanometer from an outer surface 35 of the exterior 29 of each granule 22. In a preferred embodiment, for granules 22 ranging in size between about 500 and about 2400 microns, the upraised projections, including spikes, extend outwardly from the surface 35 between about 35 and about 900 nanometers, preferably between 100 nanometers and 800 nanometers.

The outer surface 29 preferably also has at least a plurality of pairs of cracks 36a-36c, preferably microcracks 37, formed therein which are formed after agglomeration, which preferably are formed during curing and/or drying of each granule 22, which cracks 36a-36c, including microcracks 37, preferably continue to propagate and even from after drying, including during moisture stabilized storage, e.g., retail packaging. Each of the cracks 36a-36c, including microcracks 37, are formed in the outer surface 35 of the exterior 29 of each granule 22 at least during curing and drying of each granule 22. Each of the cracks 36a-36c, including microcracks 37 have a root width at the location where the crack 36a-36c, including microcrack 37, begins or forms in the outer surface 35 which is nanoscale and nanosized as it is in nanometers typically ranging between at least about 5 and no more than about 700 nanometers, preferably between 10 and 500 nanometers. Each crack 36a-36c can extend below the outer granule surface 35 from between about 5 nanometers to about the thickness of the coating 28, with crack lengths ranging from at least about 5 nanometers to no greater than about 5 microns, preferably between about 20 nanometers and about 2 microns, more preferably between 50 nanometers and about 1 micron. Where the crack 36a is a microcrack 37, it preferably has a length or depth of less than 1 micron where it extends below the granule surface to a length or depth of less than 1 micron.

As is shown in FIG. 1, cracks 36a which are microcracks 37 extend below the surface 33 of the coating 28, i.e., surface 33 of granule 22, into the outer absorbent region 26 of the coating 28 but not into the inner substrate adhering region 34 of the coating 28. Cracks 36b extend below the surface 33 into the inner self-adhering region 34 of the coating. Cracks 36c extend below the surface 33 of the coating 28 through the outer absorbent region 26 into and through the inner region 34 to the outer surface 24 of the substrate granule 42.

These microcracks are formed in each substrate coated litter granule 22 after agglomeration of the substrate granule 42 into a finished substrate coated litter granule 22, preferably during curing of the finished substrate coated litter granule 22 as well as during post-curing drying of the finished substrate coated litter granule 22. These microcracks continue to develop and grow after post-curing drying, including during and after retail packaging into bags or other containers. These microcracks are advantageous because they facilitate more rapid and more thorough absorption of water in urine by each wetted coated substrate litter granule 22 during litter use.

The clumping agent coating 28 is composed of a modified-starch water-absorbent clumping agent 27 that preferably is an extrusion modified starch water absorbent clumping agent having (a) an absorbent component comprised of a water swelling water absorbent modified starch, preferably a cold water swelling cold water absorbent modified starch, (b) a clumping component comprised of an at least partially water-soluble binder, preferably in at least partially cold water-soluble binder of which a soluble fraction forms a water soluble flowable water-activated moisture-curing adhesive, preferably cold water soluble flowable water-activated moisture-curing adhesive, at least some of which preferably can be re-activated at least once after initial water activation. The clumping agent coating 28 preferably is composed of a modified-starch water-absorbent clumping agent 27 that preferably is an extrusion modified starch water absorbent clumping agent, more preferably an ultrahigh pressure extrusion modified starch water absorbent clumping agent, which preferably is or includes a water sorbent swelling and gelling biopolymeric clumping agent. In a preferred clumping agent 27 that can be and preferably is a water sorbent swelling and gelling biopolymeric clumping agent, the clumping agent 27 is composed of: (a) an absorbent component comprised of a water swelling water absorbent modified starch, preferably a cold water swelling cold water absorbent modified starch, which nearly instantly absorbs room temperature water and cat body temperature urine within three seconds, and (b) a clumping component comprised of an at least partially water-soluble binder, preferably in at least partially cold water-soluble binder of which a soluble fraction forms a water soluble flowable water-activated moisture-curing adhesive, preferably cold water soluble flowable water-activated moisture-curing adhesive, at least some of which preferably can be re-activated at least once after initial water activation, which facilitates agglomeration and self-clumping together of water or urine wetted self-clumping absorbent litter granules into a removably scoopable clump (not shown) during sorbent, absorbent and/or litter use.

The inner substrate granule or inner substrate particle 42 of the self-clumping absorbent coated substrate litter granule 22 shown in FIG. 1 has at least a plurality of pairs of pores 32 in its outer surface 24, can be internally void-filled with at least a plurality of pairs of internal voids and/or pockets (not shown) underneath the outer surface 24, and can be an organic substrate particle, such as a particle of crushed walnut shell, or inorganic substrate particle, such as a particle of crushed perlite, As is also shown in FIG. 1, the outer region 26 of the modified starch water absorbent clumping agent 28 can be fixed or bonded to the outer surface of the substrate particle by an intermediate or inner adhering region 34, preferably a self-adhering inner bonding region, composed of the same modified-starch water absorbent clumping agent 28 as the outer region but which has a higher percentage or fraction of its at least partially water-soluble modified starch binder in an activated and cured substantially hard glassy material state, preferably a substantially hard glassy material adhesive or bonding state, and adhesively bonded to the outer substrate particle region surface via at least one and preferably both hydrogen bonds and covalent bonds.

In a preferred embodiment, at least some of the at least partially water-soluble modified starch binder, including at least some of the at least partially soluble flowable adhesive, of the modified-starch water-absorbent clumping agent in both the inner self-adhering region and the outer granule region is or includes at least some water-activated moisture-curing binder and/or water-activated moisture-curing adhesive that is in a modified starch form, preferably an extrusion modified starch form, even more preferably at an ultrahigh pressure extrusion modified starch form, which can be reactivated into a binder and/or adhesive adhering state and recured back into the activated and cured substantially hard glassy material state, preferably substantially hard glassy material adhesive or bonding state by rewetting with water, preferably room temperature water, enabling the at least partially soluble modified starch binder and/or flowable adhesive to water activate and moisture cure at least a second time. In another preferred modified starch water absorbent clumping agent embodiment, at least some of the modified starch, preferably extrusion modified starch, more preferably ultrahigh pressure extrusion modified starch, can be water reactivated and moisture re-cured at least a plurality of times, preferably at least a plurality of pairs of times, by being reactivated each time temperature water or cat body heat temperature urine wets the material and thereafter once again being moisture re-cured by drying, preferably to a moisture content of no greater than 15%, preferably no greater than 12% by weight. Such a water re-activatable and moisture re-curable modified starch water absorbent clumping agent can be and preferably occurs through one of endothermic water reactivation and moisture recuring and/or endothermic re-gelatinization of at least some of the modified starches, preferably extrusion-modified starches, more preferably ultrahigh extrusion pressure modified starches, in the modified-starch water absorbent clumping agent of the outer region. In at least one such preferred embodiment, at least some of the modified starch, preferably extrusion modified starch, more preferably ultrahigh pressure extrusion modified starch, is water re-activatable and moisture re-curable by being able to be water reactivated and moisture re-cured at least a plurality of times, preferably at least a plurality of pairs of times, by being reactivated each time temperature water or cat body seat temperature urine whets the material and thereafter once again being moisture re-cured by drying, preferably to a moisture content of no greater than 15%, preferably no greater than about 12% by weight.

This enables at least some of the at least partially soluble modified starch binder, including at least some of the at least partially soluble flowable adhesive formed therefrom upon water or urine wetting, after application of the outer region to the inner substrate particle, to be re-wetted and re-activated by room temperature water or cat body temperature urine during sorbent or litter use to be available in remain available to agglomerate and self-clumping wetted litter granules of the present invention together into a clump that moisture cures as it dries into a substantially rock hard clump having a clump retention rate of at least 95%, preferably 97%, more preferably 99%, and a clump crush strength or compressive strength of at least 40 PSI, preferably at least 60 PSI, more preferably at least 80 PSI, and even more preferably at least 100 PSI when dried to a moisture content of about 12% by clump weight.

The inner self-adhering region and outer region of each litter granule can be applied in a water wetting-rewetting application method where relatively small particles of the modified starch water absorbent clumping agent are applied substantially simultaneously onto outer surfaces of the substrate particles, including substrate particles of more than one type of substrate material, to form the outer region of water absorbent clumping material on each one of the substrate particles in accordance with such methods of making the self-clumping absorbent litter granules of the present invention disclosed elsewhere herein. The inner self-adhering region and outer region of each litter granule can also be applied in a slurry application method where relatively small particles of the modified starch water absorbent clumping agent are mixed with a liquid, preferably water, to form a slurry that is applied onto outer surfaces of the substrate particles, including substrate particles of more than one type of substrate material, to form the outer region of water absorbent clumping material on each one of the substrate particles in accordance with such methods of making the self-clumping absorbent litter granules of the present invention disclosed elsewhere herein. After application, moisture is removed, preferably by drying, from the litter granules to moisture cure the adhesives from the at least partially soluble modified starch binder, including flowable adhesive produced therefrom, thereby fixing or bonding the outer region to its inner substrate particle and further inhibiting retrogradation of at least some of the starches in the outer region producing litter granules of the present invention containing at least some un-activated moisture curing modified starch water absorbent clumping agent, including at least some at least partially soluble modified-starch un-activated moisture curing modified binder and flowable adhesive that forms during wetting therefrom, in the outer region of each granule, and at least some reactivatable moisture re-curing modified starch water absorbent clumping agent, including at least some at least partially soluble modified-starch un-activated moisture curing modified binder and flowable adhesive that forms during wetting therefrom, in the outer region of each granule thereby advantageously producing finished self-clumping water-absorbent litter granules of the present invention ready for litter or sorbent use.

### Granular Substrates

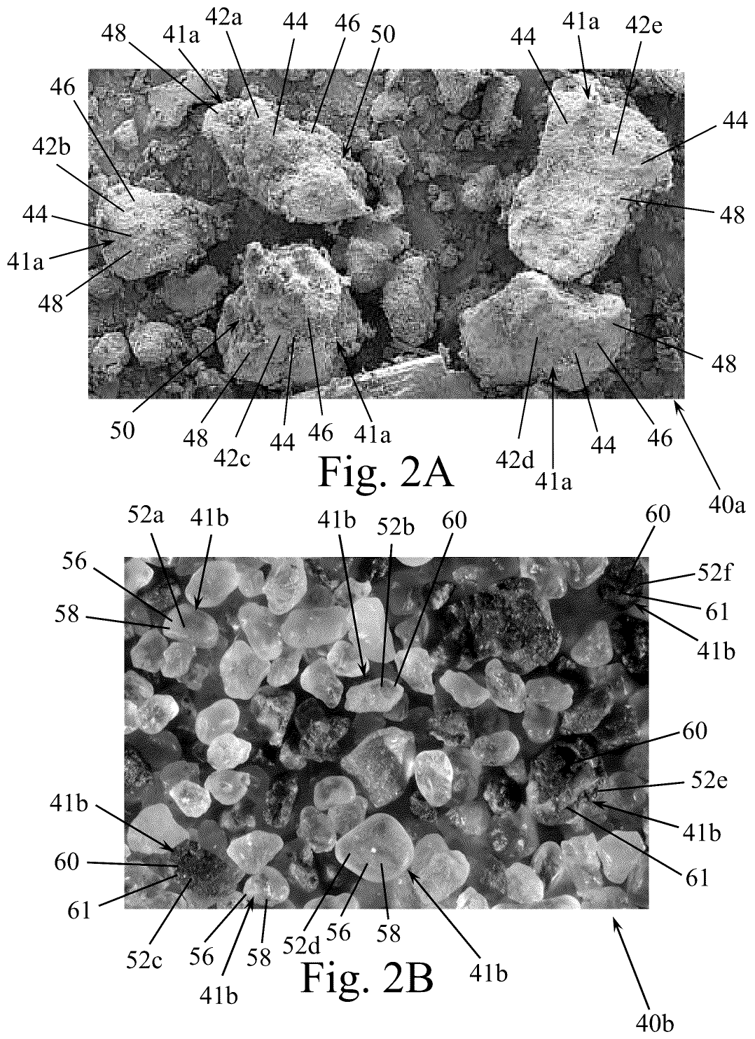

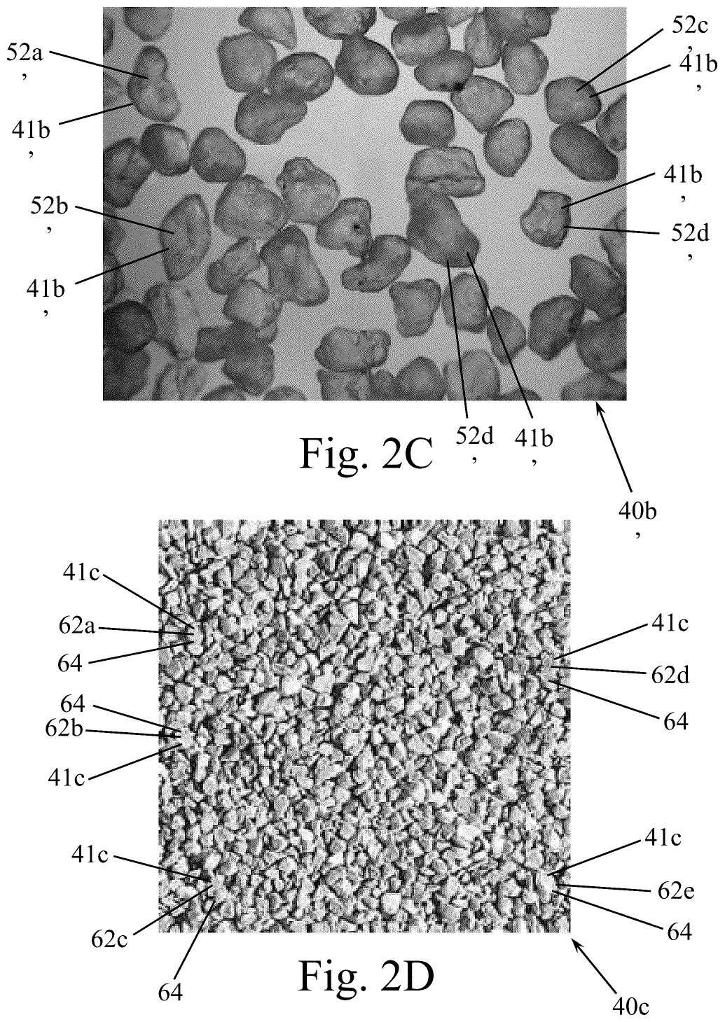

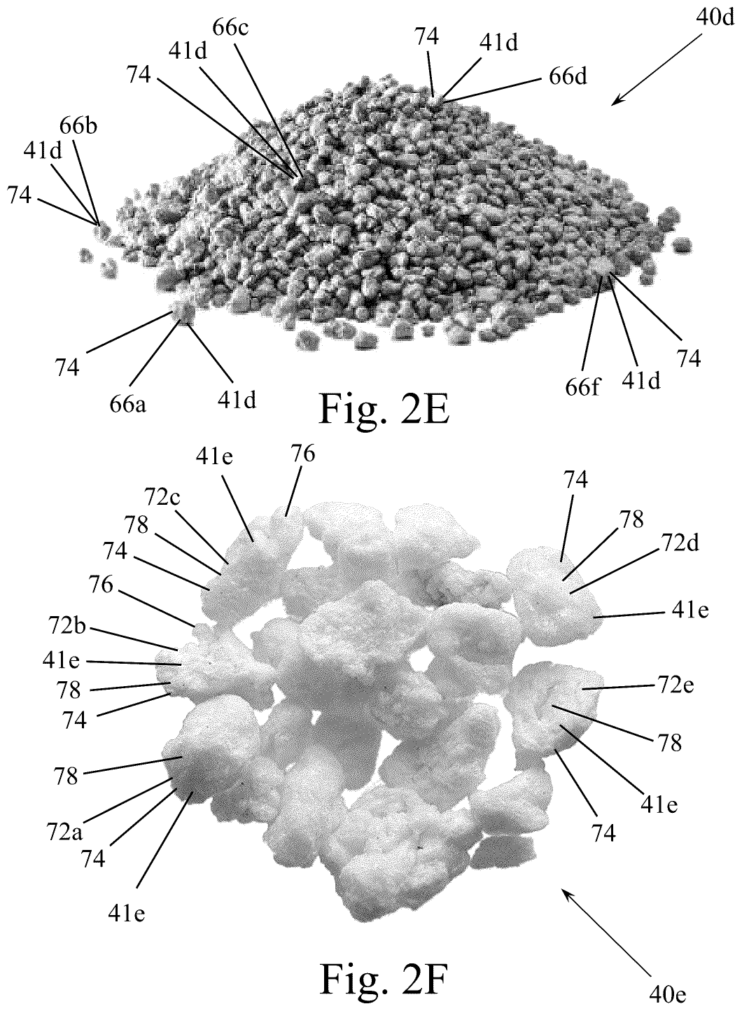

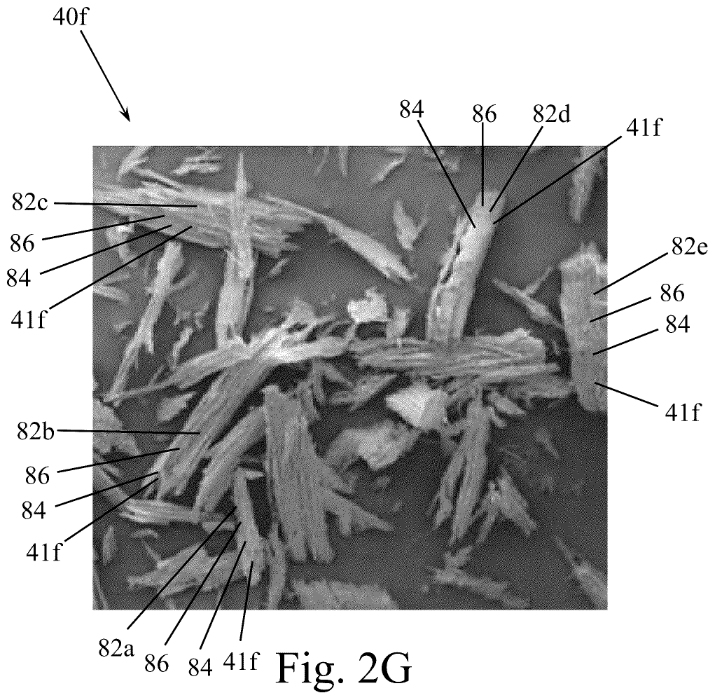

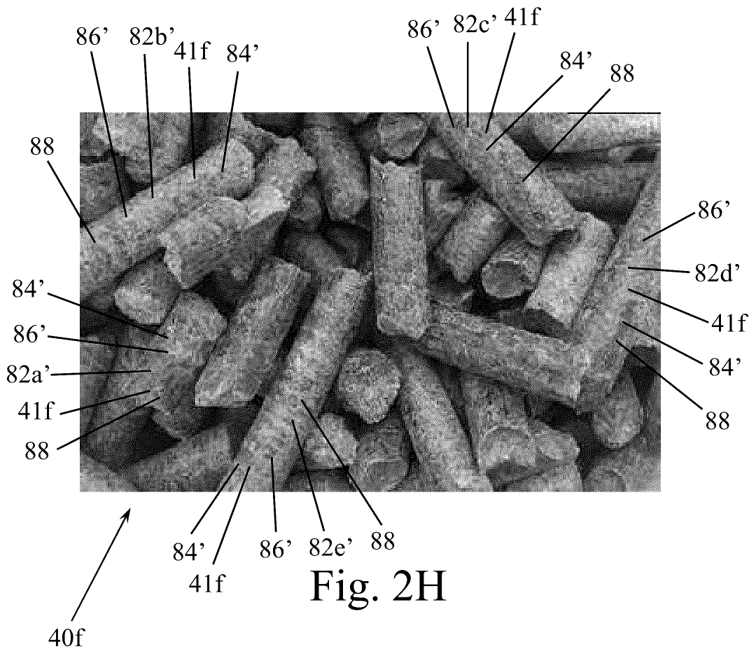

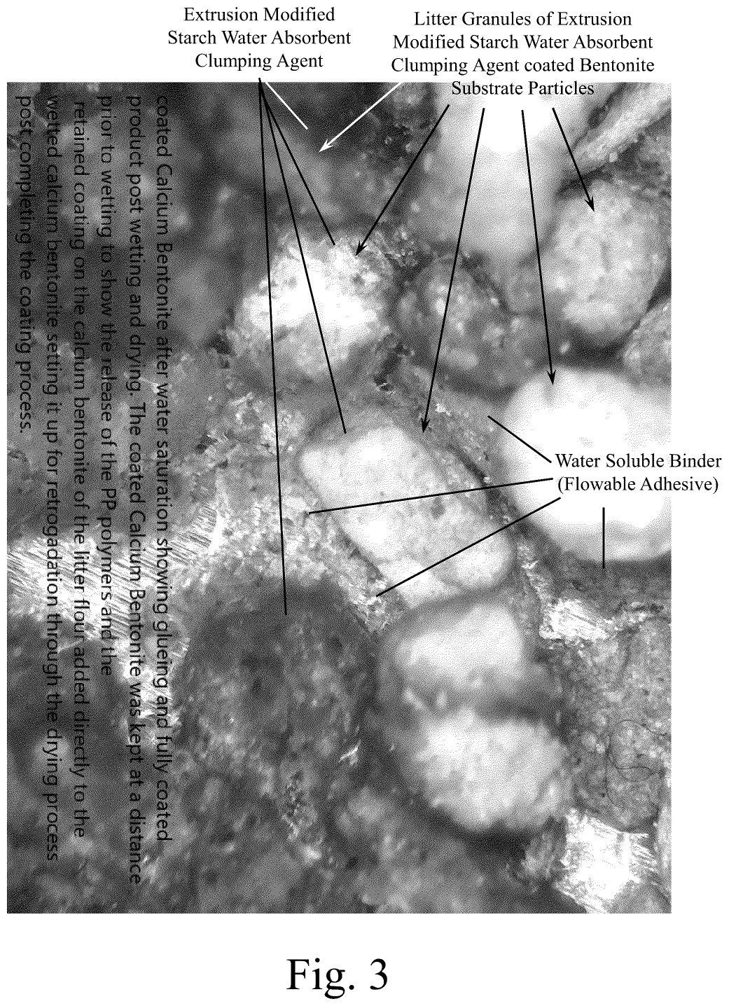

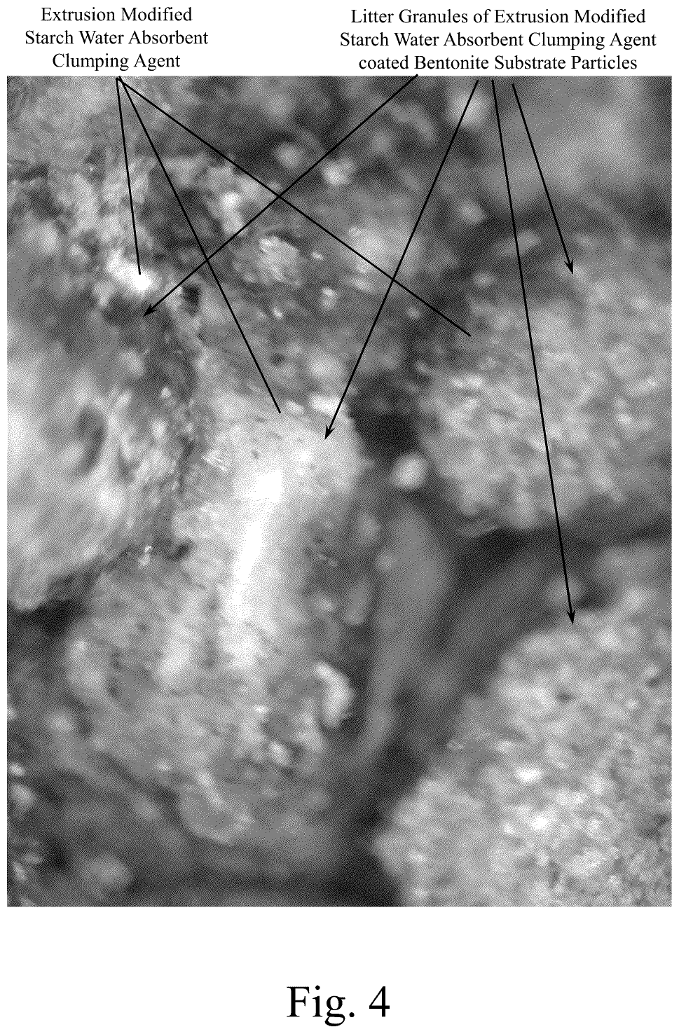

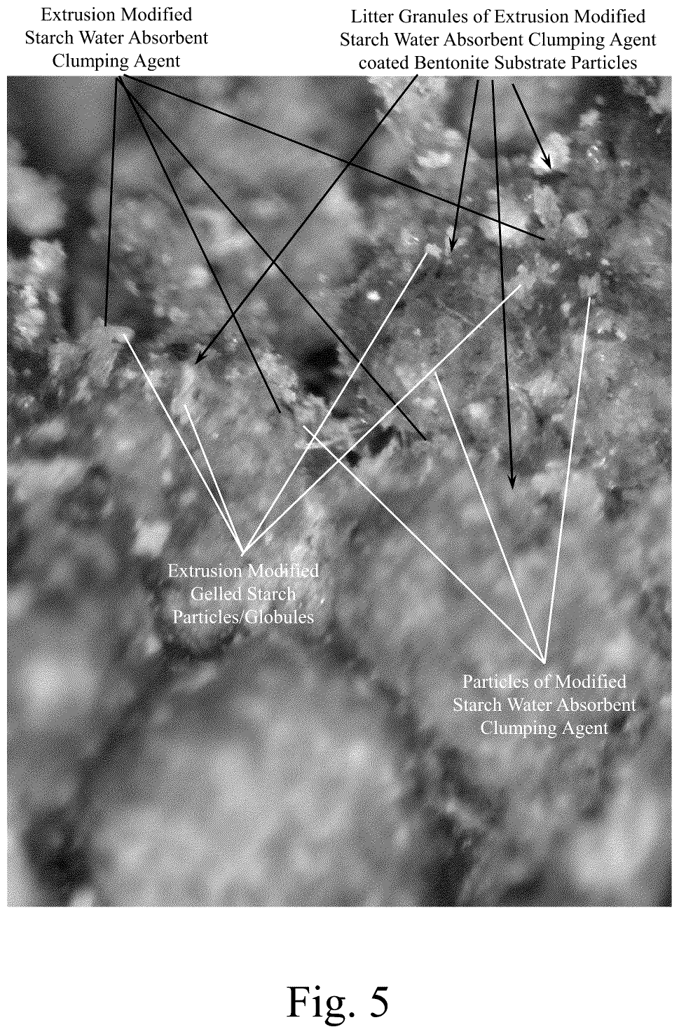

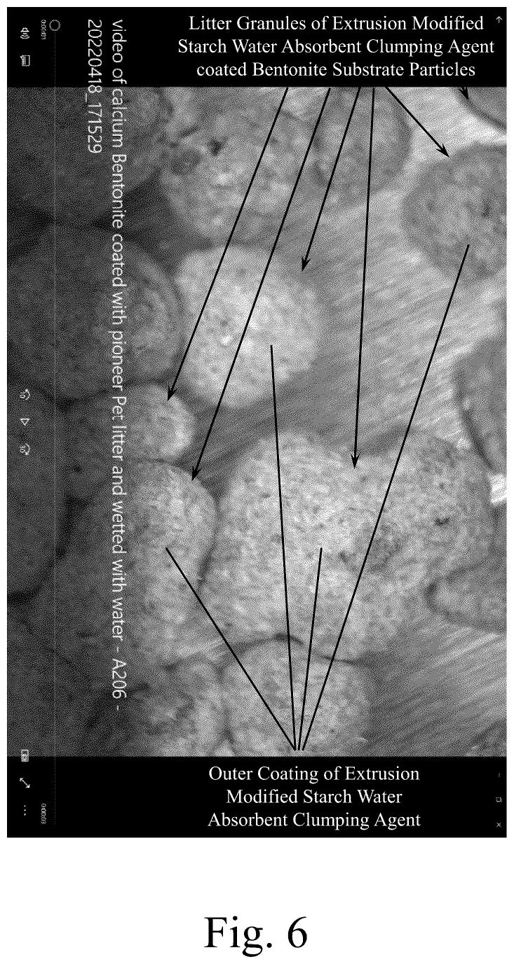

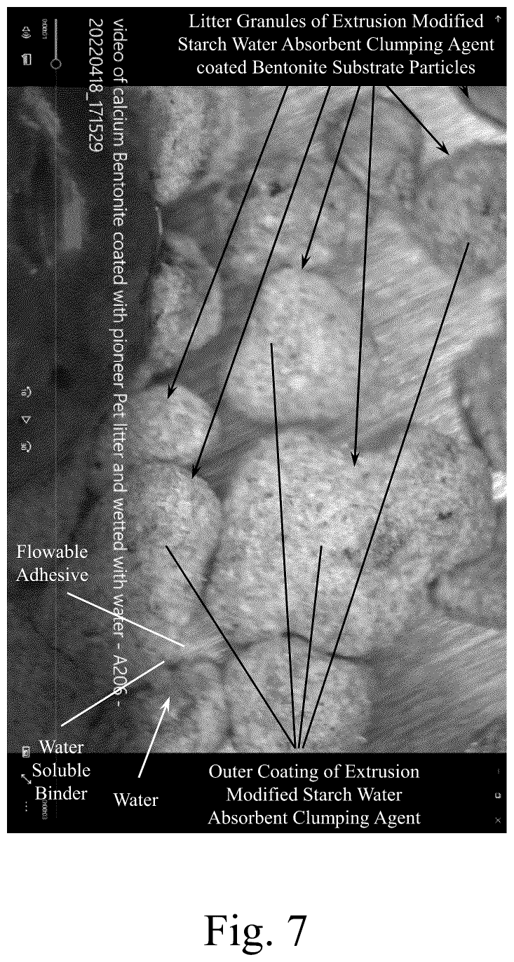

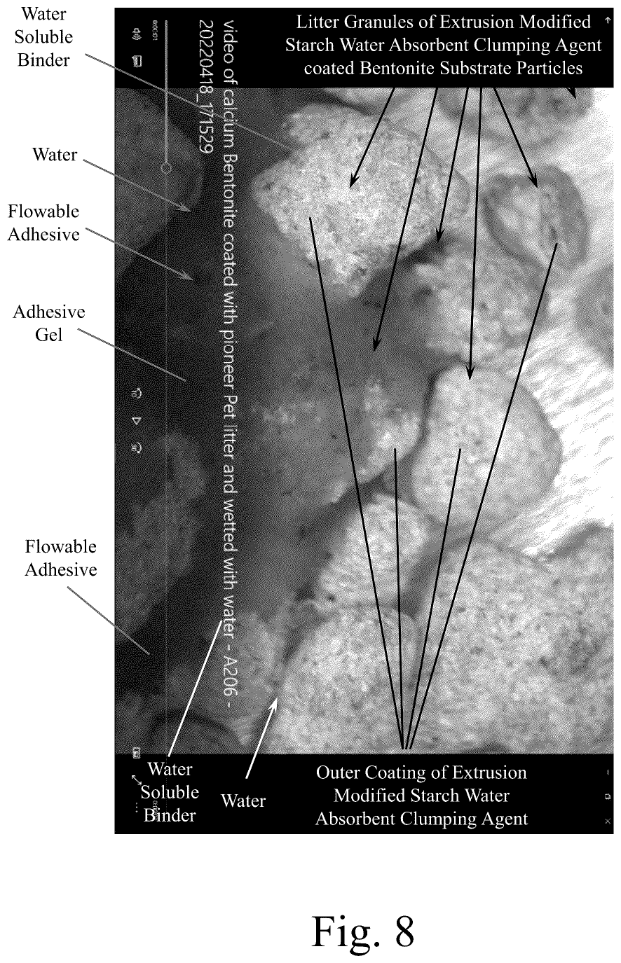

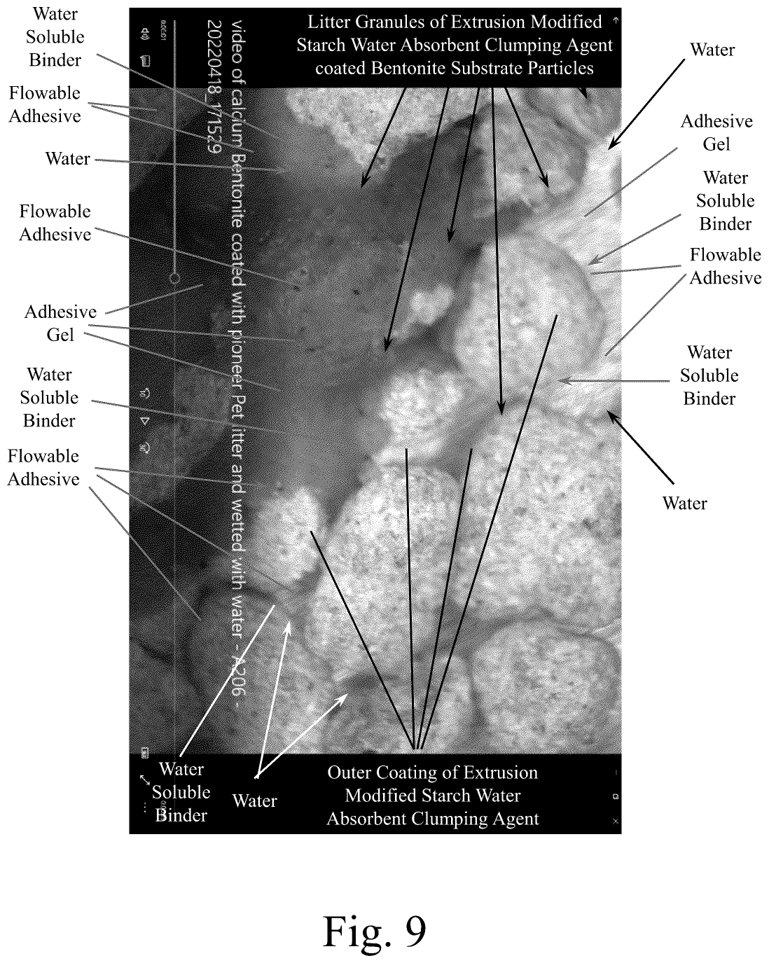

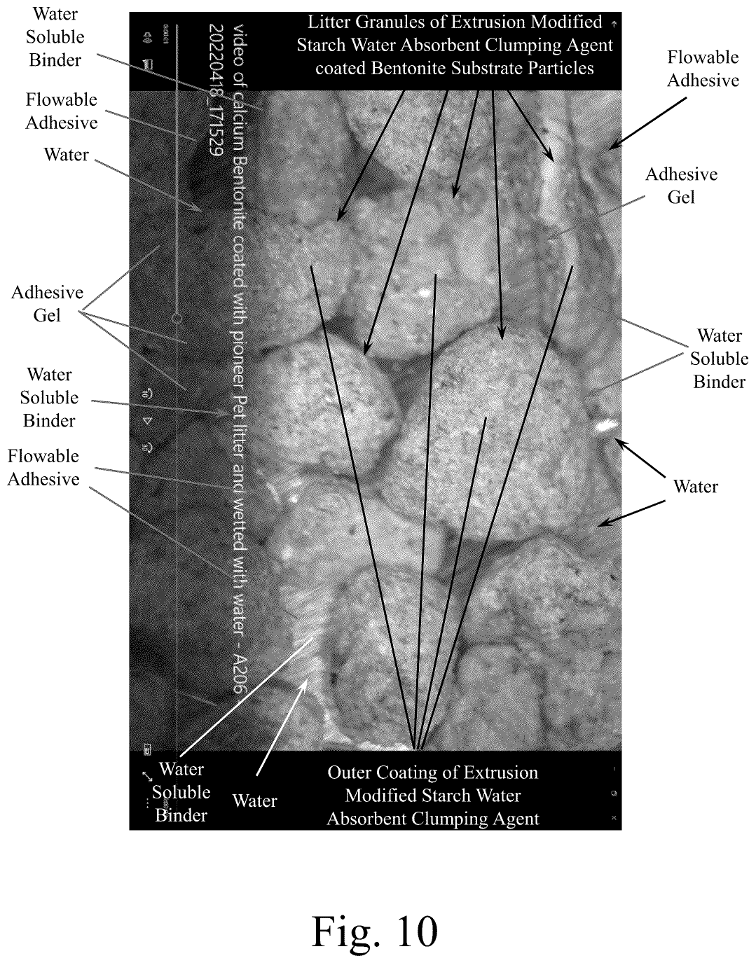

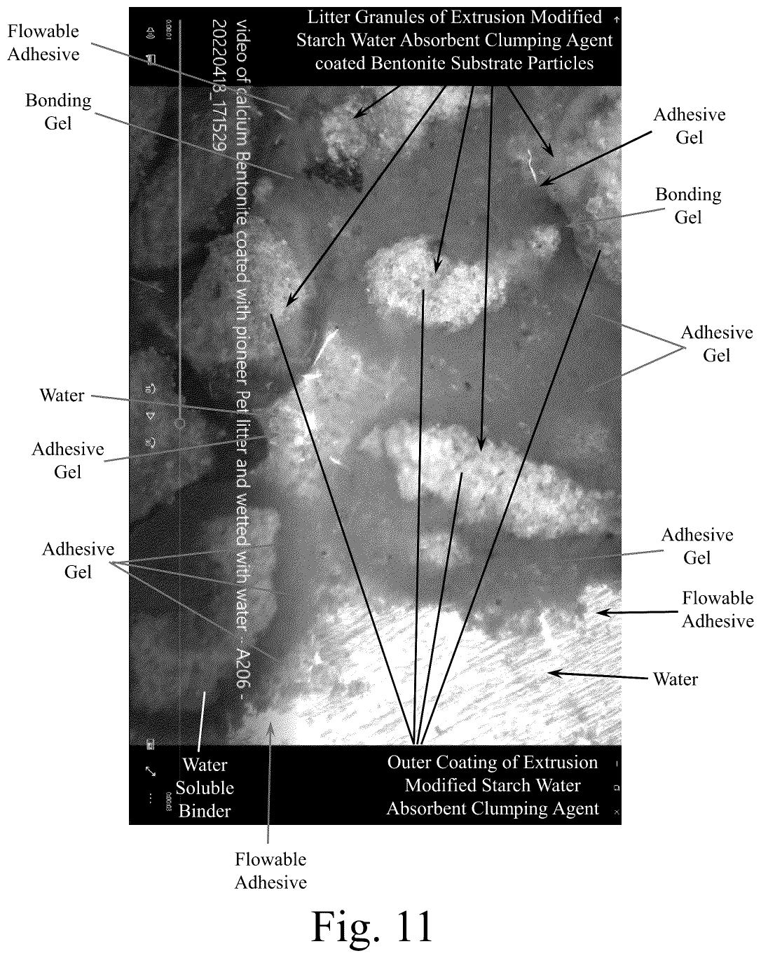

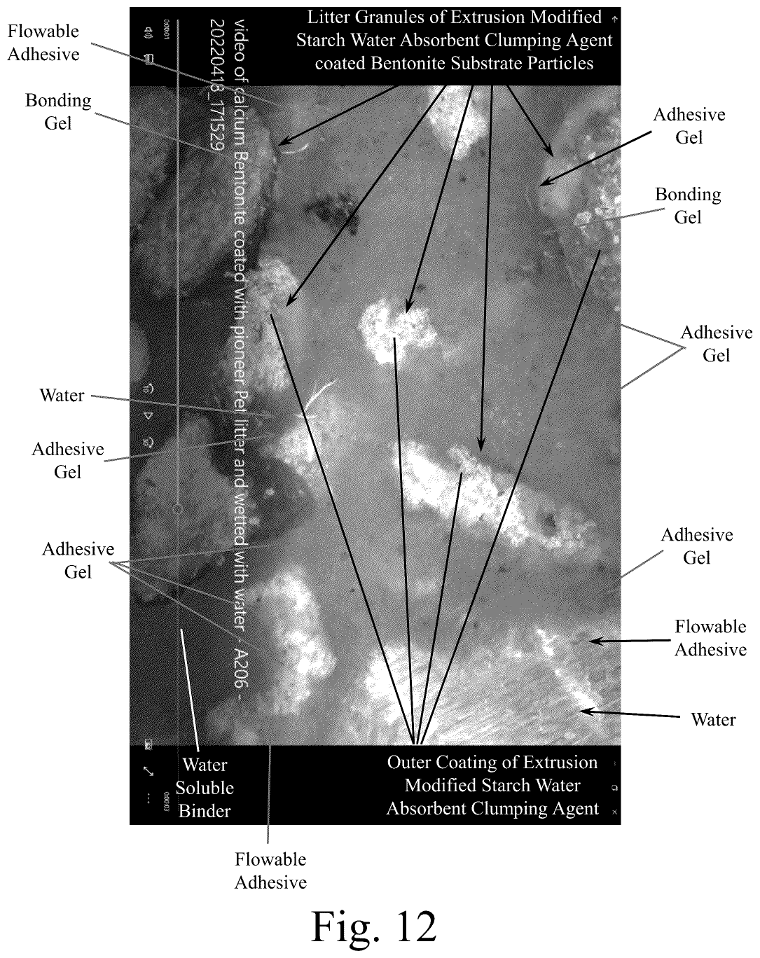

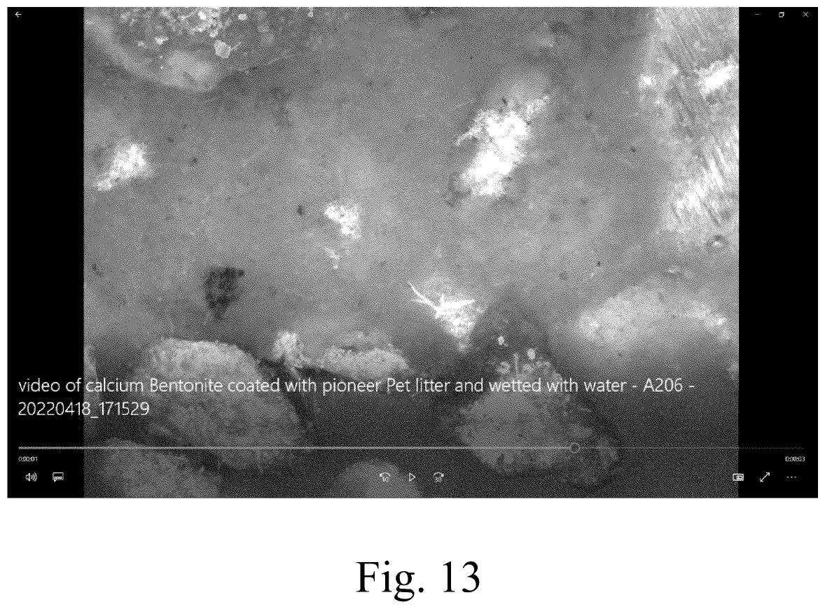

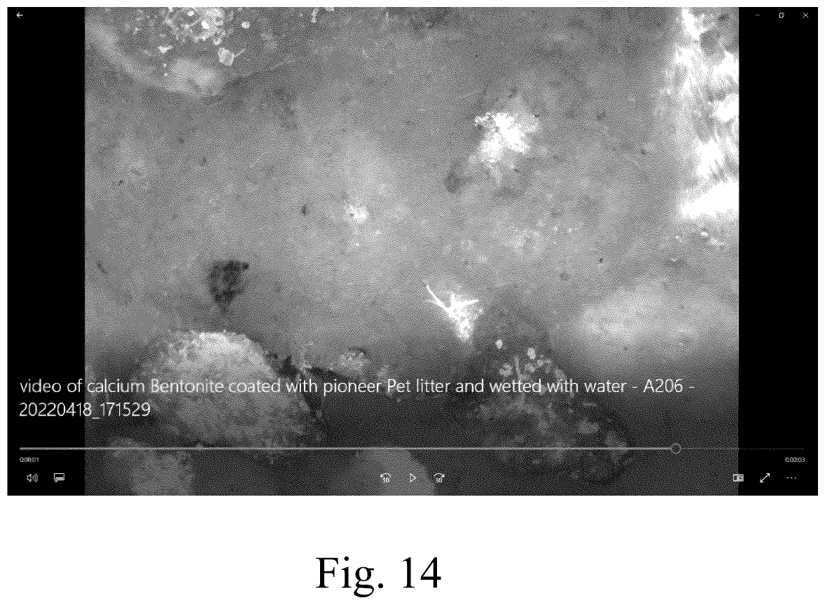

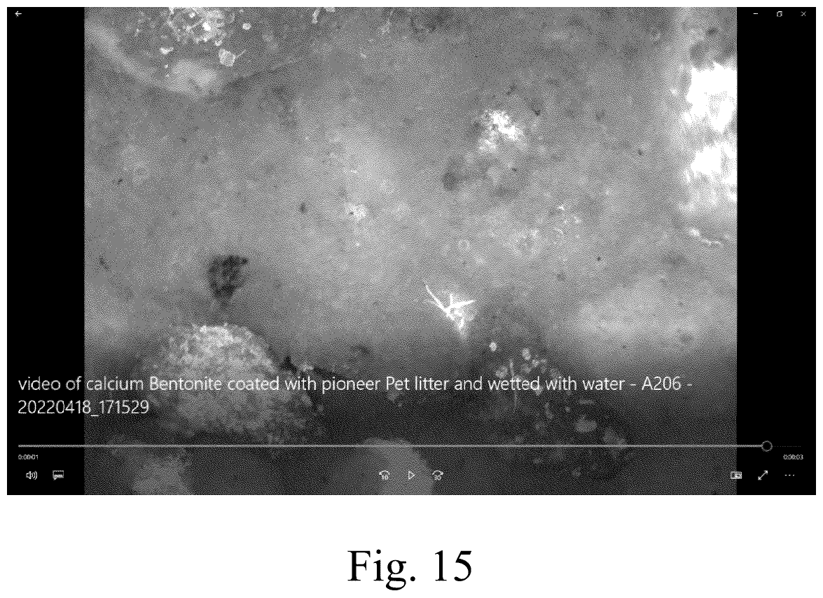

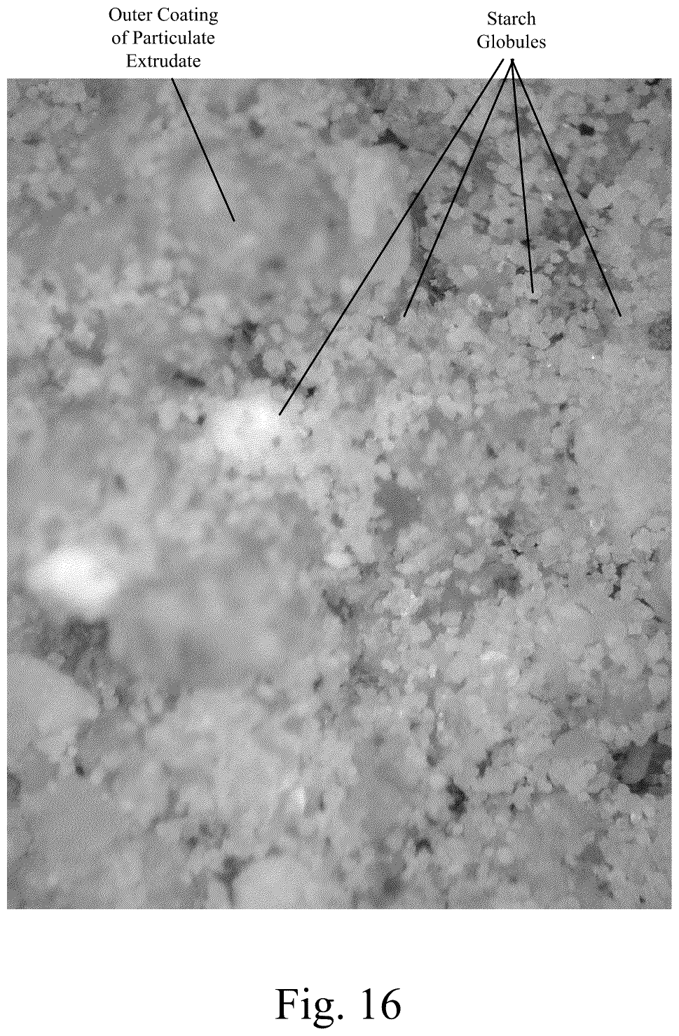

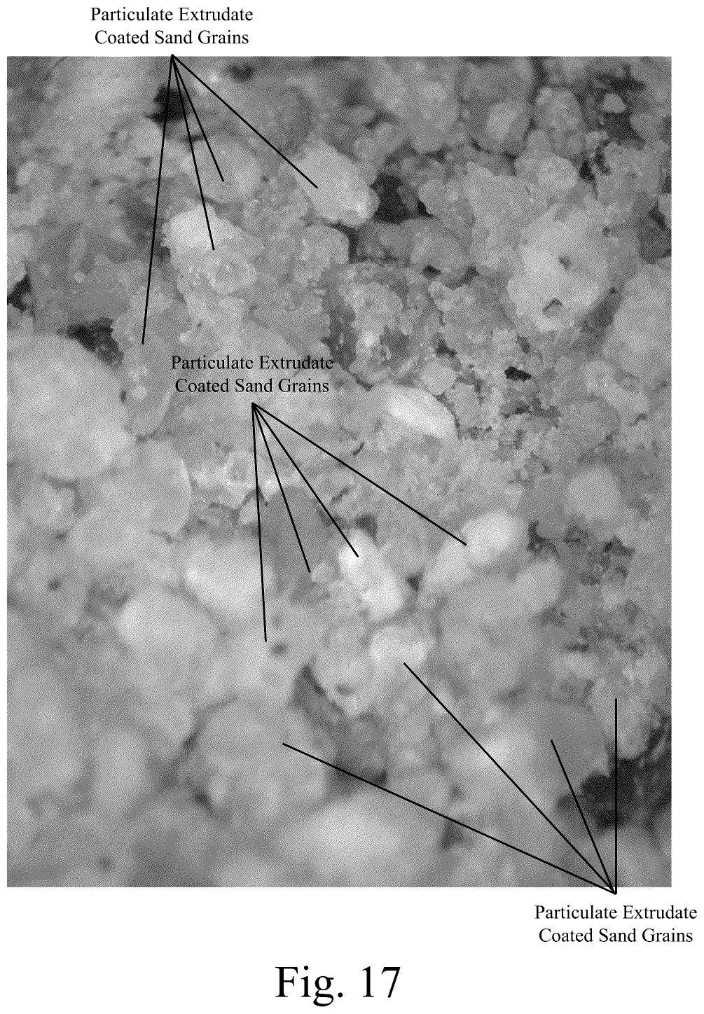

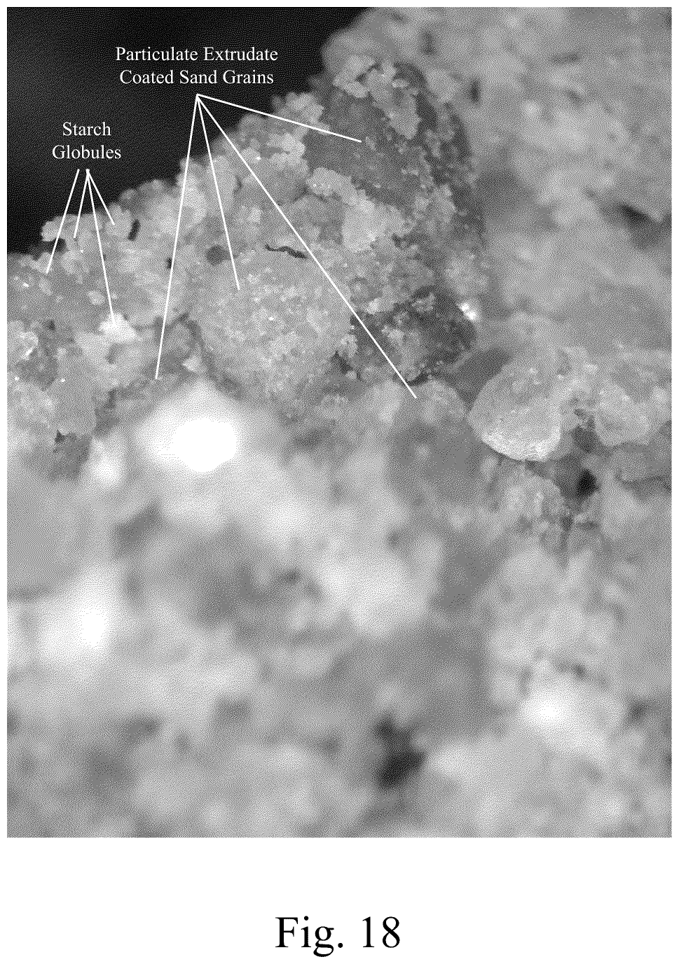

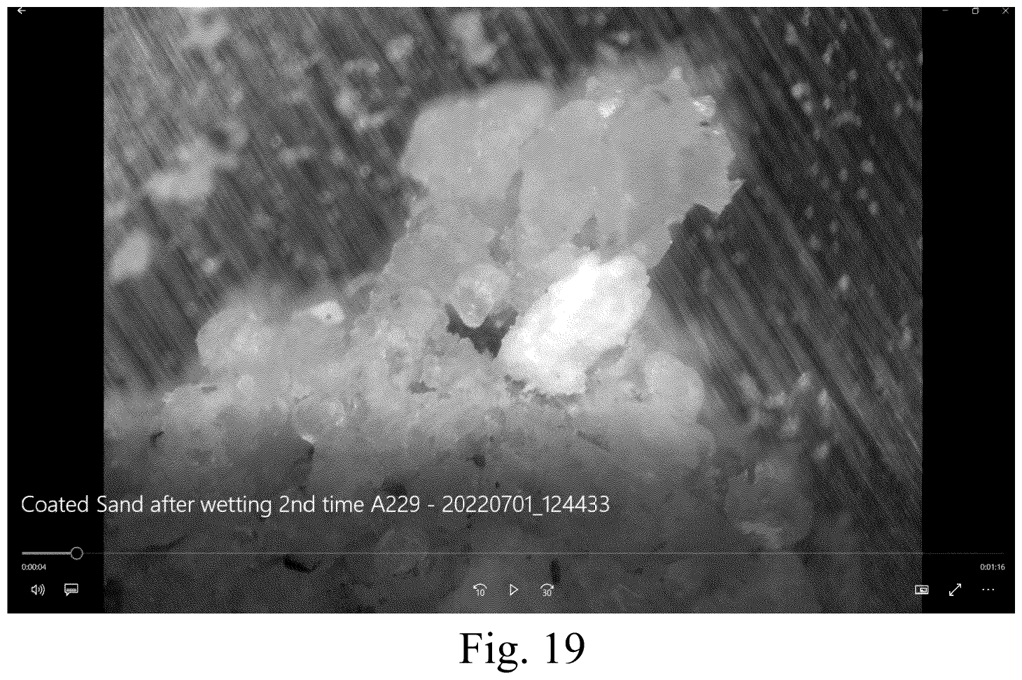

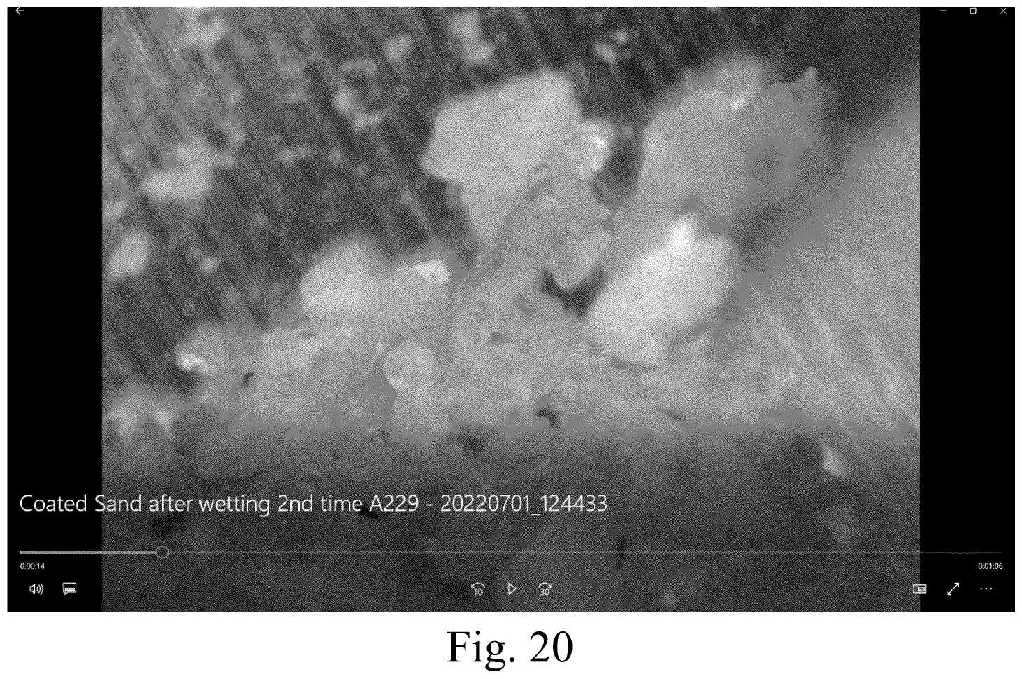

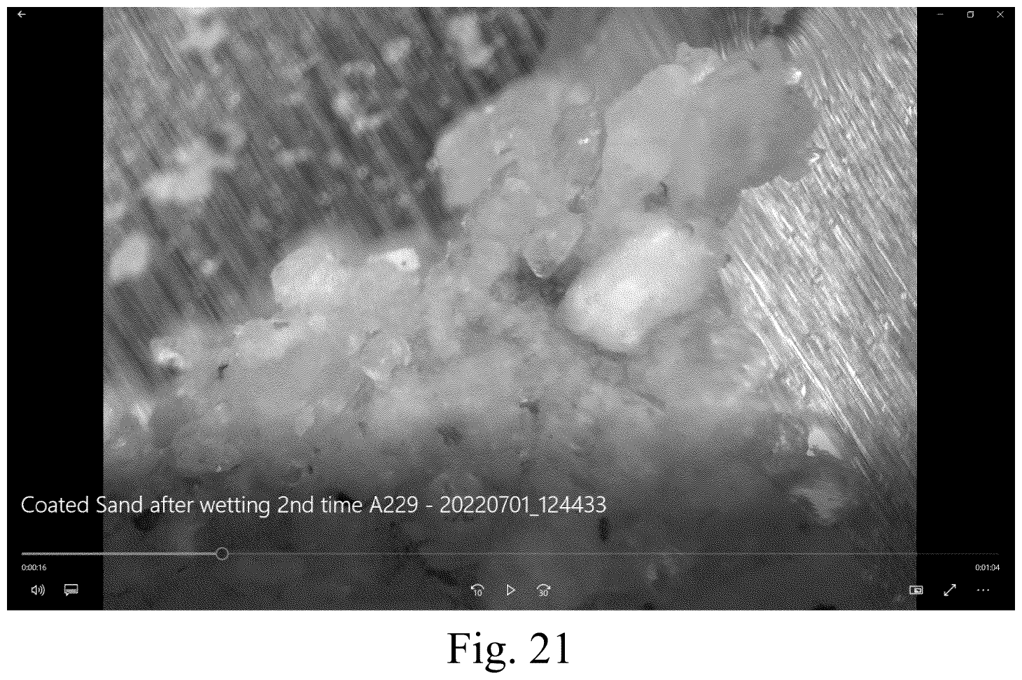

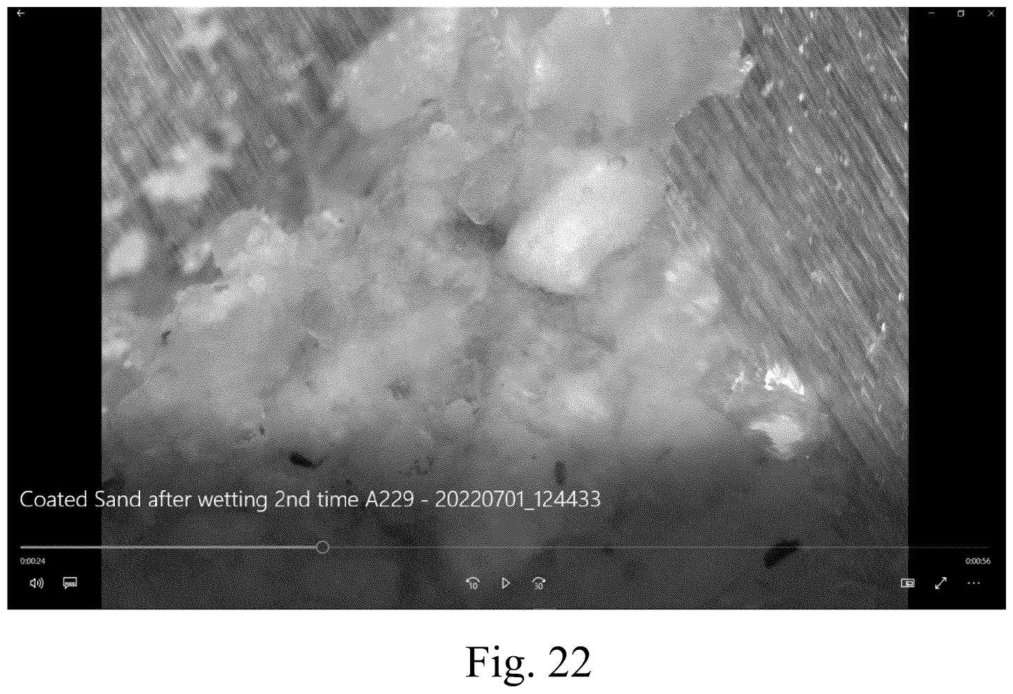

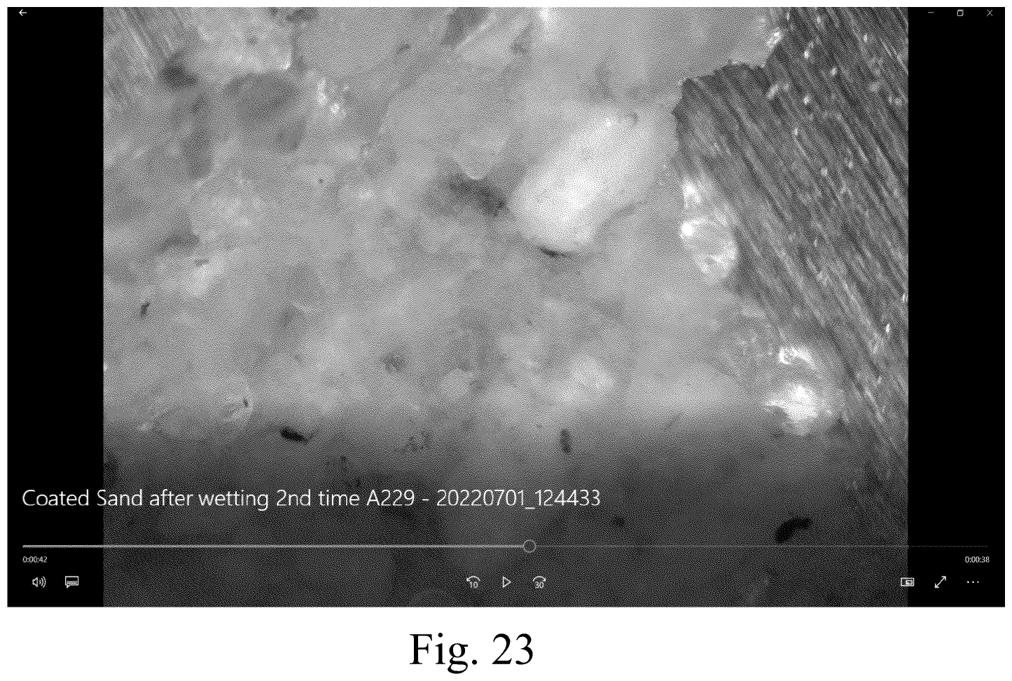

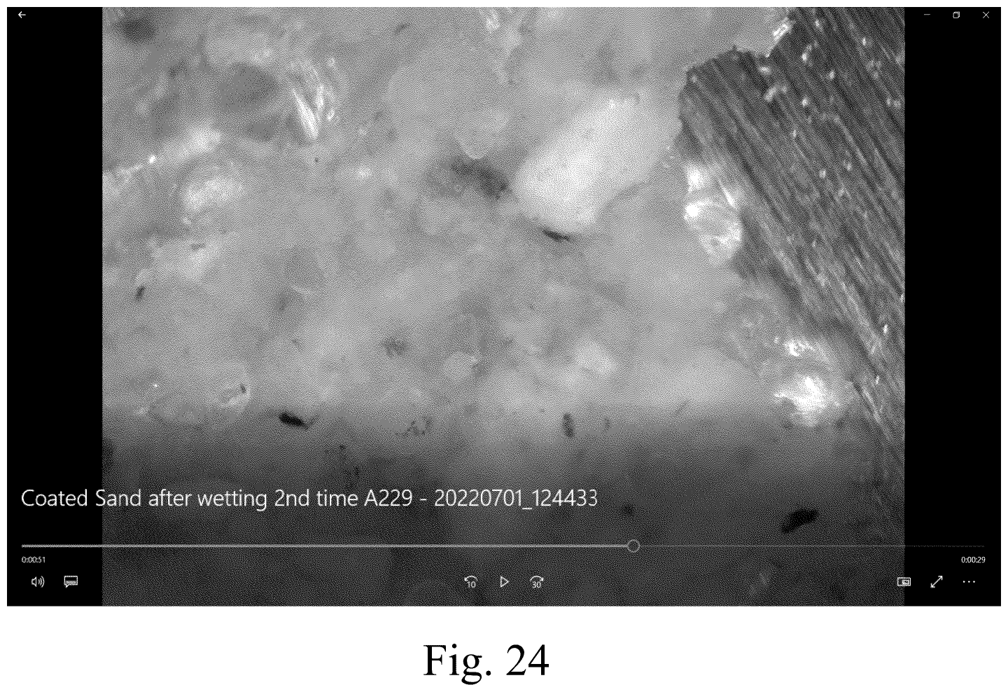

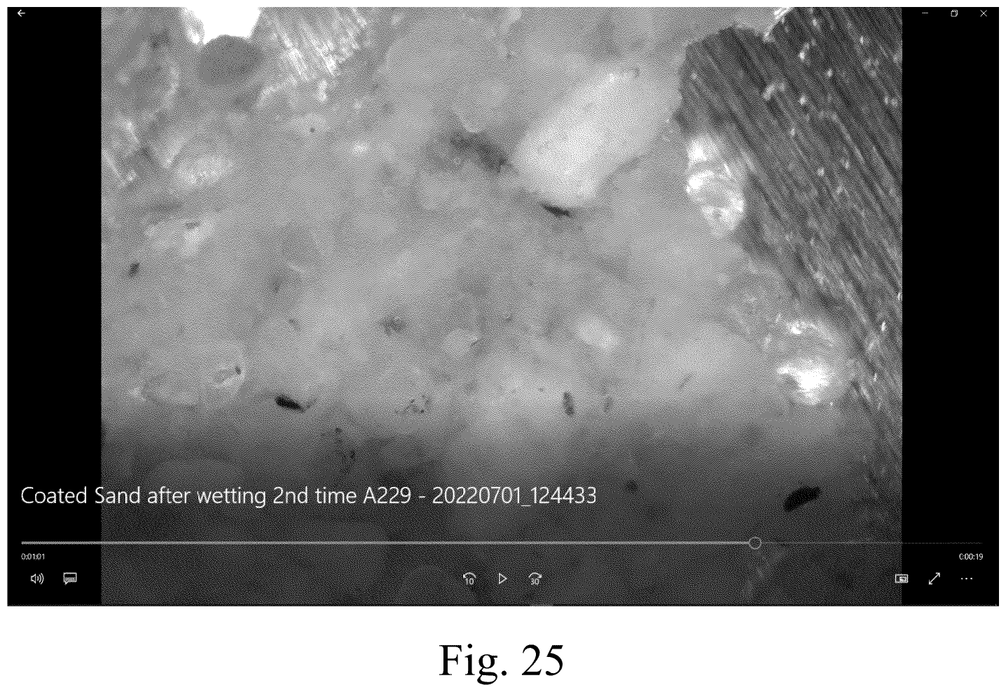

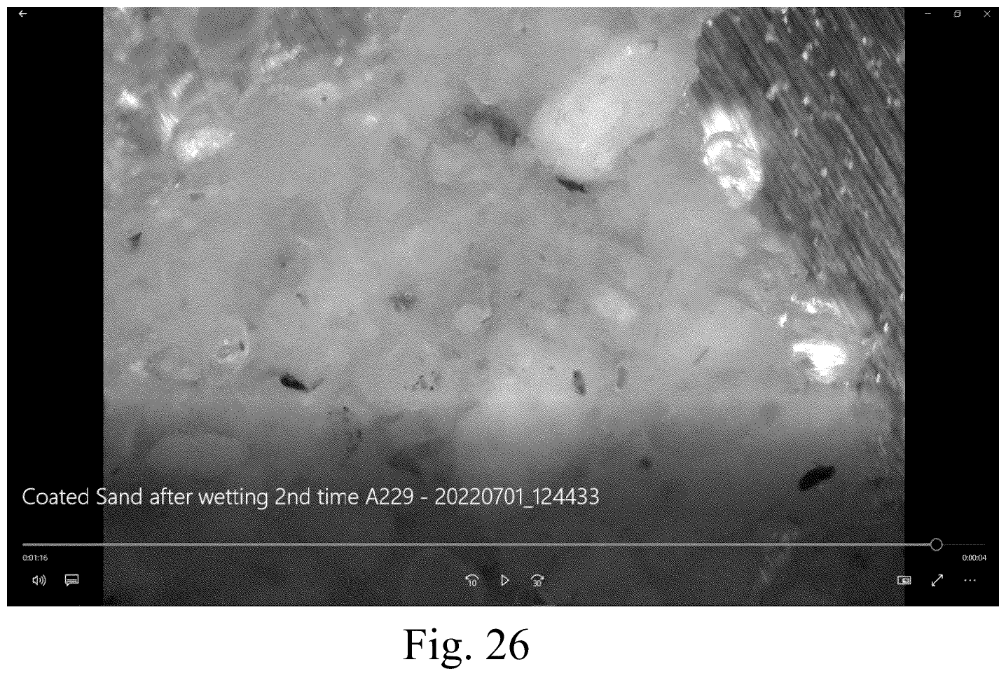

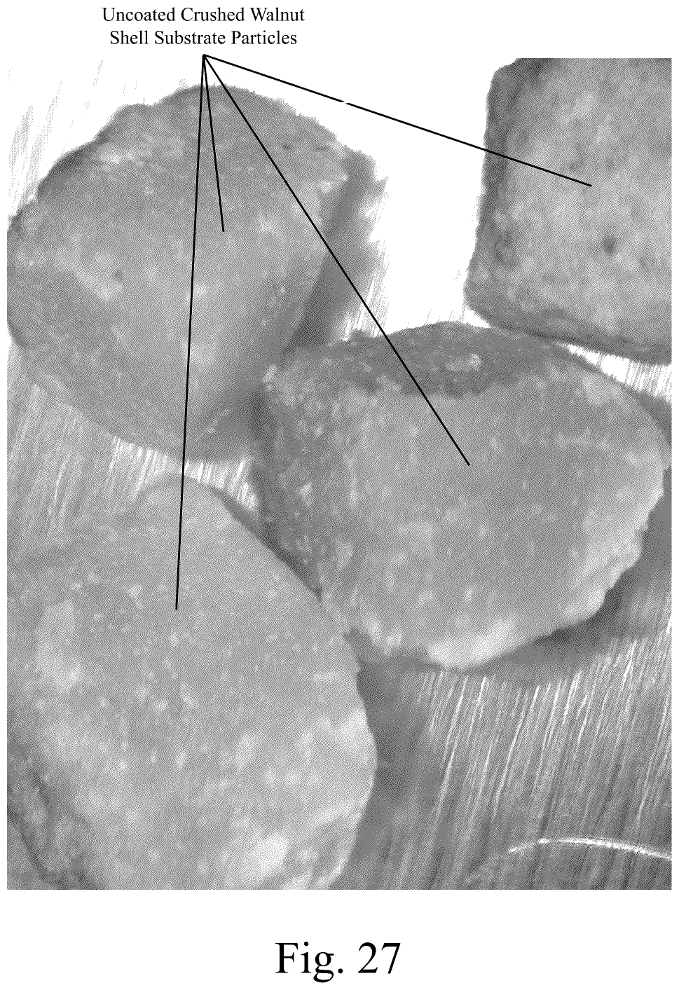

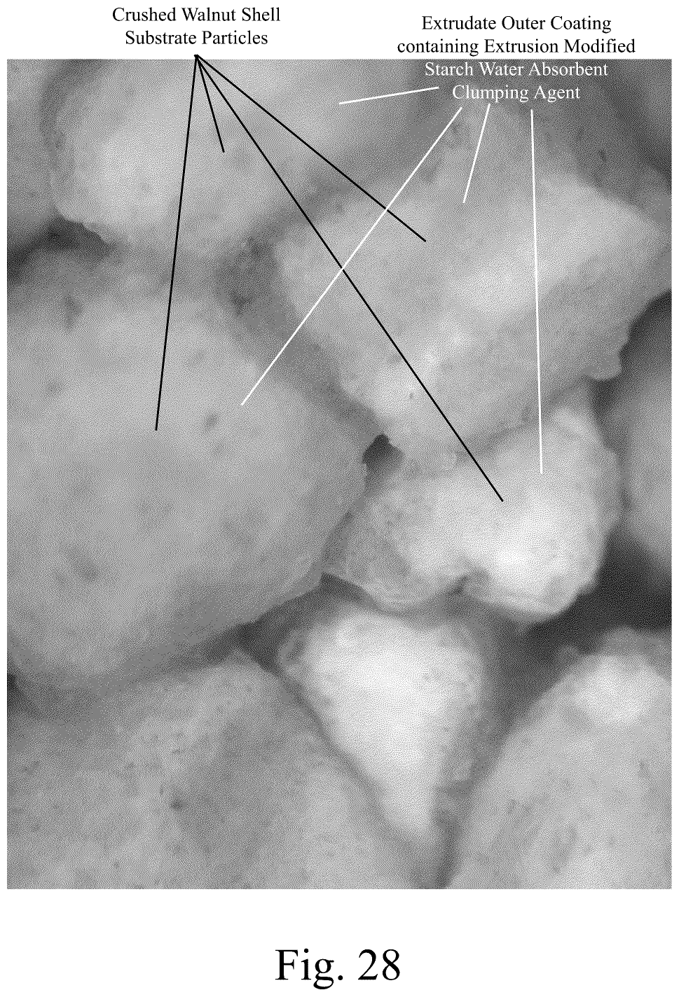

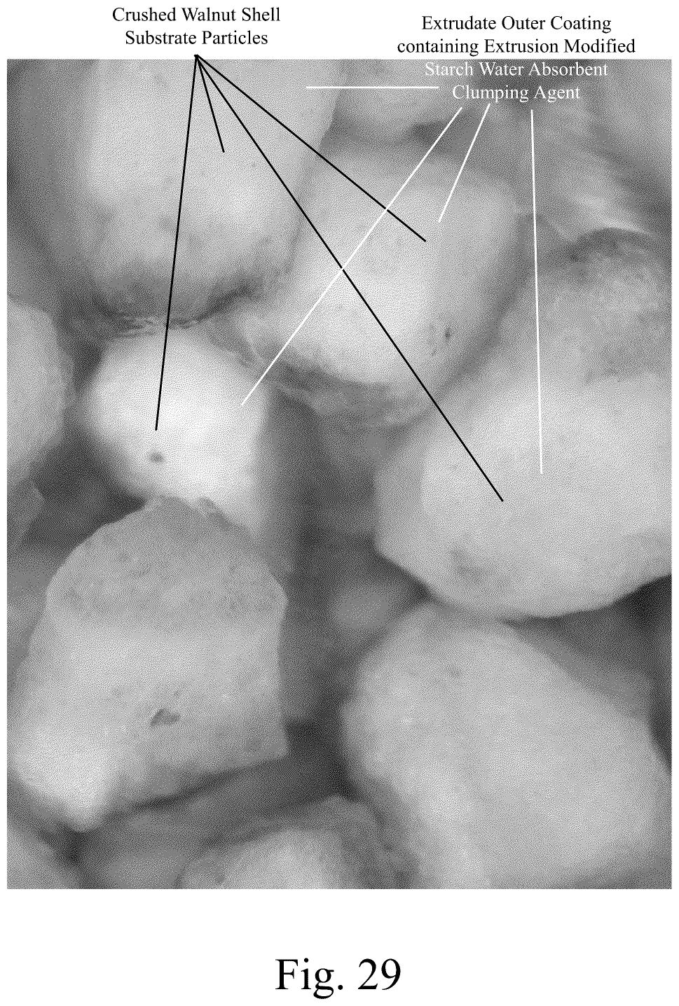

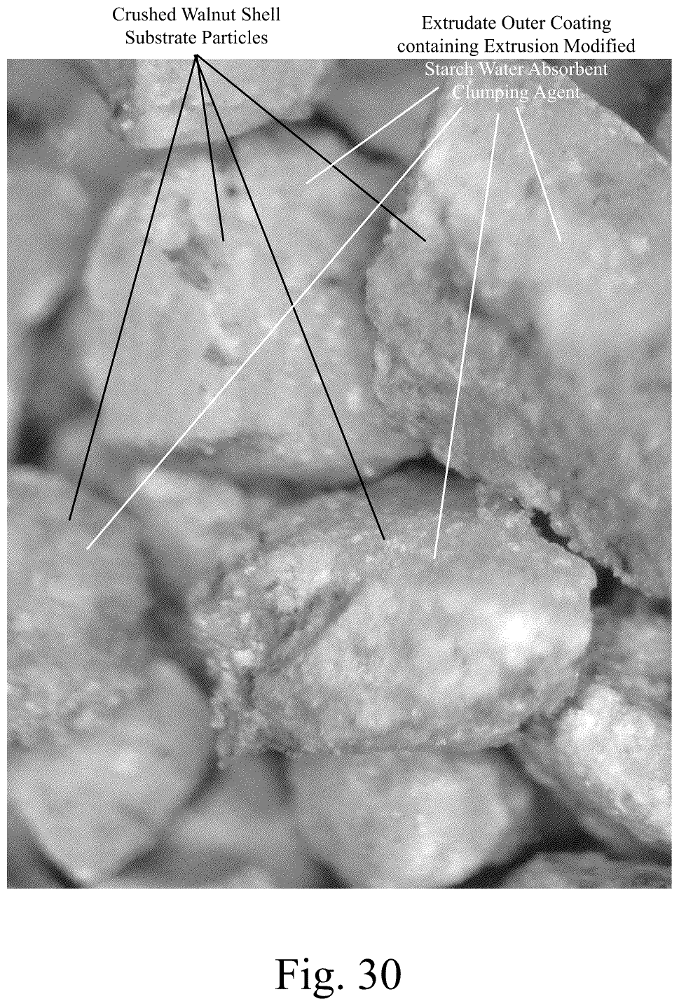

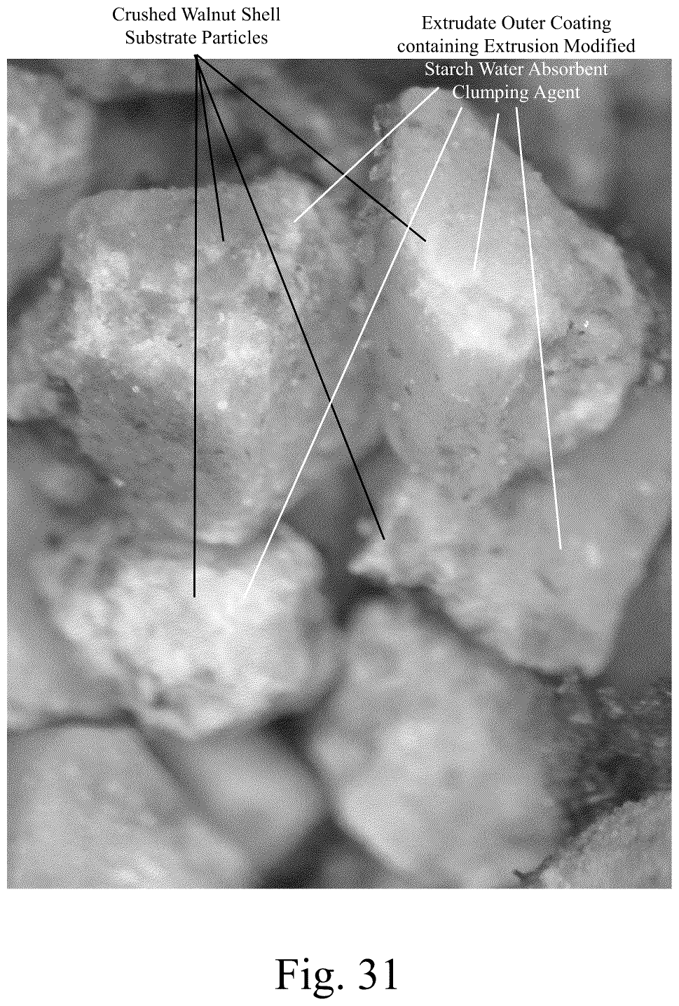

FIGS. 2A-2G are illustrative of several preferred embodiments of granular substrates, which are typically non-clumping substrates, to which a sorbent gelling extrusion-modified starch binding agent is adhered in carrying out a method of making self-clumping litter of the present invention to produce a self-clumping litter of the present invention.

FIG. 2A illustrates a plurality of pairs of, i.e., at least three, particles 42a-42e of a non-clumping substrate 40a of a calcium bentonite 41a preferably used in a method of making a self-clumping litter of the present invention to produce a self-clumping litter of the present invention where the calcium bentonite non-clumping substrate particles 42a-42e each have a sorbent gelling extrusion modified starch binding agent (not shown) applied thereto as discussed in more detail below. The particles 42a-42e of calcium bentonite 41a are water absorbent, nonporous, inorganic and have a bulk density of between 30-45 lbs./ft³. Each one of the calcium bentonite substrate particles 42a-42e has a particle body 44 that can have an irregular or jagged shape 46 with a rough or jagged, i.e., non-smooth, outer surface 48 as is illustrated in FIG. 2A. One or more of the particles 42a-42e can also have crevices or depressions 50 formed in the outer surface 44 thereof.

FIG. 2B illustrates a plurality of pairs, i.e., at least three particles 52a-52e of a non-clumping substrate 40b of sand 41b preferably also used in a method of making a non-clumping litter of the present invention. Sand 41b is an inorganic, non-porous, non-absorbent non-clumping substrate 40b having a bulk density of between 75-110 lbs./ft³. Each one of the particles 52a-52e of sand 41b used as a non-clumping substrate 40b in a self-clumping litter embodiment of the present invention is a grain 54a-54e of sand 41b with at least a plurality of the sand grains 54a-54e having a generally round or oblong sand grain body 56 with an outer surface 58 that is generally smooth or which has rounded edges and a plurality of the sand grains 54a-54e having an irregularly shaped body 60 with an outer surface 61 that is rough, which can be crack or crevice filled, and/or which can be pitted. With continued reference to FIG. 2B, the grains 54a-54e of sand 41b used as the non-clumping substrate 40b are composed of an inert, nonabsorbent, imperforate, inorganic material, such as preferably one or more of silicon dioxide, e.g., quartz, calcium carbonate, granite, chert, igneous rock, limestone and/or gypsum. In one preferred non-clumping substrate embodiment, such as is depicted in FIG. 1B, the sand 41b has at least a plurality of pairs of grains 54a-54e composed of at least a plurality of silicon dioxide, e.g., quartz, calcium carbonate, granite, chert, igneous rock, limestone and/or gypsum.

In another preferred embodiment, such as is depicted in FIG. 2C, substantially all of the grains 54a′-54e′ of sand 41b′ used as the non-clumping substrate 40b′ are composed of silicon dioxide, e.g., quartz. In one such preferred embodiment, substantially all of the grains 54a′-54e′ of sand 41b′ are composed of silicon dioxide, e.g., quartz, with the remainder of the grains 54a′-54e′ of sand 41b′ are composed of calcium carbonate. In still another embodiment, the non-clumping substrate 40b′ consists essentially of silicon dioxide sand grains. In yet another embodiment, the non-clumping substrate 40b′ consists essentially of calcium carbonate sand grains.

FIG. 2D illustrates a porous and organic non-clumping substrate 40c composed of walnut shells 41c comminuted, such as by crushing, grinding, or milling walnut shells into a granular composition of smaller walnut shell particles 62a-62e with each one of the particles 62a-62e having an outer surface 64 that is at least partially porous, i.e., composed of at least a plurality of pores formed therein. The particles 62a-62e of crushed walnut are water absorbent, porous, organic, buoyant, i.e., will float on water, biodegradable, and have a bulk density of between 28-45 lbs./ft³.

FIG. 2E illustrates a porous, absorbent and generally organic non-clumping substrate 40d composed of particles 66a-66e of a cellulosic material 41d that preferably contains paper or is composed of paper, such as recycled paper, reclaimed paper, recycled paper waste, reclaimed paper waste, and/or recycled or reclaimed paper sludge, with each one of the cellulose-paper particles 66a-66e having an outer surface 68 that is fibrous, e.g., composed of paper fibers, can be at least partially porous, i.e., composed of at least a plurality of pores, or substantially porous, i.e., having pores distributed throughout the entire particle outer surface 68, and which has an interior with internal voids or pockets. In a preferred embodiment, the cellulose-paper particles 66a-66e can have a shape that is generally round, e.g. round ball and/or oblong spheroid, with an outer surface 68 that can be generally smooth, but which is fibrous, e.g., composed of paper fibers, can be at least partially porous, i.e., composed of at least a plurality of pores formed in its outer surface 68, or substantially porous, i.e., having water-absorbing pores distributed throughout the entire outer particle surface 68, and which preferably also has a void-filled or pocket-filled interior. The cellulose-paper particles 66a-66e are water absorbent, i.e., able to absorb at least one times their weight in water or oil, buoyant, i.e., float on water, biodegradable, and have a bulk density of between 32-49 lbs./ft³.

FIG. 2F illustrates an inorganic non-clumping substrate 40e composed of particles 72a-72e of perlite 41e with each one of the perlite particles 72a-72e having a rough and uneven outer surface 78 that is crack, crevice and void filled, an irregular shape which can be oblong, have one or more protrusions or lobes projecting outwardly, and possessing a bulk density of between 2-68 lbs./ft³. In a preferred embodiment, the perlite non-clumping substrate 40e is formed of particles 72a-72e of expanded perlite 41e that is absorbent, capable of absorbing between 30% and 40% of its own weight in water, with each particle 72a-72e having an irregularly shaped body 74, which can be oblong and have one or more protrusions or lobes 76 projecting outwardly therefrom, a rough and uneven outer surface 78 that is pore, crack, crevice and void filled, and possessing a bulk density of between 2-25 lbs./ft³.

FIG. 2G illustrates an organic, absorbent, buoyant and biodegradable non-clumping substrate 40f composed of particles 82a-82e of wood 41f with each one of the wood particles 82a-82e having an elongate body 84 and a fibrous outer surface 86 with a bulk density of between 8-15 lbs./ft³. The wood particles 82a-82e can be in the form of sawdust, wood shavings, or wood chips.

FIG. 2H illustrates an organic, buoyant, and biodegradable non-clumping substrate 40f composed of particles 82a′-82e′ of wood 41f′ in the form of wood pellets 88 each preferably formed of compressed sawdust with each one of the wood pellets 88 having an elongate generally cylindrical body 84′ and a relatively smooth outer surface 86′ with a bulk density of between 30-50 lbs./ft³. If desired, the wood pellets 88 can be comminuted, such as by crushing, grinding, or milling the pellets 88, into smaller sized particles before using the smaller sized particles as a non-clumping substrate 40f to make self-clumping litter using a method of making self-clumping litter from a non-clumping substrate according to the present invention.

The granular non-clumping substrates when used in making the self-clumping litter of the present invention can be divided up by type and subtype in the following manner: (a) organic non-clumping substrates which are (1)(i) porous and/or (ii) fibrous, and/or (2)(i) water absorbent, or (ii) nonabsorbent, and (b) inorganic non-clumping substrates which are (1)(i) porous, and/or (2)(i) water absorbent, or (ii) nonabsorbent. The steps of a method of making self-clumping litter in accordance with the present invention using a granular non-clumping substrate can vary at least slightly depending upon whether the granular non-clumping substrate is water absorbent or nonabsorbent, which in turn can and typically does depend upon whether the granular non-clumping substrate is porous.

### Sorbent Swelling and Gelling Biopolymeric Clumping Agent

The sorbent swelling and gelling starch-containing biopolymeric clumping agent contains at least 7.5% of a water-activated moisture curing at least partially soluble cold-water soluble binder that forms a flowable adhesive when wetted defining a viscous flowable clumping agent that gels and solidifies by hardening as it moisture cures as it dries. The water-activated moisture cured sorbent swelling and gelling biopolymeric clumping agent contains at least 7.5% of a pregelatinized starch that preferably is in the form of an extrusion-modified starch pregel produced by extruding an admixture composed of at least 25% starch by admixture weight, preferably at least 30% starch by admixture weight, more preferably at least 40% starch by admixture weight and which has a relatively low moisture content of no greater than 30% by admixture weight, preferably no greater than 25% by admixture weight, more preferably no greater than 20% by admixture weight, even more preferably no greater than about 17%±2% by admixture weight where the starch in the admixture preferably is composed of unmodified amylopectin starch, making up at least 7.5% by weight of the starch present in the admixture, preferably making up at least 10% by weight of the starch present in the admixture, more preferably making up at least 15% by weight of the starch present in the admixture, and even more preferably making up at least 20% by weight of the starch present in the admixture, and unmodified amylose starch, making up at least 5% by weight of the starch present in the admixture, preferably making up at least 7.5% by weight of the starch present in the admixture, more preferably making up at least 10% by weight of the starch present in the admixture, and even more preferably making up at least 15% by weight of the starch present in the admixture, using an extruder that preferably is a single screw extruder, more preferably a 50 horsepower (hp) or 100 hp single screw extruder at an ultrahigh extrusion pressure of at least 2000 PSI, preferably at least 3000 PSI, more preferably at least 4000 PSI, add an extrusion temperature of at least 100° C. and preferably no greater than 150° C. for a relatively short residency time of between 3 seconds and 20 seconds, preferably between 3 seconds and 15 seconds, more preferably between 4 seconds and 12 seconds. No water or moisture, including steam, is added to the admixture while it is inside the extruder, preferably single screw extruder, during extrusion. Upon exiting the extrusion die of the single screw extruder, the extrudate is rapidly cooled and dried without adding any thereto preferably by air quenching the extrudate immediately upon exiting the die with turbulently flowing air to freeze the state of the extrusion-modified starches in the sorbent swelling and gelling biopolymeric clumping agent extrudate thereby freezing the state of the extrusion-modified starch, including the pregelatinized starch (extrusion-modified starch pregel) in the extrudate, and particularly including any water-soluble extrusion-modified starch pregel, further including any-water-soluble extrusion-modified starch pregel in the extrudate pellets. The extruded pellets contain the modified starch water absorbent clumping material, preferably modified starch water absorbent clumping agent, and are comminuted into much smaller particle size, preferably into flour or powder, used to cover each one of the substrate particles and form the outer region around each one of the substrate particles to form them into self-clumping water absorbent litter granules of the present invention.

In a preferred admixture, the admixture contains at least one of a cereal grain, such as wheat, buckwheat, oats, rice, corn (maize), quinoa, barley, sorghum, rye, triticale, and millet and a legume, such as chickpeas, kidney beans, black beans, lentils, pinto beans, peas including green peas and yellow peas, adzuki beans, and peanuts and can be composed of a mixture of a plurality of cereal grains and/or a plurality of legumes. In one such preferred admixture, the admixture is substantially completely composed of at least one of a cereal grain, such as wheat, buckwheat, oats, rice, corn (maize), quinoa, barley, sorghum, rye, triticale, and millet and a legume, such as chickpeas, kidney beans, black beans, lentils, pinto beans, peas including green peas and yellow peas, adzuki beans, and peanuts and can be composed of a mixture of a plurality of cereal grains and/or a plurality of legumes.

Extrusion of such an unmodified starch-containing admixture as described hereinabove using such a single screw extruder operating in accordance with the above extrusion pressure and extrusion temperature parameters modifies, preferably physically modifies, at least some of the starch in the admixture during ultrahigh pressure extrusion into an extrusion-modified cold water soluble starch pregel which preferably is or includes cold water-soluble extrusion-modified starch pregel, and which more preferably is or contains at least partially water-soluble modified starch binder, of which at least a portion forms at least partially water-soluble flowable adhesive when wetted with temperature water and/or cat body temperature urine. In at least one such preferred method implementation, extrusion of such a starch containing admixture as described hereinabove using such a single screw extruder operating in accordance with the above parameters modifies, preferably physically modifies, at least some of the starch in the admixture during ultrahigh pressure extrusion into modified starch water absorbent clumping agent containing extrudate having at least 10%, preferably at least 15%, more preferably at least 30% by weight of extrusion-modified starch pregel which preferably is or includes a cold water-soluble extrusion-modified starch pregel. As a result of ultrahigh pressure extrusion using a single screw extruder, the extrusion-modified starch pregel, including any cold water-soluble extrusion-modified starch pregel, is substantially uniformly distributed throughout the modified starch water absorbent clumping agent containing extrudate such that the extrusion-modified starch pregel, including any cold water-soluble extrusion-modified starch pregel, is substantially uniformly distributed throughout the outer region surrounding each substrate particle of each self-clumping absorbent litter granule of the present invention.

Extrusion of such a starch containing admixture using such a single screw extruder modifies, preferably physically modifies, at least some of the starch in the admixture into an extrusion-modified starch pregel, which can and preferably does contain at least some cold water-soluble extrusion-modified starch pregel, thereby producing extrudate containing the extrusion-modified starch pregel, including any cold water-soluble extrusion-modified starch pregel, which is substantially uniformly distributed throughout the extrudate discharged through a perforate extrusion die at a discharge end of the single screw extruder. In at least one preferred method implementation, extrusion of such a starch containing admixture using such a single screw extruder modifies, preferably physically modifies, at least some of the starch in the admixture into at least 10%, preferably at least 15%, more preferably at least 30% by extrudate weight of the extrusion-modified starch pregel, which can and preferably does contain at least some cold water-soluble extrusion-modified starch pregel, thereby producing an extrudate, which can be an extruded instantized starch containing extrudate, a water gelling extrudate, and/or a water swelling extrudate, which contains at least 10%, preferably at least 15%, more preferably at least 30% by weight of the extrusion-modified starch pregel, including any cold water-soluble extrusion-modified starch pregel, substantially uniformly distributed throughout the extrudate discharged through a perforate extrusion die at the discharge end of the single screw extruder. In at least one such preferred method implementation, extrusion of such a starch containing admixture using such a single screw extruder modifies, preferably physically modifies, at least some of the starch in the admixture into at least 10%, preferably at least 15%, more preferably at least 30% by extrudate weight of the cold water-soluble extrusion-modified starch pregel which contains at least 10%, preferably at least 15%, more preferably at least 30% by weight of cold water-soluble extrusion-modified starch pregel, substantially uniformly distributed throughout the extrudate discharged through a perforate extrusion die at a discharge end of the single screw extruder.

The present invention also is directed to an ultrahigh pressure modified starch-containing extrudate, which is configured for use in making the outer region that covers the inner substrate particle of each litter granule of the present invention, which is made by such a method that is composed of at least 15% by weight of a pregelatinized starch formed of starch in the admixture modified, preferably physically modified, in the single screw extruder during ultrahigh pressure extrusion, i.e., extrusion-modified starch pregel, that is absorptive of water and gels upon water absorption such that the extrudate produced for application onto substrate particles to produce the self-clumping absorbent litter granules of the present invention contains at least one of an instantized ultrahigh pressure extrusion modified starch preferably swells and gels upon contact and absorption water, and/or at least a portion of which at least partially solubilizes in room temperature water or cat body heat temperature urine, is composed of at least 15% by weight of the extrusion-modified starch pregel, and an extrudate composed of at least 15% by weight of the extrusion-modified starch pregel.

In a preferred method implementation, the single screw extruder is one of (a) a 50 horsepower (hp) single screw extruder having a barrel length of between about nine inches and about sixteen inches, between nine inches and twelve inches, and preferably about nine inches, a barrel internal diameter of between two inches and five inches, preferably between three and four inches, and more preferably about three and one-half inches, and a residency time of between three seconds and fifteen seconds, preferably between four seconds and twelve seconds, and more preferably between about four seconds (±1 second) and eight seconds (±1 second), and (b) a 100 hp single screw extruder having a barrel length of between about fourteen inches and twenty inches, preferably between sixteen inches and eighteen inches, more preferably either sixteen inches or eighteen inches, a barrel internal diameter (I.D) of between three inches and six inches, preferably between four inches and five inches, and more preferably about four and one half inches, and a residency time of between four seconds and twenty seconds, preferably between six seconds and eighteen seconds, and more preferably between about eight seconds (±1 second) and about twelve seconds (±1 second). During operation, the 50 hp extruder and/or 100 hp single screw extruder subjects the admixtures to an ultrahigh extrusion pressure of at least at least 2000 PSI, preferably at least 3000 PSI, more preferably at least 4000 PSI, and even more preferably at least 5000 PSI, in which preferably ranges between 2000 PSI and 5000 PSI during extruder operation.

In one preferred method of making extrudate and extrudate of the present invention, the aforementioned single screw extruder parameters are configured and controlled during extrusion of such a starch-containing admixture containing at least 25%, preferably at least 30%, more preferably at least 40% by weight of starch and a relatively low moisture content of no greater than 30%, preferably no greater than 25%, more preferably no greater than 20%, even more preferably no greater than about 17%±2%, by admixture weight, and which is composed of at least one of a cereal grain and a legume to achieve at least 65% starch gelatinization within the extruder, preferably at least 70% starch gelatinization within the extruder, more preferably at least 75% starch gelatinization within the extruder, even more preferably between 75% and 95% starch gelatinization within the extruder to produce extrudate that is particle size classified or particle-size reduced into relatively small particles, such as preferably in flour or powder particulate size form, which are composed of extrusion-modified starch water-absorbent clumping agent that is or includes modified-starch-based sorbent swelling biopolymeric gellant comprised of at least 15% of an extrusion-starch modified pregel, i.e., extrusion-modified pregelatinized starch. In another preferred method and extrudate of the present invention, the aforementioned single screw extruder parameters are configured and controlled during extrusion of such a starch-containing admixture containing at least 25%, preferably at least 30%, more preferably at least 40% by weight of starch and which is composed of at least one of a cereal grain and a legume, to achieve between 35% and 65% starch gelatinization within the extruder, preferably between 40% and 60% starch gelatinization within the extruder, to produce an extrudate composed of extrusion-modified starch water-absorbent clumping agent comprising modified-starch-based sorbent swelling biopolymeric gellant containing both an extrusion-modified starch at least partially soluble binder, preferably extrusion-modified starch cold water soluble binder, and a water swellable water absorbent extrusion-modified starch. No water or moisture, including any steam, is added to the admixture while it is inside the single screw extruder during extrusion nor to the extrudate upon exiting the extruder. Upon exiting the extrusion die of the single screw extruder, the extrudate is rapidly cooled and dried without adding any heat thereto preferably by air quenching the extrudate immediately upon exiting the die and being cut into pellets using turbulently flowing air to freeze the state of the extrusion-modified starches in the extrudate. This thereby also freezes the state of the extrusion-modified starch pregelatinized starch (extrusion-modified starch pregel) in the extrudate, including any water-soluble extrusion-modified starch pregel, i.e., water-soluble extrusion-modified pregelatinized starch, which also includes or encompasses any-water-soluble extrusion-modified starch pregel in the extrudate.

It was previously thought that extruded fines or flour of the modified starch absorbent clumping agent or material made using air quenching that freezes the state of its modified water-soluble starches only form an at least partially water-soluble binder and an at least partially water-soluble flowable adhesive that can only be water-activated and moisture-cured a single time once wetted with water or urine. It is therefore a surprise that at least some of the ultrahigh pressure extrusion modified starch in the modified starch absorbent clumping agent or material extrudate that is or forms the at least partially water-soluble binder and at least partially water soluble flowable adhesive can be at least partially solubilized, water re-activated, and moisture re-cured at least one and preferably at least a plurality of times after previously being wetted, water activated and moisture cured with room temperature water or cat body temperature urine. During extrusion, the heat of vaporization affects the already modified starches in the extrudate to produce one or more of the desired water swelling, water absorption, binder, flowable adhesive, clumping, water activated and moisture curing, water re-activated and moisture re-curing, endothermic water re-activated and moisture re-curing, and/or endothermic re-gelatinization properties including by setting or freezing in place to retain these properties following extrusion, even when the extrudate, even in flour or powder form, is stored for long periods of time of over six months or even one year, self-clumping absorbent litter granules made with substrate particles coated therewith are stored for over six months and even up to one year, as well as further modifying some of the modified starch in the extrudate as it exits the extruder die to produce one or more of the desired water swelling, water absorption, binder, flowable adhesive, clumping, water activated and moisture curing, water re-activated and moisture re-curing, endothermic water re-activated and moisture re-curing, and/or endothermic re-gelatinization properties including by setting or freezing in place to retain these properties following extrusion, even when the extrudate, even in flour or powder form, is stored for long periods of time of over six months or even one year, self-clumping absorbent litter granules made with substrate particles coated therewith are stored for over six months and even up to one year.

It was also previously believed that the extrusion modified starch water absorbent clumping material or clumping agent containing extrudate could not be heated up after extrusion and air quenching/flash drying without adversely affecting the ability of at least partially soluble modified starch binder to form flowable adhesive when wetted as well as to adhesively bond thereafter such that it was an expected surprise to learn that the ultrahigh pressure extrusion modified starch water absorbent clumping material or clumping agent containing extrudate after being applied in particulate, preferably flour or powder, form onto the substrate granules to form the self-clumping absorbent litter granules of the invention can be heated to a temperature of at least 100° Fahrenheit, preferably at least 150°, more preferably at least 180° Fahrenheit to dry the litter granules, which are moist when finished, without adversely affecting the ability of the outer regions of the litter granules to at least partially solubilize and water active enough of the binder and flowable adhesive therein when wetted with room temperature urine or cat body temperature urine and form clumps of the litter granules that have a clump retention rate of at least 95%, preferably at least 97%, more preferably at least 99%, and a clump crush strength of at least 40 PSI, preferably at least 60 PSI, more preferably at least 80 PSI and even more preferably at least 100 PSI.

The extrudate containing the extrusion-modified starch water-absorbent clumping agent can be particle-size reduced, such as by using a particle-size reducing machine, such as a hammermill, roll granulator, a roller crusher or another type of particle-size reducing machine to reduce particle size preferably to less than the particle size of the substrate particles to which the particle-size reduced extrusion-modified starch water-absorbent clumping agent containing extrudate is applied. The extrudate containing the extrusion-modified starch water-absorbent clumping agent can be particle-size classified, such as by using a sieve, screen, a pneumatic or air classifier, a pneumatic or air classifying mill, or another type of particle size classifier that particle size classifies in real time as extrudate is extruded from the extruder and conveyed pneumatically downstream to the size classifying equipment.

The present invention also is directed to an extruded gelling constituent that is composed of a gelling constituent extrudate extruded from a starch-containing admixture subjected to sufficiently high extrusion pressures and extrusion conditions within an extruder to modify, preferably physically modify, starch in the admixture into a water-soluble extrusion-modified starch gellant that gels and/or forms a gel when wetted with water, thereby configuring the gelling constituent extrudate and extruded gelling constituent composed of the gelling constituent extrudate to gel and/or form a gel when wetted with water. As disclosed in more detail below, in one preferred embodiment, other starch of the starch-containing admixture is modified, preferably also physically modified, by the high extrusion pressure and extrusion conditions withing the extruder such that pregelatinized starch also is formed in the gelling constituent extrudate producing an extruded gelling constituent in accordance with the present invention configured with two-component gelling, with one gelling component provided by the water-soluble extrusion-modified starch gellant in the gelling constituent extrudate, and the other gelling component provided by the water-soluble pregelatinized starch in the gelling constituent extrudate. As disclosed herein in more detail, the resultant extruded gelling constituent is comminuted into relatively small particles sizes having the size of grits, powder or flour for use to coat the substrate particles. Where the extruded gelling constituent is solely composed of gelling constituent extrudate and contains no other constituents, the gelling constituent extrudate is comminuted during extrusion into pellets or granules that are further comminuted by grinding or milling into smaller sized particles having the size of grits, powder or preferably flour used as to coat the substrate particles and form them into litter granules of the invention.

In one preferred embodiment, the extrusion pressures and extrusion conditions within the extruder modify some of the starch in the starch-containing admixture into a plurality of different molecular weight extrusion-modified starch polymers or starch-based polymers that form the water-soluble extrusion-modified starch gellant that polymerize into a hydrocolloid gel when wetted with and preferably mixed with water. In another preferred embodiment, the extrusion pressures and extrusion conditions within the extruder also modify and/or free up some of the protein or proteins in the starch-containing admixture into a crosslinker that forms part of the water-soluble extrusion-modified starch gellant that crosslinks the plurality of different molecular weight starch polymers or starch-based polymers of the gellant when wetted with and preferably mixed with water. In one such preferred embodiment where the water-soluble extrusion-modified starch gellant contains both (a) extrusion-modified starch or starches that forms a plurality of different molecular weight extrusion-modified starch polymers or different molecular weight extrusion-modified starch-based polymers, and (b) extrusion-modified or extrusion-freed protein or proteins that crosslink the different molecular weight extrusion-modified starch polymers or different molecular weight extrusion-modified starch-based polymers when an extruded gelling constituent composed of extrudate containing such an extrusion-modified starch polymer and protein crosslinker starch gellant is wetted with water, the resultant self-gelling gel formed preferably is a thermoreversible gel, a moisture re-activatable and/or moisture re-curable gel, a moisture re-activatable, a moisture re-curable at least partially water-soluble ultrahigh pressure extrusion modified starch binder, and/or a moisture re-curable at least partially water-soluble flowable adhesive component in the at least partially water soluble ultrahigh pressure extrusion modified starch binder.

It was previously thought that extruded fines or flour of the modified starch absorbent clumping agent or material made using air quenching that freezes the state of its modified water-soluble starches only form an at least partially water-soluble binder and an at least partially water-soluble flowable adhesive that can only be water-activated and moisture-cured a single time once wetted with water or urine. It is therefore a surprise that at least some of the ultrahigh pressure extrusion modified starch in the modified starch absorbent clumping agent or material extrudate that is or forms the at least partially water-soluble binder and at least partially water soluble flowable adhesive can be at least partially solubilized, water re-activated, and moisture re-cured at least one and preferably at least a plurality of times after previously being wetted, water activated and moisture cured with room temperature water or cat body temperature urine.

In a preferred embodiment, the water-soluble extrusion-modified starch gellant is a cold-water soluble hydrocolloid when wetted with room temperature water mixed therewith that forms a gel, preferably a self-gelling gel, which is thermally stable, and which preferably produces thermally and shelf-life stable emulsions when mixed with an aqueous liquid, preferably water, such as preferably using a high shear mixer, or another mixer or blender form a slurry. In one such preferred embodiment, the extruded gelling constituent is composed of a gelling constituent extrudate that not only contains water-soluble extrusion-modified starch gellant but also contains pregelatinized starch formed of other starch in the admixture modified, preferably also physically modified by extrusion pressure during extrusion in pregelatinized starch, which also gels when wetted with water mixed therewith producing a dual-gelling component gelling constituent extrudate containing one gelling component, namely water-soluble extrusion-modified starch gellant that gels when wetted, but also a second gelling component, namely pregelatinized starch that also gels when wetted.

Each self-clumping absorbent coated substrate litter granule of the present invention preferably is a swelling and gelling self-clumping absorbent coated substrate litter granule in which the outer region of its modified starch water-absorbent clumping agent outer coating swells as it absorbs water or urine, preferably room temperature water or cat body temperature urine, wetting the granule and also substantially simultaneously forms a gel on, along and for a depth below the outer surface of the coated substrate litter granule that preferably is tacky when wetted and which can be, include, or otherwise preferably does contain a water-activated moisture curing adhesive which facilitates clumping with other contacting litter granules by its stickiness or tackiness creating adhesion therebetween that adhesively bonds the contacting granules thereto into a clump by moisture curing by the moisture evaporating from the clump as the clump dries. In one embodiment of a coated substrate litter granule of the invention, the modified starch water-absorbent clumping agent outer coating of each wetted coated substrate litter granule at least partially solubilizes in water or urine, preferably room temperature water or cat body temperature urine, forming a flowable water-activated moisture-curing adhesive with a viscosity that remains low enough, preferably no greater than 15,000 centipoise, more preferably no greater than 10,000 centipoise, even more preferably no greater than about 5,000 for a long enough period of time, preferably for at least one second after being wetted, more preferably for at least 4 seconds after being wetted, enabling it to flow from the water or urine wetted of modified starch water-absorbent clumping agent of the litter granule along and in between contacting granules and adjacent granules until the viscosity increases forming back into a tacky semisolid gel having a viscosity of at least about 30,000 centipoise, preferably at least 50,000 centipoise, more preferably at least 80,000 centipoise within 20 seconds after being wetted, preferably within 10 seconds after being wetted, more preferably within 5 seconds after being wetted. As the flowable adhesive increases in viscosity, it gels (but remains at least slightly tacky), and hardens into a glassy material having a glassy material state at room temperature as the formed clump moisture cures during drying thereby bonding together the clumped granules. These bonds can include one of hydrogen bonds and covalent bonds, preferably covalent bonds. In any event, the resultant clump formed becomes hard enough to have a clump retention rate of at least 95%, preferably at least 97%, more preferably at least 99% and a clump crush strength of at least 40 PSI, preferably at least 60 PSI, more preferably 80 PSI, even more preferably at least 100 PSI, when the clump is dried to a moisture content of about 12% (12%±1.5%) by clump weight and clump tested using the clump compression strength test procedure below. Where viscosities are set forth herein, the viscosities are to be measured using a viscometer, preferably a Brookfield DV3T viscometer at a spindle rotation of 50 RPM, where 400 grams of the coated-substrate litter granules are wetted with 200 grams of water, e.g., 2% saline solution, at room temperature, e.g., between 68° F. and 74° F. in carrying out the viscosity measurements.

For all of the values of the clump compression strengths or clump crush strengths listed herein, the following test procedure is used:

### Clump Compression Strength Test Procedure

The following equipment was utilized in carrying out extruded granular absorbent (litter) clump compression strength testing:
(1) 5 mL centrifuge tubes with screw top caps, plastic.
(2) 3.0 mL disposable pipettes, plastic.
(3) Distilled water
(4) Force Gauge: Mark—10 Model M7-500 S/N 3674412
(5) Motorized test stand: Model ESM303 S/N 3979431
(6) Digital control panel: Mark—10 Model DC4060 S/N 3680222
(7) DREMEL handheld high speed rotary power tool with deep cutting wheel
(8) Samples of extruded granular absorbent material (extruded pellets) to be wetted to form clumps therefrom to be compression strength tested.

Using the above, the following methodology was utilized in performing extruded granular absorbent (litter) clump compressive strength testing:
(1) Saw off tapered end of a 15 mL test tube and clean off burrs.
(2) Screw on cap of test tube and fill tube with sample material to be tested.
(3) Add distilled water to sample material in test tube (1:1 by weight) to wet sample material
(4) Wait 10 seconds.
(5) Unscrew cap from test tube and gently push “cast” clump formed of wetted sample material out of test tube using bulbous end of a plastic pipette (snug fit).
(6) Let cast clump sit and dry for 5 days at ambient room temperature conditions.
(7) Using deep cutting wheel attached to a DREMEL high speed rotary tool at high speed greater than 10,000 RPM, cut cast clump into barrel-shaped sections each approximately 0.5 inches thick or long.
(8) Measure the diameter and length of each barrel shaped cast clump section.
(9) Place barrel shaped cast clump section on middle of compression test stand platform, with flat cut ends of barrel shaped cast clump section on top and bottom for compression testing by force gauge.
(10) Using a compression speed of 0.5 inches/minute, determine peak compression strength of barrel shaped cast clump section using force gauge.

Finally, self-clumping absorbent litter granules of the present invention can be made using substrate particles of pine and/or cedar, such as in the form of shavings, sawdust, and/or pellets, and calcium bentonite, e.g., calcium bentonite particles or granules, which are blended together and the blend of these two or more different types of substrate particles wet coated or slurry coated with the modified starch water absorbent clumping material flour or powder or modified starch water absorbent clumping agent flour or powder to form an outer region of the modified starch water absorbent clumping material or modified starch water absorbent clumping agent thereon. Other types of substrate materials can be used as substrates and substrate particles, including pine, cedar, or another type of wood, such as in the form of wood sawdust or pine shavings, bentonite, calcium bentonite and/or sodium bentonite, limestone, e.g., crushed limestone, perlite, e.g., crushed perlite, shredded corn cobs, shredded straw, shredded cereal grain hulls and/or husks, rice hulls, shredded nut hulls and/or shells, and/or bamboo fiber. One or more, up to ten, of these different types of substrate particle materials can be mixed or blended together in particulate form to form a blend or mixture of different types of substrate particles that all can be coated simultaneously or substantially simultaneously with particulate modified starch water absorbent clumping material or modified starch water absorbent clumping agent, such as in the form of a flour or powder to produce self-clumping water absorbent litter granules therefrom. In addition, calcium bentonite granules can be pulverized or comminuted into a powder that that is first agglomerated onto granules of perlite and/or onto grains of sand to form substrate particles thereof before coating these dual component (calcium bentonite-perlite, calcium bentonite-sand) or multicomponent (calcium bentonite-perlite-sand) substrate granules with particulate ultrahigh pressure extrusion modified starch water absorbent binder material or binder agent extrudate to form self-clumping absorbent litter granules of the invention.

Self-clumping absorbent litter granules of the present invention can also be made using pelletized substrate particles, i.e., substrate particle pellets, each formed of two or more different types of substrates or substrate materials, such as pine, cedar, or another type of wood, such as in the form of wood sawdust or pine shavings, mixed with particles of one or more other types of materials, such as bentonite, calcium bentonite and/or sodium bentonite, limestone, e.g., crushed limestone, perlite, e.g., crushed perlite, shredded corn cobs, shredded straw, shredded cereal grain hulls and/or husks, rice hulls, shredded nut hulls and/or shells, bamboo fiber, along with a pelletizing agent before being formed into pellets thereof used as substrate particles coated with the modified starch water absorbent clumping material flour or powder or modified starch water absorbent clumping agent flour or powder to form an outer region of the modified starch water absorbent clumping material or modified starch water absorbent clumping agent around each substrate particle pellet.

The present invention therefore includes the use of a mixture of organic materials and inorganic materials blended together prior to application of the modified starch water absorbent clumping material, modified starch water absorbent clumping agent extrusion, which preferably includes modified starch polymer binder; pelletized organic blends and/or pelletized inorganic blends, and combinations thereof, and is therefore not intended to be limited in scope or extent by one of ordinary skill in the art. Designer pelletized granules can be used as substrate particles having a plurality of different constituents each having a different attribute designed to enhance the litter and/or pellet such as bulk density, entrained fragrances, or oils, e.g., lavender, catnip, alfalfa (attracts cats to litter box), sodium bicarbonate, benzyl quaternary compounds, preservatives, or other odor reducing compounds (because coating isolates any such compound with direct cat contact). The coating comprised of extrusion modified starch polymer binder provides a chemically isolating barrier that only allows activation of the benzyl quaternary compounds or other odor reducing compounds upon wetting and solubilizing of the protective chemically isolating coating and then wetting of the benzyl quaternary compounds or other odor reducing compounds.

During wetting of self-clumping absorbent litter granules of the present invention, the resultant gels that forms after wetting with water or urine is a water catching and/or water flow impeding extrusion modified amylopectin starch gel that increase in viscosity over time, including due to moisture in the gel evaporating into the air. The gel can and preferably does also include an extrusion modified amylose starch gel which preferably is a fibrous type gel.

A litter of the present invention can include functional particles like zeolite additives e.g., colored particles, and other types of functional and nonfunctional particles that do not carry the extrusion modified starch polymer binder (which are not substrate particles and which are used without any coating thereon in the litter) which are blended with the self-clumping absorbent litter granules of the invention. Self-clumping absorbent litter granules of the present invention can also be made using substrate particles of cedar, such as pine shavings, pine sawdust, and/or pine pellets, and calcium bentonite, e.g., calcium bentonite particles or granules, blended together and then coated to form an outer region of the modified starch water absorbent clumping material or modified starch water absorbent clumping agent thereon.

It is also to be understood that, although the foregoing description and drawings describe and illustrate in detail one or more preferred embodiments of the present invention, to those skilled in the art to which the present invention relates, the present disclosure will also suggest various modifications, constructions, and alternatives, as well as different embodiments and applications all of which are contemplated as being within the scope of the invention. The present invention, therefore, is intended to be limited only by the scope of the appended claims.

It is claimed:

1. A self-clumping sorbent granular litter comprised of a plurality of sorbent litter granules which self-clump together when wetted, each self-clumping sorbent litter granule comprised of:
(a) an inner substrate particle; and
(b) a modified-starch clumping agent adhesively self-adhered to the inner substrate particle.

2. The self-clumping sorbent granular litter of claim 1, wherein the modified starch clumping agent is adhesively self-adhered to the to the substrate particle by an inner self-adhering region comprised of the modified starch water absorbing clumping agent.

3. The self-clumping sorbent granular litter of claim 2, wherein the modified starch clumping agent comprises an outer region encompassing the inner self-adhering region and defining an outer surface of each sorbent litter granule.

4. The self-clumping sorbent granular litter of claim 3, wherein the outer surface is comprised of at least a plurality of pairs of upraised projections formed in the outer surface which are each upraised therefrom, the upraised projections configured to improve water and urine absorption of the sorbent litter granule.

5. The self-clumping sorbent granular litter of claim 4, wherein each one of the upraised projections is microscopic in size.

6. The self-clumping sorbent granular litter of claim 5, wherein each one of the upraised projections is nanosized or nanoscale in size.

7. The self-clumping sorbent granular litter of claim 3, wherein the outer surface is comprised of at least a plurality of pairs of cracks formed in the outer surface, the cracks configured to improve water and urine absorption of the sorbent litter granule.

8. The self-clumping sorbent granular litter of claim 7, wherein each one of the each one of the cracks are microcracks.

9. The self-clumping sorbent granular litter of claim 3, wherein the modified-starch clumping agent defines an outer surface of each sorbent granule, the outer surface of each sorbent granule comprised of at least a plurality of pairs of upraised projections formed in the outer surface which are each upraised therefrom, the upraised projections configured to improve water and urine absorption of the sorbent litter granule.

10. The self-clumping sorbent granular litter of claim 9, wherein substantially the entire outer surface of each sorbent granule is comprised of the upraised projections.

11. The self-clumping sorbent granular litter of claim 10, wherein each one of the upraised projections is microscopic in size.

12. The self-clumping sorbent granular litter of claim 3, wherein the modified-starch clumping agent defines an outer surface of each sorbent granule, the outer surface of each sorbent granule comprised of at least a plurality of pairs of microcracks formed in the outer surface, the microcracks configured to improve water and urine absorption of the sorbent litter granule.

13. The self-clumping sorbent granular litter of claim 3, wherein the modified-starch clumping agent defines an outer surface of each sorbent granule, the outer surface of each sorbent granule comprised of (i) at least a plurality of pairs of microscopic upraised projections formed in the outer surface which are each upraised therefrom, and (ii) at least a plurality of pairs of microcracks formed in the outer surface, the microscopic upraised projections and the microcracks configured to improve water and urine absorption of the sorbent litter granule.

14. The self-clumping sorbent granular litter of claim 1, wherein the clumping agent is comprised of (a) a first constituent comprised of a single-time moisture activated single-time moisture cured binder, and (b) a second constituent comprised of a moisture reactivating moisture recuring binder configured to be moisture activated and moisture cured a plurality of times.

15. The self-clumping sorbent granular litter of claim 14, wherein the clumping agent is further comprised of a third constituent comprised of a water sorbent.

16. The self-clumping sorbent granular litter of claim 14, wherein the first constituent is comprised of a cold-water soluble starch that is at least partially water soluble at a room temperature of between 68 degrees Fahrenheit and 72 degrees Fahrenheit.

17. The self-clumping sorbent granular litter of claim 16, wherein the first constituent is comprised of an extrusion-modified starch that is comprised of starch in the admixture modified during extrusion.

18. The self-clumping sorbent granular litter of claim 17, wherein the first constituent is comprised of a dextrinized starch.

19. The self-clumping sorbent granular litter of claim 14, wherein the second constituent is comprised of a cold-water soluble starch that is at least partially water soluble at a room temperature of between 68 degrees Fahrenheit and 72 degrees Fahrenheit.

20. The self-clumping sorbent granular litter of claim 19, wherein the second constituent is comprised of an extrusion-modified starch that is comprised of starch in the admixture modified during extrusion.

21. The self-clumping sorbent granular litter of claim 20, wherein the second constituent is comprised of a pregelatinized starch or a starch pregel.

22. The self-clumping sorbent granular litter of claim 14, wherein the first constituent is comprised of a dextrinized starch and the second constituent is comprised of a pregelatinized starch or a starch pregel.

23. The self-clumping sorbent granular litter of claim 1, wherein the modified starch water absorbing clumping agent is adhesively self-adhered to the to the substrate particle by an inner self-adhering region comprised of the modified starch water absorbing clumping agent.

24. The self-clumping sorbent granular litter of claim 23, wherein the modified starch water absorbing clumping agent is comprised of (a) a first type of starch modified into a water swellable modified starch that also is water absorbent, and (b) a second type of starch modified into an at least partially water-soluble binder which comprises a water-activated adhesive when the at least partially water-soluble binder is wetted with an aqueous liquid.

25. The self-clumping sorbent granular litter of claim 24, wherein the water-activated adhesive comprises a moisture-curing water-activated adhesive.

26. The self-clumping sorbent granular litter of claim 25, wherein the room temperature moisture-curing water-activated adhesive is comprised of one of a room temperature moisture-curing water-activated thermoset adhesive and a room temperature moisture-curing water-activated thermoplastic adhesive.

27. The self-clumping sorbent granular litter of claim 1, wherein the inner substrate particle has an outer surface, and wherein the outer region of the modified-starch water-absorbent clumping agent is adhesively self-adhered to the outer surface of the inner substrate particle by at least a portion of the outer region of the modified-starch water-absorbent clumping agent.

28. The self-clumping sorbent granular litter of claim 27, wherein the outer region of the modified-starch water-absorbent clumping agent is comprised of (1) cold water swellable water-absorbent modified starch, and (2) cold water soluble modified starch binder that forms an at least partially water soluble flowable adhesive when wetted with an aqueous liquid or solution comprised of water, at least some which adhesively self-adheres the outer region of the modified-starch water-absorbent clumping agent to the outer surface of the inner substrate particle.

29. The self-clumping sorbent granular litter of claim 27, wherein the outer region of the modified-starch water-absorbent clumping agent is comprised of (a) cold water swellable water-absorbent modified starch, and (b) cold water soluble modified starch binder that forms an at least partially water soluble flowable adhesive when wetted with an aqueous liquid or solution comprised of water, at least some which adhesively self-adheres the outer region of the modified-starch water-absorbent clumping agent to the outer surface of the inner substrate particle when one of (1)(i) the modified-starch water-absorbent clumping agent, and (ii) the inner substrate particle is wetted with an aqueous wetting liquid comprised of water, (2) wet modified-starch water-absorbent clumping agent is disposed in contact with the wet outer surface of the inner substrate particle, and (3) the flowable adhesive thereafter moisture cures or sets comprising an inner self-adhering region that solidifies into a solid hardened adhesive in glassy material state that bonds the outer region of the modified-starch water-absorbent clumping agent to the outer surface of the inner substrate particle.

30. The self-clumping sorbent granular litter of claim 29, wherein the flowable adhesive of the inner adhering region is cured or set to become solid and hard.

31. The self-clumping sorbent granular litter of claim 30, wherein the moisture content of the self-clumping absorbent granule is reduced to transition the flowable adhesive of the inner adhering region into a solid glassy material.

32. The self-clumping sorbent granular litter of claim 31, wherein the moisture content of the self-clumping absorbent granule is reduced until the flowable adhesive of the inner adhering region transitions from one of a flowable liquid and a gel into a solid glassy material.

33. The self-clumping sorbent granular litter of claim 31, wherein the moisture content of the self-clumping absorbent granule is reduced until the flowable adhesive of the inner adhering region transitions from one of a flowable liquid and a gel into a solid glassy material that is hard to the touch.

34. The self-clumping sorbent granular litter of claim 33, wherein the moisture content of the self-clumping absorbent granule is reduced to no more than about 8% by weight of the litter granule to cure or set the flowable adhesive in the inner region to transition the flowable adhesive from one of a viscous liquid and a semi-solid gel into a solid glassy material that is hard to the touch.

35. A method of making a self-clumping sorbent granular litter comprised of a plurality of sorbent litter granules which self-clump together when wetted, the method comprising:
(a) providing a substrate particle and a modified-starch clumping agent;
(b) applying the modified-starch clumping agent onto the substrate particle forming a self-clumping sorbent litter granule comprised of the substrate particle and the modified-starch clumping agent adhesively self-adhered to the substrate particle.

36. The method of claim 35, wherein the modified starch clumping agent is adhesively self-adhered to the to the substrate particle by an inner self-adhering region comprised of the modified starch water absorbing clumping agent.

37. The method of claim 36, wherein the modified starch clumping agent comprises an outer region encompassing the inner self-adhering region and defining an outer surface of each sorbent litter granule.

38. The method of claim 37, wherein the outer surface is comprised of at least a plurality of pairs of upraised projections formed in the outer surface which are each upraised therefrom, the upraised projections configured to improve water and urine absorption of the sorbent litter granule.

39. The method of claim 38, wherein each one of the upraised projections is microscopic in size.

40. The method of claim 39, wherein each one of the upraised projections is nanosized or nanoscale in size.

41. The method of claim 37, wherein the outer surface is comprised of at least a plurality of pairs of cracks formed in the outer surface, the cracks configured to improve water and urine absorption of the sorbent litter granule.

42. The method of claim 41, wherein each one of the each one of the cracks are microcracks.

43. The method of claim 37, wherein the modified-starch clumping agent defines an outer surface of each sorbent granule, the outer surface of each sorbent granule comprised of at least a plurality of pairs of upraised projections formed in the outer surface which are each upraised therefrom, the upraised projections configured to improve water and urine absorption of the sorbent litter granule.

44. The method of claim 43, wherein substantially the entire outer surface of each sorbent granule is comprised of the upraised projections.

45. The method of claim 44, wherein each one of the upraised projections is microscopic in size.

46. The method of claim 37, wherein the modified-starch clumping agent defines an outer surface of each sorbent granule, the outer surface of each sorbent granule comprised of at least a plurality of pairs of microcracks formed in the outer surface, the microcracks configured to improve water and urine absorption of the sorbent litter granule.

47. The method of claim 37, wherein the modified-starch clumping agent defines an outer surface of each sorbent granule, the outer surface of each sorbent granule comprised of (i) at least a plurality of pairs of microscopic upraised projections formed in the outer surface which are each upraised therefrom, and (ii) at least a plurality of pairs of microcracks formed in the outer surface, the microscopic upraised projections and the microcracks configured to improve water and urine absorption of the sorbent litter granule.

48. The method of claim 35, wherein the clumping agent is comprised of (a) a first constituent comprised of a single-time moisture activated single-time moisture cured binder, and (b) a second constituent comprised of a moisture reactivating moisture recuring binder configured to be moisture activated and moisture cured a plurality of times.

49. The method of claim 48, wherein the clumping agent is further comprised of a third constituent comprised of a water sorbent.

50. The method of claim 48, wherein the first constituent is comprised of a cold-water soluble starch that is at least partially water soluble at a room temperature of between 68 degrees Fahrenheit and 72 degrees Fahrenheit.

51. The method of claim 50, wherein the first constituent is comprised of an extrusion-modified starch that is comprised of starch in the admixture modified during extrusion.

52. The method of claim 51, wherein the first constituent is comprised of a dextrinized starch.

53. The method of claim 48, wherein the second constituent is comprised of a cold-water soluble starch that is at least partially water soluble at a room temperature of between 68 degrees Fahrenheit and 72 degrees Fahrenheit.

54. The method of claim 53, wherein the second constituent is comprised of an extrusion-modified starch that is comprised of starch in the admixture modified during extrusion.

55. The method of claim 54, wherein the second constituent is comprised of a pregelatinized starch or a starch pregel.

56. The method of claim 48, wherein the first constituent is comprised of a dextrinized starch and the second constituent is comprised of a pregelatinized starch or a starch pregel.
